(19) United States
(12) Patent Application Publication
(10) Pub. No.: US 2025/0188238 A1
(43) Pub. Date: Jun. 12, 2025

(54) HYDROPHOBIC POLYMER AEROGELS

(71) Applicant: Aerogel Technologies, LLC, Boston, MA (US)

(72) Inventors: Stephen A. Steiner, III, Milwaukee, WI (US); Moriah C. Buckwalter, South Weymouth, MA (US)

(73) Assignee: Aerogel Technologies, LLC, Boston, MA (US)

(21) Appl. No.: 18/856,189

(22) PCT Filed: Apr. 13, 2023
(86) PCT No.: PCT/US2023/018567

§ 371 Date: Oct. 11, 2024

Related U.S. Application Data
(60) Provisional application No. 63/331,766, filed on Apr. 15, 2022.
(60) Provisional application No. 63/331,775, filed on Apr. 15, 2022.

(51) Int. Cl. C08J 9/00; C08G 18/72; C08G 18/79; C08J 9/28

(52) U.S. Cl. CPC C08J 9/0028; C08G 18/725; C08G 18/792; C08J 9/28; C08G 2110/005; C08G 2110/0091; C08J 2201/05; C08J 2375/02

(57) ABSTRACT

Aerogels comprising a hydrophobic polyimide moiety, including hydrophobic polyimide aerogels, as well as methods of manufacture and applications thereof, are generally described. The methods comprise the steps of forming a gel from a combination comprising a gel precursor and a solvent, and optionally a catalyst, and drying the gel to form the aerogel, wherein a hydrophobe is present at least one point in time after the beginning of forming the combination and before the completion of drying the gel.

### RELATED APPLICATIONS

This application claims priority under 35 U.S.C. § 119(e) to U.S. Provisional Patent Application No. 63/331,766, filed Apr. 15, 2022, and entitled “Hydrophobic Polymer Aerogels,” and to U.S. Provisional Patent Application No. 63/331,775, filed Apr. 15, 2022, and entitled “Hydrophobic Polymer Aerogels,” each of which is incorporated herein by reference in its entirety for all purposes.

### TECHNICAL FIELD

Hydrophobic polymer aerogels (e.g., comprising polyurea, polyurethane, polyisocyanurate, polyimides, or polyamides), and related polymer systems and combinations thereof, as well as methods of manufacture and applications thereof, are generally described.

### SUMMARY

Hydrophobic polymer aerogels (e.g., comprising polyurea, polyurethane, polyisocyanurate, polyimides, or polyamides), and related polymer systems and combinations thereof, as well as methods of manufacture and applications thereof, are generally described. The subject matter of the present disclosure involves, in some cases, interrelated products, alternative solutions to a particular problem, and/or a plurality of different uses of one or more systems and/or articles.

In one aspect, the present disclosure provides aerogels comprising one or more moieties of Formula (M):

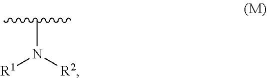

wherein:
each of R¹ is independently a first organic moiety;
each of R² is independently H or a second organic moiety; and
the log P of H—R¹ and/or H—R² determined at about 25° C. and about 1 atm is not lower than 1;
provided that each of the first and second organic moieties is not H. In some such embodiments, the log P of H—R¹ and H—R² determined at about 25° C. and about 1 atm is not lower than 1. In some embodiments in which neither R¹ nor R² is hydrogen, the log P of H—R¹ and H—R² determined at about 25° C. and about 1 atm is not lower than 1.

In another aspect, the present disclosure provides methods for synthesizing an aerogel comprising:
forming a combination comprising a gel precursor and a solvent, and optionally a catalyst;
forming a gel from the combination; and
drying the gel to form the aerogel;
wherein:
a hydrophobe is present at at least one point in time after the beginning of forming the combination and before the completion of drying the gel;
the hydrophobe is a compound of the formula: H—N(R¹)(R²); and
the aerogel comprises one or more moieties of Formula (M):

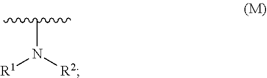

wherein:
each of R¹ is independently a first organic moiety;
each of R² is independently H or a second organic moiety; and
the log P of H—R¹ and/or H—R² determined at about 25° C. and about 1 atm is not lower than 1;
provided that each of the first and second organic moieties is not H. In some such embodiments, the log P of H—R¹ and H—R² determined at about 25° C. and about 1 atm is not lower than 1. In some embodiments in which neither R¹ nor R² is hydrogen, the log P of H—R¹ and H—R² determined at about 25° C. and about 1 atm is not lower than 1.

In another aspect, the present disclosure provides aerogels comprising one or more moieties of Formula (M101):

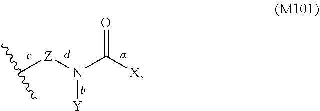

wherein:
   each X is independently

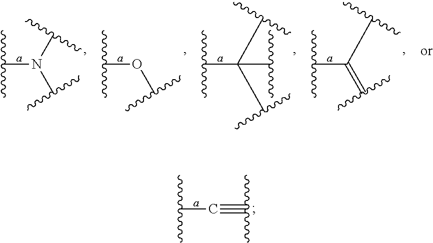

each Y is independently H,

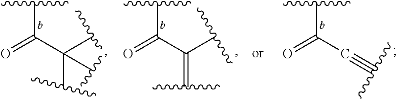

and
each Z is independently a third organic moiety or an inorganic moiety.

In another aspect, the present disclosure provides methods for synthesizing an aerogel comprising:
forming a combination comprising a gel precursor and a solvent, and optionally a catalyst;
forming a gel from the combination; and
drying the gel to form the aerogel;
wherein:
   a hydrophobe is present at at least one point in time after the beginning of forming the combination and before the completion of drying the gel;
   the hydrophobe is a compound of the formula: H—X; and
   the aerogel comprises one or more moieties of Formula (M101):

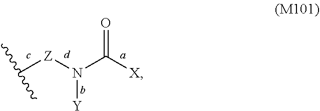

wherein:
each X is independently

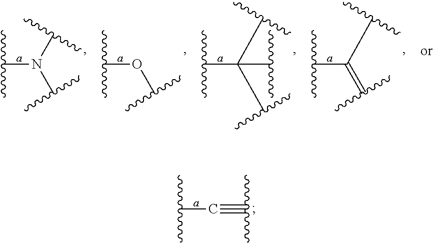

each Y is independently H,

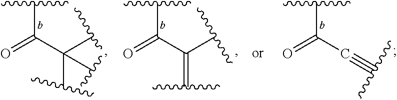

and
each Z is independently a third organic moiety or an inorganic moiety.

In another aspect, the present disclosure provides aerogels prepared by the method of the present disclosure.

In another aspect, the present disclosure provides thin films comprising the aerogel of the present disclosure.

In another aspect, the present disclosure provides monoliths comprising the aerogel of the present disclosure.

In another aspect, the present disclosure provides particles comprising the aerogel of the present disclosure.

In another aspect, the present disclosure provides flexible tapes comprising the aerogel of the present disclosure.

In another aspect, the present disclosure provides ballistics armors, shields, panels, composites, and/or protective vests comprising the aerogel of the present disclosure.

Other advantages and novel features of the present disclosure will become apparent from the following detailed description of various non-limiting embodiments of the disclosure when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present disclosure will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1 is a schematic illustration of the formation of an aerogel, according to some embodiments.

FIG. 2A depicts an aerogel with a water droplet on an exterior surface of the aerogel and the contact angle of the water droplet and the surface of the aerogel, in accordance with certain embodiments.

FIG. 2B depicts an aerogel (left), the aerogel submerged in liquid water under a mesh to hold the aerogel under water (middle), and the aerogel after submersion in liquid water (right), in accordance with certain embodiments.

FIG. 3 depicts the apparatus used to measure thermal conductivity in accordance with the Calibrated Hot Plate (CHP) method described herein, according to certain embodiments.

FIG. 4 depicts the apparatus used to measure flexural strength and modulus of a material according to ASTM D790-10 as described herein, according to certain embodiments.

FIG. 5 depicts an aerogel comprising particulate material, according to certain embodiments.

FIG. 6 depicts an aerogel before exposure to an elevated temperature (left), the aerogel while being exposed to an elevated temperature (middle), and the aerogel after exposure to an elevated temperature (right), according to certain embodiments.

FIGS. 7A-7B depicts the apparatus used to measure dust shedding of an aerogel in its extended and contracted positions as described herein, according to certain embodiments.

FIG. 8 depicts an aerogel and its radius of curvature, according to certain embodiments.

FIG. 9A depicts an aerogel with a facing material over the entirety of an exterior surface of the aerogel, in accordance with certain embodiments.

FIG. 9B depicts an aerogel with a facing material over portions of an exterior surface of the aerogel, in accordance with certain embodiments.

FIG. 9C depicts an aerogel with an adhesive material over an exterior surface of the aerogel, in accordance with certain embodiments.

FIG. 9D depicts an aerogel with an adhesive over an exterior of the aerogel and a facing material over the adhesive, in accordance with certain embodiments.

FIG. 9E depicts an aerogel adhered to another aerogel, in accordance with some embodiments.

FIG. 10 depicts an apparel garment comprising an aerogel, in accordance with certain embodiments.

FIG. 11 depicts a shoe comprising an aerogel, according to certain embodiments.

FIG. 12A depicts an aerogel between individual battery cells, in accordance with certain embodiments.

FIG. 12B depicts an aerogel surrounding a plurality of battery cells, in accordance with certain embodiments.

FIG. 13 depicts a gel submerged in a bath of transfer solvent where the transfer solvent is continuously replacing the liquid in the pores of the gel, according to certain embodiments.

### DETAILED DESCRIPTION

Aerogels are a diverse class of low-density solid materials comprising a porous three-dimensional solid-phase network. Aerogels often exhibit a wide array of desirable diverse and extreme materials properties including high specific surface area, low bulk density, high specific strength and stiffness, low thermal conductivity, and/or low dielectric constant, among others.

Certain aerogel compositions may combine several such properties into the same material envelope and may thus be advantageous for applications including thermal insulation, acoustic insulation, lightweight structures, electronics, apparel, impact damping, electrodes, catalysts, catalyst supports, and/or sensors. Some aerogel materials also possess mechanical properties that make them suitable for use as structural materials and, for example, can be used as lightweight alternatives to plastics.

Polymer aerogels comprising urea, urethane, isocyanurate, imide, amide, phenolic, biuret, uretdione, allophanate, and/or amine can potentially combine numerous valuable materials properties into a single material envelope, for example high mass-normalized strength and stiffness properties, low bulk density, high internal surface area, submicron porosity, low and constant dielectric constant and loss tangent over a wide frequency range, low speed of sound, high sound transmission loss, low to no flammability, machinability, low cost, ease of manufacture, rigidity or flexibility, and low thermal conductivity.

In certain embodiments, the urea comprises a moiety of Formula (M1):

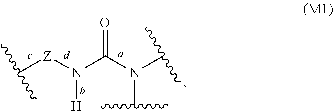

wherein each Z is independently a third organic moiety or an inorganic moiety.

In certain embodiments, the urethane comprises a moiety of Formula (M2):

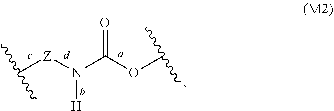

wherein each Z is independently a third organic moiety or an inorganic moiety.

In certain embodiments, the isocyanurate comprises a moiety of Formula (M3):

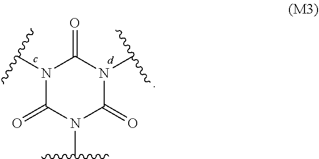 [SMILES: *n1c(=O)n(*)c(=O)n(*)c1=O]

In certain embodiments, the imide comprises a moiety of Formula (M4):

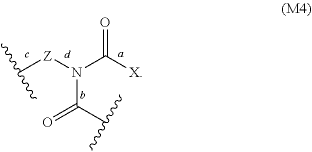

wherein each Z is independently a third organic moiety or an inorganic moiety, and each X is independently

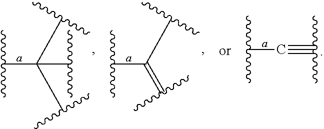

In certain embodiments, the amide comprises a moiety of Formula (M5):

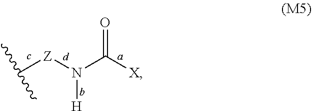

wherein each Z is independently a third organic moiety or an inorganic moiety, and each X is independently

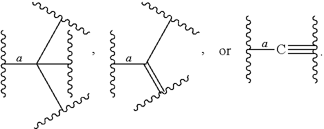

In certain embodiments, the biuret comprises a moiety of Formula (M6):

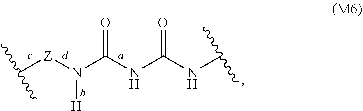

wherein each Z is independently a third organic moiety or an inorganic moiety.

In certain embodiments, the uretdione comprises a moiety of Formula (M7):

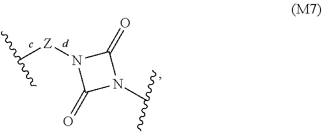

wherein each Z is independently a third organic moiety or an inorganic moiety.

In certain embodiments, the allophanate comprises a moiety of Formula (M8):

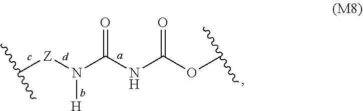

wherein each Z is independently a third organic moiety or an inorganic moiety.

In certain embodiments, the amine comprises a moiety of Formula (M9):

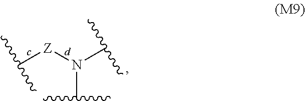

wherein each Z is independently a third organic moiety or an inorganic moiety.

Potential applications of polymer aerogels comprising these moieties include structural insulating components; apparel; building materials; industrial insulation; insulating components for sensors and electronics; shockwave-reflecting and/or energy-absorbing materials in ballistics shields; insulative components for shoes, boots, and insoles; low-k substrates for electronics and antennas; cryogenics; and other applications. Polymer aerogels comprising these moieties are often hydrophilic, i.e., they absorb and retain moisture, liquid- and/or vapor-phase water, and/or polar solvents, in some cases up to 30× their weight in absorbed liquid. Many potential engineering applications for such polymer aerogels, however, require materials that can resist contact with liquid-phase and/or vapor-phase water and/or other polar solvents without degrading, gaining significant weight, or losing performance. Thus, aerogels that comprise these moieties that simultaneously exhibit water-resistant properties are highly desirable for many applications.

In some embodiments, the aerogel comprises a polymer aerogel. A polymer aerogel is an aerogel that is at least partially made of polymeric material. The use of aerogels comprising a relatively high amount of polymeric material can be particularly advantageous, in some embodiments. Thus, in some embodiments, at least 25 wt %, at least 50 wt %, at least 75 wt %, at least 90 wt %, at least 95 wt %, at least 98 wt %, at least 99 wt %, at least 99.9 wt %, or all of the aerogel in the aerogel is made of polymeric material. In some embodiments, at least 25 wt %, at least 50 wt %, at least 75 wt %, at least 90 wt %, at least 95 wt %, at least 98 wt %, at least 99 wt %, at least 99.9 wt %, or all of the aerogel within the aerogel is made of organic polymer, i.e., a polymer having carbon atoms in its backbone. In some embodiments, it can be particularly advantageous to employ polymeric aerogels in which at least 75 atomic percent (at %) (or at least 85 at %, at least 95 at %, at least 99 at %, at least 99.9 at %, or more) of the aerogel material is polymeric material comprising covalently-bonded carbon in its backbone and in which at least 75 at % of the backbone atoms are carbon, nitrogen, oxygen, phosphorous, or sulfur. Examples of organic polymers that can be used as all or part of the aerogel component of the aerogel include, but are not limited to, polyamides, polyimides, polyureas, polyurethanes, polybenzoxazines, polycylopentadienes, polyolefins, polynorbornenes, and biopolymers.

In some embodiments, the polymeric material has a polymeric structure. In some embodiments one or more moieties selected from the group of (M1), (M2), (M3), (M4), (M5), (M6), (M7), (M8), and/or (M9) are part of the polymeric structure of the aerogel. In some embodiments the polymeric structure comprises at least 2, at least 3, at least 4, at least 5, at least 10, at least 15, at least 20, at least 30, at least 40, and/or at least 50 repeating units comprising at least one of the moieties selected from the group of (M1), (M2), (M3), (M4), (M5), (M6), (M7), (M8), and/or (M9). In some embodiments, the polymeric structure comprises repeating units of a single moiety selected from the group of (M1), (M2), (M3), (M4), (M5), (M6), (M7), (M8), and/or (M9). In some embodiments, the polymeric structure comprises repeating units of two or more moieties selected from the group of (M1), (M2), (M3), (M4), (M5), (M6), (M7), (M8), and/or (M9). A moiety (M) can make up, in some cases, at least 1 wt %, at least 2 wt %, at least 5 wt %, at least 10 wt %, at least 25 wt %, at least 50 wt %, at least 60 wt %, at least 70 wt %, at least 80 wt %, at least 90 wt %, at least 95 wt %, and/or at least 99 wt % of the polymer in the aerogel. In some embodiments, at least 1 wt %, at least 2 wt %, at least 5 wt %, at least 10 wt %, at least 25 wt %, at least 50 wt %, at least 60 wt %, at least 70 wt %, at least 80 wt %, at least 90 wt %, at least 95 wt %, and/or at least 99 wt % of the polymer in the aerogel is made up of at least one of (M1), (M2), (M3), (M4), (M5), (M6), (M7), (M8), and (M9). In some embodiments, at least 1 wt %, at least 2 wt %, at least 5 wt %, at least 10 wt %, at least 25 wt %, at least 50 wt %, at least 60 wt %, at least 70 wt %, at least 80 wt %, at least 90 wt %, at least 95 wt %, and/or at least 99 wt % of the polymer in the aerogel is made up of (M1). In some embodiments, at least 1 wt %, at least 2 wt %, at least 5 wt %, at least 10 wt %, at least 25 wt %, at least 50 wt %, at least 60 wt %, at least 70 wt %, at least 80 wt %, at least 90 wt %, at least 95 wt %, and/or at least 99 wt % of the polymer in the aerogel is made up of (M2). In some embodiments, at least 1 wt %, at least 2 wt %, at least 5 wt %, at least 10 wt %, at least 25 wt %, at least 50 wt %, at least 60 wt %, at least 70 wt %, at least 80 wt %, at least 90 wt %, at least 95 wt %, and/or at least 99 wt % of the polymer in the aerogel is made up of (M3). In some embodiments, at least 1 wt %, at least 2 wt %, at least 5 wt %, at least 10 wt %, at least 25 wt %, at least 50 wt %, at least 60 wt %, at least 70 wt %, at least 80 wt %, at least 90 wt %, at least 95 wt %, and/or at least 99 wt % of the polymer in the aerogel is made up of (M4). In some embodiments, at least 1 wt %, at least 2 wt %, at least 5 wt %, at least 10 wt %, at least 25 wt %, at least 50 wt %, at least 60 wt %, at least 70 wt %, at least 80 wt %, at least 90 wt %, at least 95 wt %, and/or at least 99 wt % of the polymer in the aerogel is made up of (M5). In some embodiments, at least 1 wt %, at least 2 wt %, at least 5 wt %, at least 10 wt %, at least 25 wt %, at least 50 wt %, at least 60 wt %, at least 70 wt %, at least 80 wt %, at least 90 wt %, at least 95 wt %, and/or at least 99 wt % of the polymer in the aerogel is made up of (M6). In some embodiments, at least 1 wt %, at least 2 wt %, at least 5 wt %, at least 10 wt %, at least 25 wt %, at least 50 wt %, at least 60 wt %, at least 70 wt %, at least 80 wt %, at least 90 wt %, at least 95 wt %, and/or at least 99 wt % of the polymer in the aerogel is made up of (M7). In some embodiments, at least 1 wt %, at least 2 wt %, at least 5 wt %, at least 10 wt %, at least 25 wt %, at least 50 wt %, at least 60 wt %, at least 70 wt %, at least 80 wt %, at least 90 wt %, at least 95 wt %, and/or at least 99 wt % of the polymer in the aerogel is made up of (M8). In some embodiments, at least 1 wt %, at least 2 wt %, at least 5 wt %, at least 10 wt %, at least 25 wt %, at least 50 wt %, at least 60 wt %, at least 70 wt %, at least 80 wt %, at least 90 wt %, at least 95 wt %, and/or at least 99 wt % of the polymer in the aerogel is made up of (M9). In some embodiments, the polymeric structure comprises a moiety (MRᵢ) wherein M is a polyvalent moiety selected from the group of (M1), (M2), (M3), (M4), (M5), (M6), (M7), (M8), and/or (M9), wherein: Rᵢ represents one or more R groups attached to moiety M; i is a number 1 through n, inclusive, and n is the valence of the moiety M; and wherein each R may independently comprise —H, an alkyl, alkenyl, alkynyl, carbocyclyl, heterocyclyl, aryl, and/or heteroaryl group and/or a moiety selected from the group (M1), (M2), (M3), (M4), (M5), (M6), (M7), (M8), and/or (M9). In some embodiments, the valence n of moiety (M) is equal to 2 or 3. In some embodiments, the R groups attached to moiety (M) are the same. In other embodiments, one or more R groups attached to moiety (M) are different. In some embodiments, an R group attached to moiety (M) is polyvalent. In some embodiments, the valence of the R group is equal to 2, equal to 3, equal to 4, or greater than 4. In some embodiments the polymeric structure comprises at least 2, at least 3, at least 4, at least 5, at least 10, at least 15, at least 20, at least 30, at least 40, and/or at least 50 repeating units of (MRᵢ). In some embodiments, the moiety (MRᵢ) can make up at least 50 wt %, at least 60 wt %, at least 70 wt %, at least 80 wt %, at least 90 wt %, at least 95 wt %, and/or at least 99 wt % of the polymer in the aerogel. In some embodiments, the moiety (MRᵢ) can make up at most 99 wt %, at most 95 wt %, at most 90 wt %, at most 80 wt %, at most 70 wt %, and/or at most 60 wt % of the polymer in the aerogel.

In some embodiments, the aerogel comprises a polyurea aerogel. A polyurea aerogel is an aerogel that is at least partially made out of a polyurea material. In some embodiments, at least 25 wt %, at least 50 wt %, at least 75 wt %, at least 90 wt %, at least 95 wt %, at least 98 wt %, at least 99 wt %, at least 99.9 wt %, or all of the polymer aerogel is made of polyurea. In some embodiments, polyurea aerogels may exhibit one or more materials properties of particular value to engineering applications.

In some embodiments, the aerogel comprises a polyurethane aerogel. A polyurethane aerogel is an aerogel that is at least partially made out of a polyurethane material. In some embodiments, at least 25 wt %, at least 50 wt %, at least 75 wt %, at least 90 wt %, at least 95 wt %, at least 98 wt %, at least 99 wt %, at least 99.9 wt %, or all of the polymer aerogel is made of polyurethane. In some embodiments, polyurethane aerogels may exhibit one or more materials properties of particular value to engineering applications.

In some embodiments, the aerogel comprises a polyisocyanurate aerogel. A polyisocyanurate aerogel is an aerogel that is at least partially made out of a polyisocyanurate material. In some embodiments, at least 25 wt %, at least 50 wt %, at least 75 wt %, at least 90 wt %, at least 95 wt %, at least 98 wt %, at least 99 wt %, at least 99.9 wt %, or all of the polymer aerogel is made of polyisocyanurate. In some embodiments, polyisocyanurate aerogels may exhibit one or more materials properties of particular value to engineering applications.

In some embodiments, the aerogel comprises a poly(isocyanurate-urea) aerogel. A poly(isocyanurate-urea) aerogel is an aerogel that is at least partially made out of a poly(isocyanurate-urea) material. In some embodiments, at least 25 wt %, at least 50 wt %, at least 75 wt %, at least 90 wt %, at least 95 wt %, at least 98 wt %, at least 99 wt %, at least 99.9 wt %, or all of the polymer aerogel is made of poly(isocyanurate-urea). In some embodiments, poly(isocyanurate-urea) aerogels may exhibit one or more materials properties of particular value to engineering applications. In some embodiments, the poly(isocyanurate-urea) aerogel comprises a polymeric structure made up of the moiety (M3)R₃ wherein R is —C₆H₁₂—, —C₆H₄⁻, and/or —C₆H₄—CH₂—C₆H₄⁻, wherein one or more (M3)R₃ moieties are connected to each other by one or more urea linkages.

In accordance with certain embodiments, the present disclosure provides hydrophobic polymer aerogels comprising urea, urethane, isocyanarute, biuret, uretdione, and/or allophanate and methods for making the same.

In some embodiments, polymer aerogels comprising various of the moieties described herein (e.g., of Formulae (M1) to (M9), of Formulae (F1) to (F9), etc.) may be derived from isocyanate precursors. In some embodiments, certain isocyanate precursors are particularly suited for preparing polymer aerogels with desirable properties, for example hexamethylenediisocyanate, methyleediphenyldiisocyanate, toluene diisocyanate, isophorone diisocyanate, the isocyanurate trimer of hexamethylediisocyanate, the isocyanurate trimer of methyleediphenyldiisocyanate, the isocyanrurate trimers of toluene diisocyanate, the isocyanurate trimers of isophorone diisocyanate, and/or trisisocyanatophenyl methane.

In some embodiments, polymer aerogels may be produced by polymerizing one or more isocyanate precursors. In some embodiments, isocyanate precursors may be polymerized with themselves. In some embodiments, isocyanate precursors may be polymerized with an extraneous reactive monomer, such as a polyamine or a polyol. In some embodiments isocyanate precursors may be polymerized via urea linkages. In some embodiments, isocyanate precursors are polymerized via urethane linkages. In some embodiments, isocyanate precursors may be polymerized via multiple types of linkages, for example isocyanate precursors may be polymerized via urea and isocyanurate linkages. In some embodiments, isocyanate precursors may be polymerized via multiple types of linkages, for example isocyanate precursors may be polymerized via urea and urethane linkages. In some embodiments, isocyanate precursors may be polymerized via multiple types of linkages, for example isocyanate precursors may be polymerized via urethane and isocyanurate linkages. In some embodiments, isocyanate precursors may be polymerized via multiple types of linkages, for example isocyanate precursors may be polymerized via urea, urethane, and isocyanurate linkages. In some embodiments, isocyanate precursors may be polymerized into isocyanurate rings. In some embodiments, isocyanate precursors may be polymerized into biuret linkages. In some embodiments isocyanate precursors maybe polymerizes into uretdione linkages. In some embodiments, isocyanate precursors may be polymerized via allophanate linkages. In some embodiments, one or more isocyanate precursors are added to a solvent and then polymerized to form a gel. In some embodiments, water may be added to a solution to a solution of one or more isocyanate precursors in solvent to form urea linkages between isocyanate precursors. In certain embodiments, the isocyanate is replaced by a urea. In some embodiments, the reaction of an isocyanate group on an isocyanate precursor with water will result in conversion of the isocyanate group into an amine group. In some embodiments, an amine group may react with an isocyanate group to form a urea linkage. In some embodiments, a polyol may be added to the reaction mixture. In some embodiments, an isocyanate group may react with a hydroxyl group to form a urethane linkage. In some embodiments, a urethane selective catalyst may be used to form a urethane linkage. In some embodiments, a catalyst may be used to form a urea linkage.

In some embodiments, an aerogel may be produced as follows: reactive monomers are combined with a solvent, and optionally a catalyst. Reaction of monomers in the solvent results in the formation of a gel. A gel is a colloidal system in which a porous, solid-phase network spans the volume occupied by a liquid medium. Accordingly, gels have two components: a sponge-like solid skeleton, which gives the gel its solid-like cohesiveness, and a liquid that permeates the pores of that skeleton. In certain embodiments, to form an aerogel, the liquid may be removed from the gel in a way that minimizes densification of the gel's porous solid network. The removal of liquid from the porous solid network of the gel results in a dry porous aerogel. Removal of liquid from the gel may be performed using any of a variety of methods including controlled evaporative drying, vacuum freeze drying, atmospheric pressure freeze drying, supercritical drying, and/or subcritical drying.

In accordance with some embodiments, a hydrophobic polymer aerogel may be prepared. As synthesized, polymer aerogels comprising the moieties (M1), (M2), (M3), (M4), (M5), (M6), (M7), (M8), and/or (M9) frequently exhibit hydrophilcity. Without wishing to be bound to any particular theory, it is believed that polymer aerogels comprising these moieties may exhibit polar surface functional groups, such as moieties of any one of Formulae (F1) to (F9), that line the internal porous backbone of the aerogel, thereby rendering the aerogel hydrophilic. Such polar surface functional groups may be the result of unreacted terminal functional groups leftover from the polymerization of precursors used to make the aerogel. For example, in some embodiments, monomers used to make polymer aerogels may comprise a polyamine, a polyanhydride, a polyisocyanate, a poly(acyl halide), a poly(carboxylic acid), an aldehyde, an alkyl polyhalide, a polyol, a thionyl halide, phosgene, and/or other reactive monomers. Because aerogels typically exhibit extremely high internal surface areas, such terminal functional groups may be present in a high volumetric density throughout the material. Therefore, replacing these functional groups with nonpolar, non-hydrolyzable, sterically hindered functional groups can convert an otherwise hydrophilic material into a hydrophobic material. In some embodiments, reaction of these surface functional groups with a reactive substance comprising a complementary reactive group may permit conversion of such groups into hydrophobic groups. In some embodiments, these surface groups may be electrophilic. In these cases, a nucleophilic hydrophobe may be used. In some embodiments, these surface groups may be nucleophilic. In these cases, an electrophilic hydrophobe may be used. In accordance with some embodiments herein, conversion of these surface functional groups may be achieved by one or more of several methods. In some embodiments, one or more reactive hydrophobes are included in solution with reactive polymer-building precursors during formation of a gel. In some embodiments, the point in time at which the one or more hydrophobes are introduced into the solution and/or the order in which reactants are introduced into the solution may change materials properties of the resulting aerogel, including hydrophobicity. In some embodiments, adding too much hydrophobe and/or adding hydrophobe at certain times during the gel formation process may surprisingly prevent a gel from forming. In some embodiments in accordance with the invention herein, certain concentrations of one or more hydrophobes and/or timing of addition of one or more hydrophobes may result in the formation of a gel that upon drying will surprisingly result in a hydrophobic polymer aerogel. In some embodiments, one or more hydrophobes are introduced into the pores of a gel after the gel has already set. In some embodiments, one or more hydrophobes are introduced into the pores of a dry aerogel. In some embodiments, one or more hydrophobes are introduced into the pores of the dry aerogel in a vapor-phase. In some embodiments, one or more hydrophobes are introduced into the pores of the dry aerogel in a liquid-phase. In some embodiments, a gel may exhibit more than one hydrophilic surface group. In these cases, more than one type of hydrophobe may be used to convert these groups into hydrophobic groups. In some embodiments, two or more different hydrophobes of complementary chemistries may be used. In some embodiments, one type of hydrophobe may react with a surface group before a second type of hydrophobe reacts with a surface group. In some embodiments, greater than or equal to 1%, greater than or equal to 2%, greater than or equal to 3%, greater than or equal to 4%, greater than or equal to 5%, greater than or equal to 10%, greater than or equal to 20%, greater than or equal to 25%, greater than or equal to 30%, greater than or equal to 35%, greater than or equal to 50%, greater than or equal to 75%, greater than or equal to 95%, greater than or equal to 98%, greater than or equal to 99%, or more of the surface functional groups on a gel may be reacted. A “hydrophobe,” as used herein, is a reactive chemical agent used to impart hydrophobicity unto a gel or aerogel by changing the composition of a surface functional group on the backbone of said gel or aerogel. In some embodiments, a hydrophobe reacts with a surface functional group by a condensation reaction.

As mentioned, in some embodiments, one or more hydrophobes are included in solution with reactive polymer-structure building monomers during the formation of a gel. For example, in some embodiments, polymer-structure building monomers may comprise an amine, an anhydride, an isocyanate, an acyl halide, a carboxylic acid, an aldehyde, an alkyl halide, a alcohol, a thionyl halide, phosgene, and/or other reactive monomers. In some embodiments, the molarity of the one or more hydrophobes in solution may have an effect on materials properties of the resulting aerogel, e.g., the mechanical strength and stiffness, bulk density, thermal conductivity, pore size and/or internal surface area, as well as the ability of a gel to form at all. In some embodiments, one or more monomers that react with one another to form polymer structure are included in a solution. In some embodiments, one or more hydrophobes are included along with these monomers. In some embodiments, too high a concentration of hydrophobe will prevent gelation or result in a weak gel by terminating reactive groups present in the reaction solution that would, otherwise, absent the hydrophobe, result in polymer linkages that give rise to the structure of the gel. In some embodiments, too low a concentration of hydrophobe results in only a minimal modification of residual polar surface groups expressed on the internal solid surfaces in the resulting gel, thereby resulting in a minimal effect on the hydrophobicity of the resulting aerogel.

In some embodiments, reactive monomers that form the polymeric structure of the gel are present in a specified concentration in the solution. This concentration is generally proportional to the weight percent solids of the aerogel that will result upon drying, which, because it is a porous material, comprises a solid component and a void space component. For example, a higher concentration of reactive polymer-structure building monomers may result in a higher density aerogel where a lower concentration of monomers may result in a lower density aerogel. Likewise, in some embodiments, the volumetric density of surface functional groups throughout a gel or aerogel may be related to the weight percent solids of said gel or aerogel. Accordingly, the concentration of hydrophobe in solution relative to the concentration of polymer-structure building monomers may need to be adjusted in order to obtain an aerogel with desirable materials properties. While reducing the weight percent solids in the solution may result in a lower density aerogel, it may also result in an aerogel with higher internal surface area; similarly increasing weight percent solids may result in a higher density aerogel, but a lower internal surface area. This tradeoff translates into competing trends in the number of functional groups required to build the gel's polymer structure and the number of functional groups that will result on the internal solid skeletal surfaces of the backbone of the gel. This said, the proportion of surface functional groups that need to be hydrophobized should generally be balanced against the total number of available functional groups in the solution to maximize resulting hydrophobicity in the aerogel while simultaneously not unduly weakening the polymeric structure of the aerogel by passivating functional groups that are required to form the polymer network. In some embodiments, solution dynamics are such that polymer structures that form in the solution that include bonded hydrophobe result in colloidal structures in which the hydrophobic groups turn outwards into the solution such that reactive polar groups turn inwards into the solid phase of the colloidal structure and/or react and cross-condense within said solid structure (i.e., the hydrophobic part expresses on the surface of the gel rather than becoming trapped within the solid). In some embodiments, the concentration of reactive monomers in solution is a molarity greater than or equal to 0.01 M, greater than or equal to 0.02 M, greater than or equal to 0.03 M, greater than or equal to 0.04 M, greater than or equal to 0.05 M, greater than or equal to 0.1 M, greater than or equal to 0.2 M, greater than or equal to 0.3 M, greater than or equal to 0.4 M, greater than or equal to 0.5 M, greater than or equal to 0.6 M, greater than or equal to 0.7 M, greater than or equal to 0.8 M, greater than or equal to 0.9 M, greater than or equal to 1.0 M, greater than or equal to 1.1 M, greater than or equal to 1.2 M, greater than or equal to 1.3 M, greater than or equal to 1.4 M, greater than or equal to 1.5 M, greater than or equal to 1.6 M, greater than or equal to 1.7 M, greater than or equal to 1.8 M, greater than or equal to 1.9 M, or greater than or equal to 2.0 M. In some embodiments, in can be particularly advantageous for the concentration of reactive monomers in solution to be a molarity greater than or equal to 0.1 M and less than or equal to 1.5 M. In some embodiments, the concentration of all hydrophobes in solution is a molarity greater than or equal to 0.0008 M, greater than or equal to 0.001 M, greater than or equal to 0.01 M, greater than or equal to 0.02 M, greater than or equal to 0.03 M, greater than or equal to 0.04 M, greater than or equal to 0.05 M, greater than or equal to 0.06 M, greater than or equal to 0.07 M, greater than or equal to 0.08 M, greater than or equal to 0.09 M, greater than or equal to 0.1 M, greater than or equal to 0.2 M, greater than or equal to 0.3 M, greater than or equal to 0.4 M, greater than or equal to 0.5 M, greater than or equal to 0.6 M, greater than or equal to 0.7 M, greater than or equal to 0.8 M, greater than or equal to 0.9 M, or greater than or equal to 1.0 M. In some embodiments, it can be particularly advantageous if the concentration of all hydrophobes in solution is a molarity greater than or equal to 0.01 M and less than or equal to 0.5 M. In further embodiments, it can be particularly advantageous if the concentration of all hydrophobes in solution is a molarity greater than or equal to 0.01 M and less than or equal to 0.08 M.

In some embodiments, a ratio of molar concentration of hydrophobe to monomers is greater than or equal to 0.01, greater than or equal to 0.02, greater than or equal to 0.03, greater than or equal to 0.04, greater than or equal to 0.05, greater than or equal to 0.06, greater than or equal to 0.07, greater than or equal to 0.08, greater than or equal to 0.09, greater than or equal to 0.1, greater than or equal to 0.2, greater than or equal to 0.3, greater than or equal to 0.4, greater than or equal to 0.5, greater than or equal to 0.6, greater than or equal to 0.7, greater than or equal to 0.8, greater than or equal to 0.9, or greater than or equal to 1 (and/or, less than or equal to 1, less than or equal to 0.9, less than or equal to 0.8, less than or equal to 0.7, less than or equal to 0.6, or less than or equal to 0.5). In some embodiments, it can be particularly advantageous if a ratio of molar concentration of hydrophobe to monomers is greater than or equal to 0.03 and less than 0.5.

As an illustrative example, in some embodiments, monomers comprising reactive isocyanate and monomers comprising reactive amine are present in a solution. In some embodiments, these monomers may serve as polymer-structure building monomers. In some embodiments, a hydrophobe comprising an amine may be used. In some embodiments, too high a concentration of hydrophobe will prevent gelation or result in a weak gel by terminating reactive isocyanate groups present in the reaction solution that would, otherwise, absent the hydrophobe, result in polymer linkages that give rise to the structure of the gel. In some embodiments, too low a concentration of hydrophobe results in only a minimal modification of residual isocyanate surface groups expressed on the internal solid surfaces in the resulting gel, thereby resulting in a minimal effect on the hydrophobicity of the resulting aerogel. Accordingly, in some embodiments, the concentration of hydrophobe in the reaction medium may be an important parameter in order to obtain an aerogel with desirable properties.

In some embodiments, it is desirable for polymer-structure building monomers to undergo partial reaction prior to introduction of the hydrophobe. It is believed this allows for some skeletal building structures to form without hydrophobe interrupting the structure building process while still allowing for the surfaces of these structure building particles to be surface passivated. In some embodiments, the hydrophobe is added directly to the solution of reactive monomers. In some embodiments, the hydrophobe is diluted and then added to the reactive solution. In some embodiments diluting the hydrophobe in a solvent before adding to the reactive mixture allows for thorough dispersion of the hydrophobe throughout the solution, as the hydrophobe may react quickly on contact with the solution and may thus form macroscopic heterogeneities across the solution if not fully dispersed. As an illustrative example, a first solution comprising an amount of solvent (e.g., acetone), an amount of the isocyanurate trimer of hexamethylenediisocyanate (e.g., Desmodur N3300A), an amount of water, and an amount of catalyst (e.g., triethylamine) can be prepared. Upon addition of the final ingredient, in some embodiments, the reagents are allowed to react for 10 seconds at room temperature. In certain embodiments, a second solution comprising an amount of the same solvent (e.g., acetone) and an amount of a hydrophobe (e.g., dioctylamine) is prepared. The second solution is added to the first solution, in some embodiments, and is quickly and evenly mixed into the first solution forming a third solution. In some embodiments, the third solution is optionally poured into a mold or other substrate and allowed to gel forming a hydrophobic poly(isocyanurate-urea) gel. In some embodiments, adding the hydrophobe to the first solution without first dispersing the hydrophobe in a solvent may result in clumps of hydrophobic poly(isocyanurate-urea) gel where the hydrophobe contacted the first solution instead of a homogeneous gel.

In some embodiments, a hydrophobe may exhibit properties that make it behave as a catalyst when added to a solution of reactive monomers. For example, mono- and/or di-substituted alkyl amines may serve as both suitable hydrophobes and basic catalysts for accelerating gelation. As the hydrophobe is consumed and added onto the forming polymer structure, it is removed from solution and may no longer serve as an effective catalyst. In this regard, the catalytic function of the hydrophobe may decrease with time as it is consumed. In some embodiments, more sterically hindered and/or more substituted hydrophobes such as alkyl amines may exhibit decreased catalytic activity compared to less sterically hindered, less substituted hydrophobes.

In some embodiments, if the liquid in a gel is removed by evaporation, capillary stresses may arise as the liquid-vapor interface recedes into the body of the gel. This liquid-vapor interface which exhibits a surface tension may exert tremendous capillary stresses on the skeletal structure of the gel, causing it to collapse and densify. In some embodiments, it may be desirable to avoid shrinkage of the gel during drying in order to produce a porous aerogel. In some embodiments, a gel may be first solvent exchanged into a target solvent prior to drying. Solvent exchange is the process of displacing the liquid-phase pore fluid of a porous material (e.g., a gel) for another liquid. In some embodiments, solvent exchange is achieved by soaking the porous material in one or more baths of the target solvent. In some embodiments, the composition of the pore fluid within the outer bounds of the porous material may become more rich in the target solvent after diffusion-mediated soaking in a volume of the target solvent as governed by the rule of mixtures. In some embodiments, it may be desirable for the pore fluid of a gel to comprise a suitably high purity of the target solvent before drying the gel to produce an aerogel. In some embodiments, soaking the gel in a series of successive baths of target solvent, allowing the gel to reach compositional equilibrium with the bath, prior to advancing the gel to the next bath, allows for the gel pore fluid to be increased in percentage of target solvent to a desired concentration. Alternatively, a flow of target solvent may be passed over the gel to solvent exchange the gel into the target solvent. In some embodiments, the flow of target solvent may be continuous. In some embodiments, the flow of target solvent may be discontinuous. In some embodiments, the diffusion of target solvent into the gel is quadratically related to the smallest diffusion accessible macroscopic dimension of the gel part. In some embodiments, the smallest diffusion accessible macroscopic dimension of the gel part is the thickness of the gel e.g., for a rectilinear gel block possessing three orthogonal dimensions L, W, and T, where L and W are greater than T, and dimension is T (i.e., the gel thickness). In some embodiments, thinner gels may solvent exchange more quickly than thicker gels. In some embodiments, halving the critical dimension of a gel part quarters the solvent exchange time. In some embodiments, performing solvent exchange of a gel allows for removal of unwanted solvent, unreacted and/or unincorporated monomers and/or oligomers, and/or catalyst to be removed from the porous network of the gel. In some embodiments, the gel may be solvent exchanged into a target solvent with which its pore fluid is miscible.

In some embodiments, a gel may be dried to produce an aerogel. In some embodiments, the liquid in the gel may be removed by evaporation (i.e., evaporative drying). In some embodiments, the liquid in the gel may be brought to supercritical conditions and then depressurized to leave behind a gas in the porous network of what was the gel (i.e., supercritical drying). In some embodiments, the liquid in a gel may be brought near but below its critical point and then depressurized to leave behind a gas in the porous network of what was the gel (i.e., subcritical drying). In some embodiments, the pore fluid of the gel comprises a solvent other than liquid carbon dioxide (e.g., methanol, ethanol, isopropanol, acetone, or acetonitrile) that is brought past its critical point and then depressurized to produce an aerogel (i.e., high temperature supercritical drying). In some embodiments, the liquid in the gel may be frozen and then removed by sublimation (i.e., freeze drying). In some embodiments, it can be particularly advantageous if drying is performed in such a way as to preserve the porosity of the porous network of the gel to produce an aerogel. In some embodiments, it can be particularly advantageous if a gel is solvent exchanged into a low surface tension solvent (e.g., pentane, hexane, heptane, liquid carbon dioxide, or ethoxynonofluorobutane), prior to evaporative drying in order to minimize shrinkage of the gel during evaporation to produce an aerogel. In some embodiments, it can be particularly advantageous if the gel is solvent exchanged into liquid carbon dioxide and supercritically dried from and/or with supercritical carbon dioxide to produce an aerogel. In some embodiments, a flow of supercritical carbon dioxide is passed over the gel after which the gel is depressurized to produce an aerogel. In some embodiments, it can be particularly advantageous if the gel is solvent exchanged into liquid carbon dioxide and brought to near or below the critical point of carbon dioxide and then depressurized to ambient conditions to produce an aerogel. In some embodiments, it can be particularly advantageous if the gel is solvent exchanged into liquid carbon dioxide and evaporatively dried from and/or with liquid carbon dioxide to produce an aerogel. In some embodiments, it can be particularly advantageous if the gel is solvent exchanged into liquid carbon dioxide, the liquid carbon dioxide is frozen (e.g., by rapid depressurization to ambient conditions) and the frozen carbon dioxide is sublimed to produce an aerogel. In some embodiments, the gel is solvent exchanged into tert-butanol after which the gel is frozen, and then freeze-dried to produce an aerogel. In some embodiments, the gel is freeze-dried under vacuum conditions. In some embodiments, the gel is freeze dried at atmospheric pressure. In some embodiments, the gel is freeze-dried at a pressure above atmospheric pressure.

In some embodiments, solvent exchange may be time consuming and/or tedious. As a result, reducing or eliminating the need for solvent exchange may be desirable. In some embodiments, freeze drying a gel from tert-butanol may be desirable. In some embodiments, the pore fluid of the gel must comprise a high concentration of tert-butanol in order to be suitable for freeze drying. In some embodiments, using a solvent that comprises tert-butanol to synthesize a gel may help reduce or eliminate the need for subsequent solvent exchange into tert-butanol prior to freeze drying. In some embodiments, adding tert-butanol to the reaction mixture used to form a polymer gel may reduce the number of solvent exchanges or eliminate the need for solvent exchange prior to freeze drying to produce an aerogel. In some embodiments, addition of tert-butanol to a reaction mixture used to form a polymer gel may compromise materials propertied of the resulting aerogel. In some embodiments, the solvent used to prepare a polymer gel may affect the morphology and/or materials properties of the resulting aerogel. In some embodiments, adding tert-butanol to the reaction mixture used to form a polymer gel may not be possible because reactive monomers required to form the gel may not have good solubility/miscibility in/with tert-butanol and/or polymerization reactions may not proceed efficiently in tert-butanol. In some embodiments, a mixture of tert-butanol and a second solvent (e.g., acetone, methyl ethyl ketone, methyl propyl ketone, ethyl ethyl ketone, and/or methyl butyl ketone) may allow for a suitable gel to be formed while simultaneously reducing the degree to which the gel needs to be solvent exchanged prior to freeze drying to produce an aerogel.

In some embodiments, an aerogel comprising one or more moieties of Formula (M):

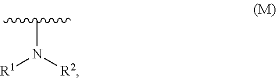

wherein: each of R¹ is independently a first organic moiety; each of R² is independently H or a second organic moiety; and the log P of H—R¹ and/or H—R² determined at about 25° C. and about 1 atm is not lower than 1; provided that each of the first and second organic moieties is not H is provided. In some such embodiments, the log P of H—R¹ and H—R² determined at about 25° C. and about 1 atm is not lower than 1. In some embodiments in which neither R¹ nor R² is hydrogen, the log P of H—R¹ and H—R² determined at about 25° C. and about 1 atm is not lower than 1. In some embodiments, at least one of the moieties of Formula (M) independently comprise one or more fluoro. In some embodiments, the aerogel is a polymer aerogel. In certain embodiments, the log P of H—R¹ and/or H—R² determined at about 25° C. and about 1 atm is not lower than 1. A “partition coefficient” (P) of a compound is the ratio of concentrations of the compound in a mixture of n-octan-1-ol and water at equilibrium. “Log P” of the compound is the logarithm (Log) of the compound's partition coefficient. The compound's Log P is determined according to the equation below:

Log P=Log ((Concentration of the compound in the n-octan-1-ol phase of the mixture)/(Concentration of the compound in the aqueous phase of the mixture)),

e.g., when the compound is not ionized in n-octan-1-ol and water. Log P may be determined at about 25° C. and about 1 atm. A higher Log P value may suggest a higher hydrophobicity. In some embodiments, the log P of H—R¹ determined at about 25° C. and about 1 atm (e.g., when R¹ is not H) is greater than or equal to 1, greater than or equal to 2, greater than or equal to 3, greater than or equal to 4, greater than or equal to 5, greater than or equal to 6, greater than or equal to 7, greater than or equal to 8, greater than or equal to 9, or greater than or equal to 10. In some embodiments, the log P of H—R² (e.g., when R² is not H) determined at about 25° C. and about 1 atm is greater than or equal to 1, greater than or equal to 2, greater than or equal to 3, greater than or equal to 4, greater than or equal to 5, greater than or equal to 6, greater than or equal to 7, greater than or equal to 8, greater than or equal to 9, or greater than or equal to 10. In some embodiments, the log P of (M) determined at about 25° C. and about 1 atm is greater than or equal to 1, greater than or equal to 2, greater than or equal to 3, greater than or equal to 4, greater than or equal to 5, greater than or equal to 6, greater than or equal to 7, greater than or equal to 8, greater than or equal to 9, or greater than or equal to 10. In some embodiments, the log P of the polymer aerogel determined at about 25° C. and about 1 atm is greater than or equal to 1, greater than or equal to 2, greater than or equal to 3, greater than or equal to 4, greater than or equal to 5, greater than or equal to 6, greater than or equal to 7, greater than or equal to 8, greater than or equal to 9, or greater than or equal to 10. In some embodiments, it can be particularly advantageous if the log P of H—R¹ and/or H—R² determined at about 25° C. and about 1 atm is not lower than 1.5, not lower than 2, not lower than 2.5, or not lower than 3.

In another aspect, the present disclosure provides aerogels comprising one or more moieties of Formula (M101):

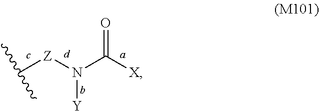

wherein:
each X is independently

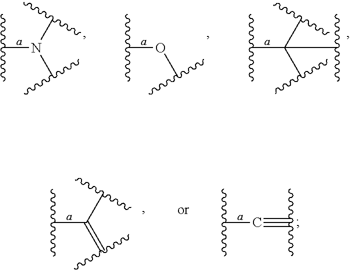

each Y is independently H,

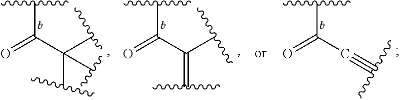

and
each Z is independently a third organic moiety or an inorganic moiety.

In some embodiments, the polymer aerogel comprises one or more moieties of Formula (M101):

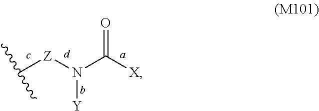

wherein: each X is independently

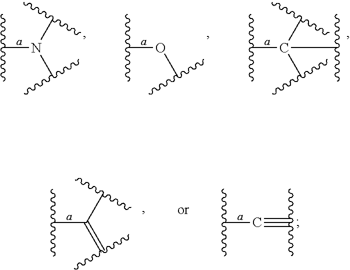

each Y is independently H,

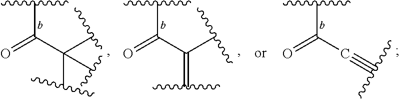

and each Z is independently a third organic moiety or an inorganic moiety. In certain embodiments, at least one

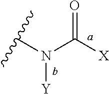

is Formula (M), wherein —C(═O)—X is R¹, and Y is R². In some embodiments, at least one of the moieties of Formula (M101) are independently of Formula (M1):

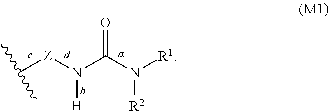

In some embodiments, at least one of the moieties of Formula (M101) are independently of the formula:

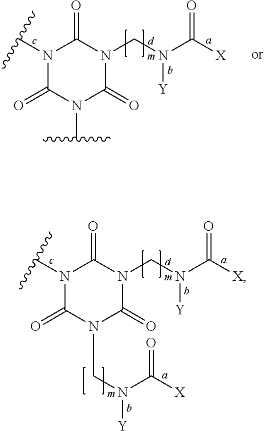

wherein each m is independently an integer between 1 and 12, inclusive.

In some embodiments, at least one m is 1. In some embodiments, at least one m is 2. In some embodiments, at least one m is 3. In some embodiments, at least one m is 4. In some embodiments, at least one m is 5. In some embodiments, at least one m is 6. In some embodiments, at least one m is 7. In some embodiments, at least one m is 8. In some embodiments, at least one m is 9 or 10. In some embodiments, at least one m is 11 or 12.

In some embodiments, at least one of the moieties of Formula (M101) are independently of the formula:

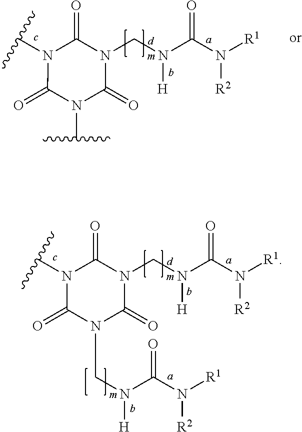

In some embodiments, at least one of the moieties of Formula (M101) are independently of the formula:

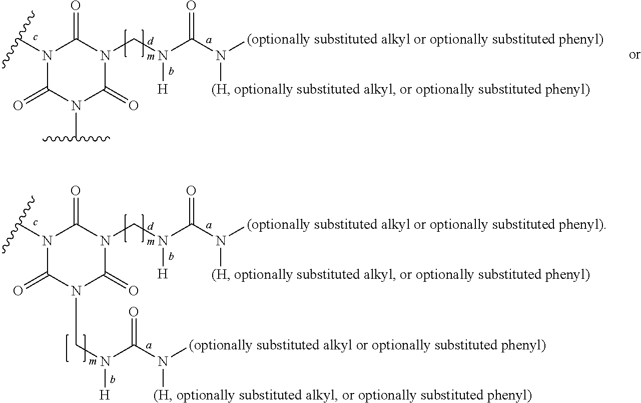

In some embodiments, at least one of the moieties of Formula (M101) are independently of the formula:

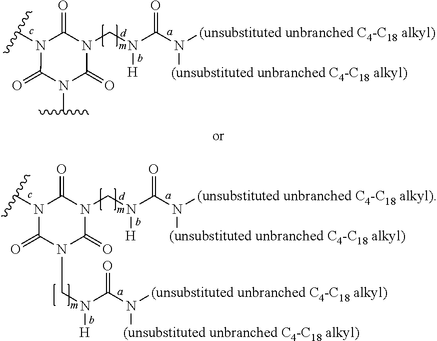

In some embodiments, at least one of the moieties of Formula (M101) are independently of the formula:

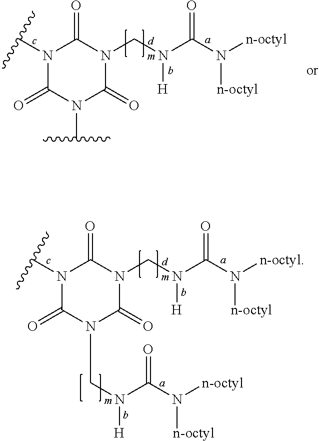

In certain embodiments, at least one of the moieties of Formula (M101) are independently of the formula:

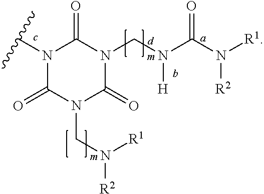

In some embodiments, at least one of the moieties of Formula (M101) are independently of the formula:

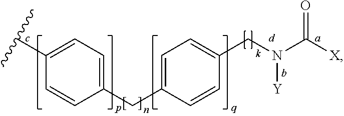

wherein: each p is independently 0 or 1; each n is independently an integer between 1 and 6, inclusive; each q is independently 0 or 1; and each k is independently an integer between 0 and 6, inclusive. In some embodiments, at least one of the moieties of Formula (M101) are independently of the formula:

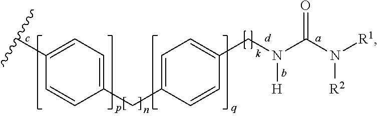

In some embodiments, at least one of the moieties of Formula (M101) are independently of Formula (M2):

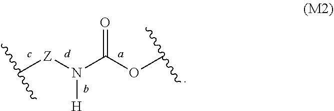

In some embodiments, at least one of the moieties of Formula (M101) are independently of the formula:

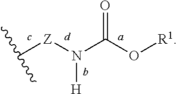

In some embodiments, at least one of the moieties of Formula (M101) are independently of Formula (M4):

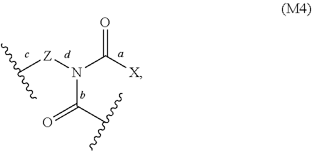

wherein each X is independently

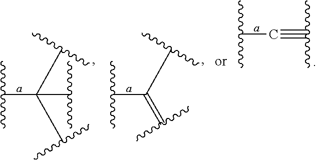

In some embodiments, at least one of the moieties of Formula (M101) are independently of the formula:

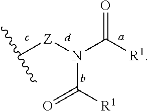

In some embodiments, at least one of the moieties of Formula (M101) are independently of Formula (M5):

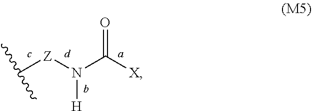

wherein each X is independently

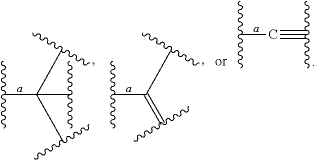

In some embodiments, at least one of the moieties of Formula (M101) are independently of the formula:

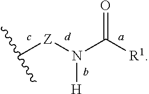

In some embodiments, at least one of the moieties of Formula (M101) are independently of Formula (M6):

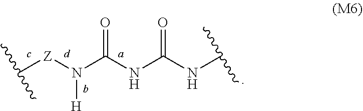

In some embodiments, at least one of the moieties of Formula (M101) are independently of the formula:

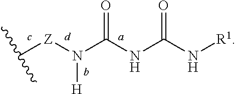

In some embodiments, the aerogel comprises one or more moieties of Formula (M7):

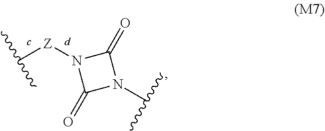

wherein each Z is independently a third organic moiety or an inorganic moiety.

In some embodiments, the aerogel comprises one or more moieties of the formula:

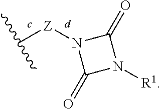

In some embodiments, at least one of the moieties of Formula (M101) are independently of Formula (M8):

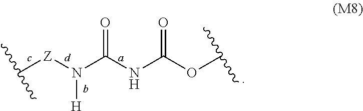

In some embodiments, at least one of the moieties of Formula (M101) are independently of the formula:

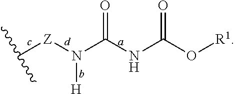

In some embodiments, the aerogel comprises one or more moieties of Formula (M9):

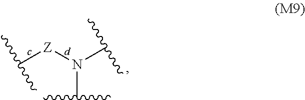

wherein each Z is independently a third organic moiety or an inorganic moiety.

In some embodiments, the aerogel comprises one or more moieties of the formula:

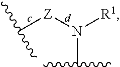

wherein each Z is independently a third organic moiety or an inorganic moiety.

In some embodiments, at least one of the moieties of Formula (M9) are independently of the formula:

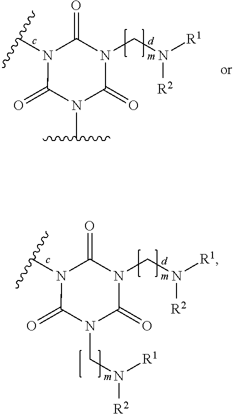

wherein each m is independently an integer between 1 and 12, inclusive.

In some embodiments, the polymer aerogel comprises at least one of the organic polymers comprising, as repeating units, at least one of the moieties of Formula (M101) that are polyvalent radicals. In some embodiment, the polymer aerogel comprises repeating units of the Formula (M101). In some embodiments, the polymer aerogel does not comprise repeating units.

In some embodiments, each R¹ is independently optionally substituted alkyl or optionally substituted phenyl. In some embodiments, each R¹ is independently C₁₋₁₈ alkyl optionally substituted with 1 or more halogen; or phenyl optionally substituted with 1, 2, 3, 4, or 5 substituents independently selected from the group consisting of halogen, C₁₋₁₈ alkyl optionally substituted with 1 or more halogen, —O(C₁₋₁₈ alkyl optionally substituted with 1 or more halogen), and —N(C₁₋₁₈ alkyl optionally substituted with 1 or more halogen)₂. In some embodiments, each R² is independently H, optionally substituted alkyl, or optionally substituted phenyl. In some embodiments, each R² is independently H; C₁₋₁₈ alkyl optionally substituted with 1 or more halogen; or phenyl optionally substituted with 1, 2, 3, 4, or 5 substituents independently selected from the group consisting of halogen, C₁₋₁₈ alkyl optionally substituted with 1 or more halogen, —O(C₁₋₁₈ alkyl optionally substituted with 1 or more halogen), and —N(C₁₋₁₈ alkyl optionally substituted with 1 or more halogen)₂. In some embodiments, at least one R¹ and/or at least one R² are independently optionally substituted alkyl. In some embodiments, at least one R¹ and/or at least one R² independently comprise optionally substituted C₁₋₁₈ alkyl. In certain embodiments, at least one R¹ and/or at least one R² independently is unsubstituted C₄₋₁₈ alkyl. In certain embodiments, at least one R¹ and/or at least one R² independently is unsubstituted C₆₋₁₂ alkyl. In certain embodiments, the alkyl described in this paragraph is unbranched. In certain embodiments, the alkyl described in this paragraph is branched.

In some embodiments, at least one R¹ and/or at least one R² independently comprise partially fluorinated alkyl or perfluoroalkyl. In some embodiments, at least one R¹ and/or at least one R² independently are partially fluorinated C₁₋₁₈ alkyl or perfluoro C₁₋₁₈ alkyl. In some embodiments, at least one R¹ and/or at least one R² independently are partially fluorinated C₄₋₁₈ alkyl or perfluoro C₄₋₁₈ alkyl. In some embodiments, at least one R¹ and/or at least one R² independently are partially fluorinated C₆₋₁₂ alkyl or perfluoro C₆₋₁₂ alkyl. In certain embodiments, the partially fluorinated alkyl or perfluoroalkyl described in this paragraph is unbranched. In certain embodiments, the partially fluorinated alkyl or perfluoroalkyl described in this paragraph is branched.

In certain embodiments, at least one R¹ is optionally substituted alkyl, and at least one R² are H. In certain embodiments, at least one R¹ is unsubstituted C₁₋₁₈ alkyl, partially fluorinated C₁₋₁₈ alkyl, or perfluoro C₁₋₁₈ alkyl, and at least one R² are H. In certain embodiments, at least one R¹ is unsubstituted C₄₋₁₈ alkyl, partially fluorinated C₄₋₁₈ alkyl, or perfluoro C₄₋₁₈ alkyl, and at least one R² are H. In certain embodiments, at least one R¹ is unsubstituted C₆₋₁₂ alkyl, partially fluorinated C₆₋₁₂ alkyl, or perfluoro C₆₋₁₂ alkyl, and at least one R² are H.

In certain embodiments, at least one R¹ is unsubstituted n-hexyl, and at least one R² are H.

In certain embodiments, at least one R¹ is unsubstituted n-octyl, and at least one R² are H.

In certain embodiments, at least one R¹ is unsubstituted n-dodecyl, and at least one R² are H.

In certain embodiments, at least one R¹ is n-perfluorooctyl, and at least one R² are H.

In certain embodiments, at least one R¹ is optionally substituted phenyl, and at least one R² are H.

In certain embodiments, at least one R¹ is pentafluorophenyl, and at least one R² are H.

In certain embodiments, at least one R¹ is 4-trifluoromethoxyphenyl, and at least one R² are H.

In certain embodiments, at least one R¹ and at least one R² independently are each optionally substituted alkyl. In certain embodiments, at least one R¹ and at least one R² independently are each unsubstituted C₁₋₁₈ alkyl, partially fluorinated C₁₋₁₈ alkyl, or perfluoro C₁₋₁₈ alkyl. In certain embodiments, at least one R¹ and at least one R² independently are each unsubstituted C₄₋₁₈ alkyl, partially fluorinated C₄₋₁₈ alkyl, or perfluoro C₄₋₁₈ alkyl. In certain embodiments, at least one R¹ and at least one R² independently are each unsubstituted C₆₋₁₂ alkyl, partially fluorinated C₆₋₁₂ alkyl, or perfluoro C₆₋₁₂ alkyl.

In certain embodiments, at least one R¹ and at least one R² are each n-hexyl.

In certain embodiments, at least one R¹ and at least one R² are each n-octyl.

In certain embodiments, at least one R¹ and at least one R² are each n-dodecyl.

In certain embodiments, at least one R¹ and/or at least one R² independently comprise vinyl. In certain embodiments, at least one R¹ comprise vinyl, and at least one R² are H.

In some embodiments, at least one Z is a third organic moiety. In some embodiments, at least one Z is divalent. In some embodiments, at least one Z is trivalent. In some embodiments, at least one Z is tetravalent. In some embodiments, at least one Z is optionally substituted alkylene, optionally substituted alkenylene, optionally substituted alkynylene, optionally substituted heteroalkylene, optionally substituted heteroalkenylene, optionally substituted heteroalkynylene, optionally substituted carbocyclylene, optionally substituted heterocyclylene, optionally substituted arylene, optionally substituted heteroarylene, or a combination thereof. In some embodiments, at least one Z is optionally substituted heterocyclylene, optionally substituted alkylene, or a combination thereof. In some embodiments, at least one Z is optionally substituted, 4- to 7-membered (e.g., 6-membered), monocyclic heterocyclylene, optionally substituted alkylene (e.g., n-alkylene), or a combination thereof. In some embodiments, at least one

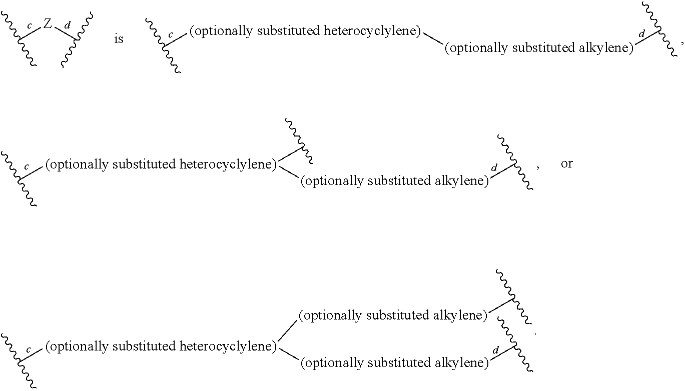

In some embodiments, at least one

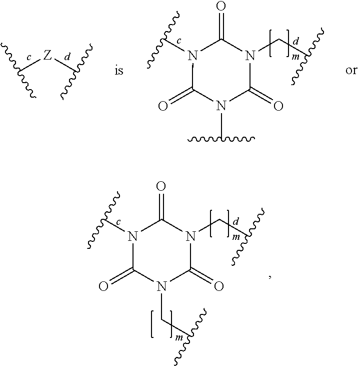

wherein each m is independently an integer between 1 and 12, inclusive.

In some embodiments, at least one Y is H. In some embodiments, at least one X is

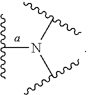 [SMILES: *N(*)*]

In some embodiments, the polymer aerogel comprises more than one moiety of Formula (M) wherein at least two

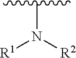

are different from each other. In some embodiments, the polymer aerogel comprises more than one moiety of Formula (M) wherein each

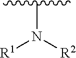

is the same as each other.

In some embodiments, the polymer aerogel comprises one or more organic polymers. In certain embodiments, at least one of the organic polymers comprise at least one of the moieties of Formula (M). In certain embodiments, at least one of the organic polymers do not comprise at least one of the moieties of Formula (M). In some embodiments, the organic polymers comprise one or more: polyureas, polyurethanes, polyamides, polyimides, polyisocyanurates, polyallophanates, polybiurets, poly(isocyanurate-urea)s and/or polyuretdiones. In some embodiments, it can be particularly advantageous if the polymer aerogel comprises at least one of the organic polymers comprising one or more polyureas. In some embodiments, the polymer aerogel comprises at least one of the organic polymers comprising at least one of the moieties of Formula (M) and/or at least one of the moieties of Formula (M101). In some embodiments, it can be particularly advantageous if the polymer aerogel comprises at least one of the polyureas comprising at least one of the moieties of Formula (M) and/or at least one of the moieties of Formula (M101).

In some embodiments, a polymer comprises a urea bond. In some embodiments, an isocyanate reacts with water to form an in-situ formed amine. In some embodiments, an isocyanate reacts with an amine resulting in a urea bond. In some embodiments, a polyisocyanate reacts with a polyamine resulting in a urea bond. In some embodiments, a polymer comprises a urea bond and/or a polyurea. In some embodiments, a polymer gel comprises the polymer. In some embodiments, a polymer aerogel comprises the polymer. In some embodiments, the polymer gel comprises a urea bond and/or a polyurea. In some embodiments, the polymer aerogel comprises a urea bond and/or a polyurea. In some embodiments, the polymer comprises a terminal amine group. In some of these embodiments, a hydrophobe comprising an isocyanate may be used. In further of these embodiments, a hydrophobe comprising an anhydride may be used. In still further of these embodiments, a hydrophobe comprising an acyl halide may be used. In still further of these embodiments, a hydrophobe comprising a carboxylic acid may be used. In some embodiments, the polymer comprises a terminal isocyanate group. In some of these embodiments, a hydrophobe comprising an amine may be used. In further of these embodiments, a hydrophobe comprising an anhydride may be used. In still further of these embodiments, a hydrophobe comprising a carboxylic acid may be used. In some embodiments, the polymer comprises a nucleophilic terminal group. In some of these embodiments, a hydrophobe comprising an electrophilic group may be used. In some embodiments, the polymer comprises an electrophilic terminal group. In some of these embodiments, a hydrophobe comprising a nucleophilic group may be used.

In some embodiments, a polymer comprises an imide bond. In some embodiments, an isocyanate reacts with an anhydride to form an imide bond. In some embodiments, a polyisocyanate reacts with a polyanhydride to form an imide bond. In some embodiments, an amine reacts with an anhydride to form an imide bond. In some embodiments, a polyamine reacts with a polyanhydride to form an imide bond. In some embodiments, a polymer comprises an imide bond and/or a polyimide. In some embodiments, a polymer gel comprises the polymer. In some embodiments, a polymer aerogel comprises the polymer. In some embodiments, the polymer gel comprises an imide bond and/or a polyimide. In some embodiments, the polymer aerogel comprises an imide bond and/or a polyimide. In some embodiments, the polymer gel comprises the polymer. In some embodiments, the polymer aerogel comprises the polymer. In some embodiments, the polymer comprises a terminal amine group. In some of these embodiments, a hydrophobe comprising an isocyanate may be used. In further of these embodiments, a hydrophobe comprising an anhydride may be used. In still further of these embodiments, a hydrophobe comprising an acyl halide may be used. In still further of these embodiments, a hydrophobe comprising a carboxylic acid may be used. In some embodiments, the polymer comprises a terminal anhydride group. In some of these embodiments, a hydrophobe comprising an amine may be used. In some embodiments, the polymer comprises a terminal isocyanate group. In some of these embodiments, a hydrophobe comprising an amine may be used. In further of these embodiments, a hydrophobe comprising an anhydride may be used. In still further of these embodiments, a hydrophobe comprising a carboxylic acid may be used. In some embodiments, the polymer comprises a nucleophilic terminal group. In some of these embodiments, a hydrophobe comprising an electrophilic group may be used. In some embodiments, the polymer comprises an electrophilic terminal group. In some of these embodiments, a hydrophobe comprising a nucleophilic group may be used.

In some embodiments, a polymer comprises a urethane bond. In some embodiments, an isocyanate reacts with an alcohol to form a urethane bond. In some embodiments, a polyisocyanate reacts with a polyol to form a urethane bond. In some embodiments, a polymer comprises a urethane bond and/or a polyurethane. In some embodiments, a polymer gel comprises the polymer. In some embodiments, a polymer aerogel comprises the polymer. In some embodiments, the polymer gel comprises a urethane bond and/or a polyurethane. In some embodiments, the polymer aerogel comprises a urethane bond and/or a polyurethane. In some embodiments, the polymer comprises a terminal isocyanate group. In some of these embodiments, a hydrophobe comprising an amine may be used. In further of these embodiments, a hydrophobe comprising an anhydride may be used. In still further of these embodiments, a hydrophobe comprising a carboxylic acid may be used. In some embodiments, the polymer comprises terminal hydroxyl groups. In some of these embodiments, a hydrophobe comprising an isocyanate may be used. In further of these embodiments, a hydrophobe comprising an acyl halide may be used. In still further of these embodiments, a hydrophobe comprising a carboxylic acid may be used. In some embodiments, the polymer comprises a nucleophilic terminal group. In some of these embodiments, a hydrophobe comprising an electrophilic group may be used. In some embodiments, the polymer comprises an electrophilic terminal group. In some of these embodiments, a hydrophobe comprising a nucleophilic group may be used.

In some embodiments, a polymer comprises an ester bond. In some embodiments, a carboxylic acid reacts with an alcohol to form an ester bond. In some embodiments, a poly(carboxylic acid) reacts with a polyol to form an ester bond. In some embodiments, an acyl halide reacts with an alcohol to form an ester bond. In some embodiments, a poly(acyl halide) reacts with a polyol to form an ester bond. In some embodiments, a polymer comprises an ester bond and/or a polyester. In some embodiments, a polymer gel comprises the polymer. In some embodiments, a polymer aerogel comprises the polymer. In some embodiments, the polymer gel comprises an ester bond and/or a polyester. In some embodiments, the polymer aerogel comprises an ester bond and/or a polyester. In some embodiments, the polymer comprises a terminal carboxylic acid group. In some of these embodiments, a hydrophobe comprising an isocyanate may be used. In further of these embodiments, a hydrophobe comprising a hydroxyl group may be used. In some embodiments, the polymer comprises a terminal hydroxyl group. In some of these embodiments, a hydrophobe comprising an isocyanate may be used. In further of these embodiments, a hydrophobe comprising an acyl halide may be used. In still further of these embodiments, a hydrophobe comprising a carboxylic acid may be used. In some embodiments, the polymer comprises a terminal acyl halide group. In some of these embodiments, a hydrophobe comprising a hydroxyl group may be used. In further of these embodiments, a hydrophobe comprising an amine may be used. In some embodiments, the polymer comprises a nucleophilic terminal group. In some of these embodiments, a hydrophobe comprising an electrophilic group may be used. In some embodiments, the polymer comprises an electrophilic terminal group. In some of these embodiments, a hydrophobe comprising a nucleophilic group may be used.

In some embodiments, a polymer comprises an amide bond. In some embodiments, a carboxylic acid reacts with an amine to form an amide bond. In some embodiments, a poly(carboxylic acid) reacts with a polyamine to form an amide bond. In some embodiments, a carboxylic acid reacts with an isocyanate to form an amide bond. In some embodiments, a poly(carboxylic acid) reacts with a polyisocyanate to form an amide bond. In some embodiments, an acyl halide reacts with an amine to form an amide bond. In some embodiments, a poly(acyl halide) reacts with a polyamine to form an amide bond. In some embodiments, a polymer comprises an amide and/or polyamide. In some embodiments, a polymer gel comprises the polymer. In some embodiments, a polymer aerogel comprises the polymer. In some embodiments, the polymer gel comprises an amide bond and/or a polyamide. In some embodiments, the polymer aerogel comprises an amide bond and/or a polyamide. In some embodiments, the polymer comprises a terminal carboxylic acid group. In some of these embodiments, a hydrophobe comprising an isocyanate may be used. In further of these embodiments, a hydrophobe comprising a hydroxyl group may be used. In still further of these embodiments, a hydrophobe comprising an amine may be used. In some embodiments, the polymer comprises a terminal amine group. In some of these embodiments, a hydrophobe comprising an isocyanate may be used. In further of these embodiments, a hydrophobe comprising an anhydride may be used. In still further of these embodiments, a hydrophobe comprising an acyl halide may be used. In still further of these embodiments, a hydrophobe comprising a carboxylic acid may be used. In some embodiments, the polymer comprises a terminal acyl halide group. In some of these embodiments, a hydrophobe comprising a hydroxyl group may be used. In further of these embodiments, a hydrophobe comprising an amine may be used. In some embodiments, the polymer comprises a terminal isocyanate group. In some of these embodiments, a hydrophobe comprising an amine may be used. In further of these embodiments, a hydrophobe comprising an anhydride may be used. In further of these embodiments, a hydrophobe comprising a hydroxyl group may be used. In still further of these embodiments, a hydrophobe comprising a carboxylic acid may be used. In some embodiments, the polymer comprises a nucleophilic terminal group. In some of these embodiments, a hydrophobe comprising an electrophilic group may be used. In some embodiments, the polymer comprises an electrophilic terminal group. In some of these embodiments, a hydrophobe comprising a nucleophilic group may be used.

In some embodiments, a polymer comprises a phenolic. In some embodiments, an aromatic alcohol reacts with formaldehyde to form a phenolic. In some embodiments, an aromatic amine reacts with formaldehyde to form a phenolic. In some embodiments, an aromatic alcohol reacts with a polyaldehyde to form a phenolic. In some embodiments, an aromatic amine reacts with a polyaldehyde to form a phenolic. In some embodiments, an aromatic polyol reacts with formaldehyde to form a phenolic. In some embodiments, an aromatic polyamine reacts with formaldehyde to form a phenolic. In some embodiments, an aromatic polyamine reacts with a polyaldehyde to form a phenolic. In some embodiments, an aromatic polyol reacts with a polyaldehyde to form a phenolic. In some embodiments, the phenolic comprises a benzoxazine. In some embodiments, the phenolic comprises a benzazine. In some embodiments, the phenolic comprises a novolac. In some embodiments, the phenolic comprises a resole. In some embodiments, a polymer comprises a phenolic. Phenolics include condensation products of aromatic alcohols such as phenol and phloroglucinol with aldehydes such as formaldehyde as well as condensation products of other aromatics such as melamine. In some embodiments, a polymer gel comprises the polymer. In some embodiments, a polymer aerogel comprises the polymer. In some embodiments, the polymer gel comprises a phenolic. In some embodiments, the polymer aerogel comprises a phenolic. In some embodiments, the polymer comprises a terminal hydroxyl group.

The methods of forming aerogels, using hydrophobes, described herein can yield a number of hydrophobized aerogel structures.

In some embodiments, the aerogel comprises one or more moieties of the following structure:

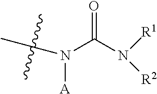

wherein:
each of A is a point of attachment to a precursor of a gel of the aerogel, a gel of the aerogel, and/or the aerogel;
each of R¹ is independently a first organic moiety;
each of R² is independently H or a second organic moiety; and
the log P of each of H—R¹ and/or H—R² determined at about 25° C. and about 1 atm is not lower than 1;
provided that each of the first and second organic moieties is not H.

In some embodiments, the aerogel comprises one or more moieties of the following structure:

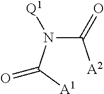

wherein:
each of A¹ is a point of attachment to a precursor of a gel of the aerogel, a gel of the aerogel, and/or the aerogel;
each of A² is either the same point of attachment to the precursor of a gel of the aerogel, the gel of the aerogel, and/or the aerogel as A¹ or a different point of attachment to the precursor of a gel of the aerogel, the gel of the aerogel, and/or the aerogel;
each of Q¹ is independently an organic moiety that is not H; and
the log P of each of H-Q¹ determined at about 25° C. and about 1 atm is not lower than 1.

One example of such a structure is as follows:

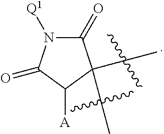

In some embodiments, the aerogel comprises one or more moieties of the following structure:

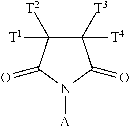

wherein:
each of A is a point of attachment to a precursor of a gel of the aerogel, a gel of the aerogel, and/or the aerogel;
at least one of T¹, T², T³, and T⁴ is an organic moiety that is not H; and
the log P of at least one of H-T¹, H-T², H-T³, and H-T⁴ determined at about 25° C. and about 1 atm is not lower than 1.

In some embodiments, the aerogel comprises one or more moieties of the following structure:

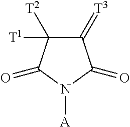

wherein:
each of A is a point of attachment to a precursor of a gel of the aerogel, a gel of the aerogel, and/or the aerogel;
at least one of T¹, T², and T³ is an organic moiety that is not H; and
the log P of at least one of H-T¹, H-T², and H-T³ determined at about 25° C. and about 1 atm is not lower than 1.

In some embodiments, the aerogel comprises one or more moieties of the following structure:

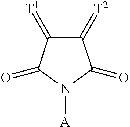

wherein:
each of A is a point of attachment to a precursor of a gel of the aerogel, a gel of the aerogel, and/or the aerogel;
at least one of T¹ and T² is an organic moiety that is not H; and
the log P of at least one of H-T¹ and H-T² determined at about 25° C. and about 1 atm is not lower than 1.

In some embodiments, the aerogel comprises one or more moieties of the following structure:

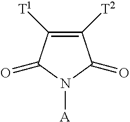

wherein:
each of A is a point of attachment to a precursor of a gel of the aerogel, a gel of the aerogel, and/or the aerogel;
at least one of T¹ and T² is an organic moiety that is not H; and
the log P of at least one of H-T¹ and H-T² determined at about 25° C. and about 1 atm is not lower than 1.

In some embodiments, the aerogel comprises one or more moieties of the following structure:

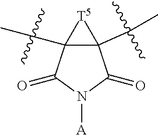

wherein:
each of A is a point of attachment to a precursor of a gel of the aerogel, a gel of the aerogel, and/or the aerogel;
T⁵ comprises one or more atoms establishing a cyclic organic moiety; and
the log P of

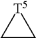

determined at about 25° C. and about 1 atm is not lower than 1.

In some embodiments, the aerogel comprises one or more moieties of the following structure:

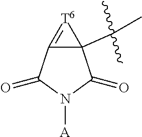

wherein:
each of A is a point of attachment to a precursor of a gel of the aerogel, a gel of the aerogel, and/or the aerogel;
T⁶ comprises one or more atoms establishing a cyclic organic moiety; and
the log P of

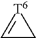

determined at about 25° C. and about 1 atm is not lower than 1.

In some embodiments, the aerogel comprises one or more moieties of the following structure:

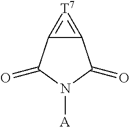

wherein:
each of A is a point of attachment to a precursor of a gel of the aerogel, a gel of the aerogel, and/or the aerogel;
T⁷ comprises two or more atoms establishing a cyclic organic moiety; and
the log P of

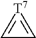

determined at about 25° C. and about 1 atm is not lower than 1.

In some embodiments, the aerogel comprises one or more moieties of the following structure:

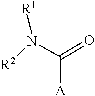

wherein:
each of A is a point of attachment to a precursor of a gel of the aerogel, a gel of the aerogel, and/or the aerogel;
each of R¹ is independently a first organic moiety;
each of R² is independently H or a second organic moiety; and
the log P of each of H—R¹ and/or H—R² determined at about 25° C. and about 1 atm is not lower than 1;
provided that each of the first and second organic moieties is not H.

In some embodiments, the aerogel comprises one or more moieties of the following structure:

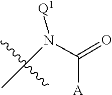

wherein:
each of A is a point of attachment to a precursor of a gel of the aerogel, a gel of the aerogel, and/or the aerogel;
each of Q¹ is independently an organic moiety that is not H; and
the log P of each of H-Q¹ determined at about 25° C. and about 1 atm is not lower than 1.

In some embodiments, the aerogel comprises one or more moieties of the following structure:

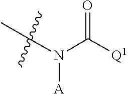

wherein:
each of A is a point of attachment to a precursor of a gel of the aerogel, a gel of the aerogel, and/or the aerogel;
each of Q¹ is independently an organic moiety that is not H; and
the log P of each of H-Q¹ determined at about 25° C. and about 1 atm is not lower than 1.

In some embodiments, the aerogel comprises one or more moieties of the following structure:

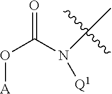

wherein:
each of A is a point of attachment to a precursor of a gel of the aerogel, a gel of the aerogel, and/or the aerogel;
each of Q¹ is independently an organic moiety that is not H; and
the log P of each of H-Q¹ determined at about 25° C. and about 1 atm is not lower than 1.

In some embodiments, the aerogel comprises one or more moieties of the following structure:

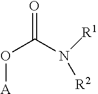

wherein:
each of A is a point of attachment to a precursor of a gel of the aerogel, a gel of the aerogel, and/or the aerogel;
each of R¹ is independently a first organic moiety;
each of R² is independently H or a second organic moiety; and
the log P of each of H—R¹ and/or H—R² determined at about 25° C. and about 1 atm is not lower than 1;
provided that each of the first and second organic moieties is not H.

In some embodiments, the aerogel comprises one or more moieties of the following structure:

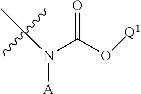

wherein:
each of A is a point of attachment to a precursor of a gel of the aerogel, a gel of the aerogel, and/or the aerogel;
each of Q¹ is independently an organic moiety that is not H; and
the log P of each of H-Q¹ determined at about 25° C. and about 1 atm is not lower than 1.

In some embodiments, the aerogel comprises one or more moieties of the following structure:

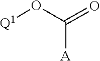

wherein:
each of A is a point of attachment to a precursor of a gel of the aerogel, a gel of the aerogel, and/or the aerogel;
each of Q¹ is independently an organic moiety that is not H; and
the log P of each of H-Q¹ determined at about 25° C. and about 1 atm is not lower than 1.

In some embodiments, the aerogel comprises one or more moieties of the following structure:

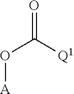

wherein:
each of A is a point of attachment to a precursor of a gel of the aerogel, a gel of the aerogel, and/or the aerogel;
each of Q¹ is independently an organic moiety that is not H; and
the log P of each of H-Q¹ determined at about 25° C. and about 1 atm is not lower than 1.

In some embodiments, the aerogel of any of the above structures comprises one or more organic polymers. In some embodiments, at least one of the organic polymers comprise one or more: polyureas, polyurethanes, polyamides, polyimides, polyisocyanurates, polyallophanates, polybiurets, and/or polyuretdiones. In some embodiments, at least one of the organic polymers comprise one or more polyureas. In some embodiments, at least one of the organic polymers comprise one or more polyurethanes. In some embodiments, at least one of the organic polymers comprise one or more polyamides. In some embodiments, at least one of the organic polymers comprise one or more polyimides. In some embodiments, at least one of the organic polymers comprise one or more polyesters.

In some embodiments of the aerogel of any of the above structures, the log P of each of H—R¹ and H—R² determined at about 25° C. and about 1 atm is not lower than 1. In some embodiments of the aerogel of any of the above structures, neither R¹ nor R² is H, and the log P of each of H—R¹ and H—R² determined at about 25° C. and about 1 atm is not lower than 1.

In some embodiments of the aerogel of any of the above structures, each R¹ is independently C₁₋₁₈ alkyl optionally substituted with 1 or more halogen; or phenyl optionally substituted with 1, 2, 3, 4, or 5 substituents independently selected from the group consisting of halogen, C₁₋₁₈ alkyl optionally substituted with 1 or more halogen, —O(C₁₋₁₈ alkyl optionally substituted with 1 or more halogen), and —N(C₁₋₁₈ alkyl optionally substituted with 1 or more halogen)₂.

In some embodiments of the aerogel of any of the above structures, each R² is independently H, optionally substituted alkyl, or optionally substituted phenyl.

In some embodiments of the aerogel of any of the above structures, each R² is independently H; C₁₋₁₈ alkyl optionally substituted with 1 or more halogen; or phenyl optionally substituted with 1, 2, 3, 4, or 5 substituents independently selected from the group consisting of halogen, C₁₋₁₈ alkyl optionally substituted with 1 or more halogen, —O(C₁₋₁₈ alkyl optionally substituted with 1 or more halogen), and —N(C₁₋₁₈ alkyl optionally substituted with 1 or more halogen)₂.

In some embodiments of the aerogel of any of the above structures, at least one R¹ and/or at least one R² are independently optionally substituted alkyl.

In some embodiments of the aerogel of any of the above structures, at least one R¹ and/or at least one R² independently comprise optionally substituted C₁₋₁₈ alkyl.

In some embodiments of the aerogel of any of the above structures, at least one R¹ and/or at least one R² independently is unsubstituted C₄₋₁₈ alkyl.

In some embodiments of the aerogel of any of the above structures, at least one R¹ and/or at least one R² independently comprise partially fluorinated alkyl or perfluoroalkyl.

In some embodiments of the aerogel of any of the above structures, at least one R¹ is unsubstituted n-hexyl, and at least one R² are H.

In some embodiments of the aerogel of any of the above structures, at least one R¹ is unsubstituted n-octyl, and at least one R² are H.

In some embodiments of the aerogel of any of the above structures, at least one R¹ is unsubstituted n-dodecyl, and at least one R² are H.

In some embodiments of the aerogel of any of the above structures, at least one R¹ is n-perfluorooctyl, and at least one R² are H.

In some embodiments of the aerogel of any of the above structures, at least one R¹ is optionally substituted phenyl, and at least one R² are H.

In some embodiments of the aerogel of any of the above structures, at least one R¹ is pentafluorophenyl, and at least one R² are H.

In some embodiments of the aerogel of any of the above structures, at least one R¹ is 4-trifluoromethoxyphenyl, and at least one R² are H.

In some embodiments of the aerogel of any of the above structures, at least one R¹ and at least one R² are each n-hexyl.

In some embodiments of the aerogel of any of the above structures, at least one R¹ and at least one R² are each n-octyl.

In some embodiments of the aerogel of any of the above structures, at least one R¹ and at least one R² are each n-dodecyl.

In some embodiments of the aerogel of any of the above structures, at least one R¹ and/or at least one R² independently comprise vinyl.

In some embodiments of the aerogel of any of the above structures, each Q¹ is independently C₁₋₁₈ alkyl optionally substituted with 1 or more halogen; or phenyl optionally substituted with 1, 2, 3, 4, or 5 substituents independently selected from the group consisting of halogen, C₁₋₁₈ is alkyl optionally substituted with 1 or more halogen, —O(C₁₋₁₈ alkyl optionally substituted with 1 or more halogen), and —N(C₁₋₁₈ alkyl optionally substituted with 1 or more halogen)₂.

In some embodiments of the aerogel of any of the above structures, at least one Q¹ is optionally substituted alkyl. In some embodiments of the aerogel of any of the above structures, at least one Q¹ comprises optionally substituted C₁₋₁₈ alkyl. In some embodiments of the aerogel of any of the above structures, at least one Q¹ is unsubstituted C₄₋₁₈ alkyl. In some embodiments of the aerogel of any of the above structures, at least one Q¹ comprises partially fluorinated alkyl or perfluoroalkyl. In some embodiments of the aerogel of any of the above structures, at least one Q¹ is unsubstituted n-hexyl. In some embodiments of the aerogel of any of the above structures, at least one Q¹ is unsubstituted n-octyl. In some embodiments of the aerogel of any of the above structures, at least one Q¹ is unsubstituted n-dodecyl. In some embodiments of the aerogel of any of the above structures, at least one Q¹ is n-perfluorooctyl. In some embodiments of the aerogel of any of the above structures, at least one Q¹ is optionally substituted phenyl. In some embodiments of the aerogel of any of the above structures, at least one Q¹ is pentafluorophenyl. In some embodiments of the aerogel of any of the above structures, at least one Q¹ is 4-trifluoromethoxyphenyl. In some embodiments of the aerogel of any of the above structures, at least one Q¹ comprises vinyl.

In some embodiments of the aerogel of any of the above structures, at least one of T¹, T², T³, and T⁴ is independently C₁₋₁₈ alkyl optionally substituted with 1 or more halogen; or phenyl optionally substituted with 1, 2, 3, 4, or 5 substituents independently selected from the group consisting of halogen, C₁₋₁₈ alkyl optionally substituted with 1 or more halogen, —O(C₁₋₁₈ alkyl optionally substituted with 1 or more halogen), and —N(C₁₋₁₈ alkyl optionally substituted with 1 or more halogen)₂. In some embodiments of the aerogel of any of the above structures, at least one of T¹, T², T³, and T⁴ is independently optionally substituted alkyl. In some embodiments of the aerogel of any of the above structures, at least one of T¹, T², T³, and T⁴ is independently optionally substituted C₁₋₁₈ alkyl. In some embodiments of the aerogel of any of the above structures, at least one of T¹, T², T³, and T⁴ is independently unsubstituted C₄₋₁₈ alkyl. In some embodiments of the aerogel of any of the above structures, at least one of T¹, T², T³, and T⁴ is independently comprises partially fluorinated alkyl or perfluoroalkyl. In some embodiments of the aerogel of any of the above structures, at least one of T¹, T², T³, and T⁴ is independently unsubstituted n-hexyl. In some embodiments of the aerogel of any of the above structures, at least one of T¹, T², T³, and T⁴ is independently unsubstituted n-octyl. In some embodiments of the aerogel of any of the above structures, at least one of T¹, T², T³, and T⁴ is independently unsubstituted n-dodecyl. In some embodiments of the aerogel of any of the above structures, at least one of T¹, T², T³, and T⁴ is independently is n-perfluorooctyl. In some embodiments of the aerogel of any of the above structures, at least one of T¹, T², T³, and T⁴ is independently optionally substituted phenyl. In some embodiments of the aerogel of any of the above structures, at least one of T¹, T², T³, and T⁴ is independently pentafluorophenyl. In some embodiments of the aerogel of any of the above structures, at least one of T¹, T², T³, and T⁴ is independently. In some embodiments of the aerogel of any of the above structures, at least one of T¹, T², T³, and T⁴ independently comprises vinyl. In some embodiments of the aerogel of any of the above structures, the one or more atoms of T⁵ include one or more atoms chosen from carbon, oxygen, nitrogen, sulfur, phosphorus, or silicon.

In some embodiments of the aerogel of any of the above structures, the cyclic organic moiety established by the one or more atoms of at least one T⁵ comprises an optionally substituted carbocyclic moiety.

In some embodiments of the aerogel of any of the above structures, the cyclic organic moiety established by the one or more atoms of at least one T⁵ comprises an optionally substituted cycloalkyl moiety.

In some embodiments of the aerogel of any of the above structures, the cyclic organic moiety established by the one or more atoms of at least one T⁵ comprises an optionally substituted heterocyclic moiety.

In some embodiments of the aerogel of any of the above structures, the cyclic organic moiety established by the one or more atoms of at least one T⁵ comprises an optionally substituted aromatic moiety.

In some embodiments of the aerogel of any of the above structures, the cyclic organic moiety established by the one or more atoms of at least one T⁵ comprises an optionally substituted heteroaromatic moiety.

In some embodiments of the aerogel of any of the above structures, the one or more atoms of T⁶ include one or more atoms chosen from carbon, oxygen, nitrogen, sulfur, phosphorus, or silicon.

In some embodiments of the aerogel of any of the above structures, the cyclic organic moiety established by the one or more atoms of at least one T⁶ comprises an optionally substituted carbocyclic moiety.

In some embodiments of the aerogel of any of the above structures, the cyclic organic moiety established by the one or more atoms of at least one T⁶ comprises an optionally substituted heterocyclic moiety.

In some embodiments of the aerogel of any of the above structures, the cyclic organic moiety established by the one or more atoms of at least one T⁶ comprises an optionally substituted aromatic moiety.

In some embodiments of the aerogel of any of the above structures, the cyclic organic moiety established by the one or more atoms of at least one T⁶ comprises an optionally substituted heteroaromatic moiety.

In some embodiments of the aerogel of any of the above structures, the two or more atoms of T⁷ include one or more atoms chosen from carbon, oxygen, nitrogen, sulfur, phosphorus, or silicon.

In some embodiments of the aerogel of any of the above structures, the cyclic organic moiety established by the two or more atoms of at least one T⁷ comprises an optionally substituted carbocyclic moiety.

In some embodiments of the aerogel of any of the above structures, the cyclic organic moiety established by the two or more atoms of at least one T⁷ comprises an optionally substituted heterocyclic moiety.

In some embodiments of the aerogel of any of the above structures, the cyclic organic moiety established by the two or more atoms of at least one T⁷ comprises an optionally substituted aromatic moiety.

In some embodiments of the aerogel of any of the above structures, the cyclic organic moiety established by the two or more atoms of at least one T⁷ comprises an optionally substituted heteroaromatic moiety.

In certain embodiments, a hydrophobe is useful in a method of preparing the aerogels. In certain embodiments, the hydrophobe comprises anhydride, carboxylic acid, acyl halide, amino, mono-substituted amine, disubstituted amine, isocyanate, and/or aldehyde.

In certain embodiments, the anhydride is of the formula:

Z¹—C(═O)—O—C(═O)—Z² (F1).

In certain embodiments, the carboxylic acid is of the formula:

Z¹—C(═O)—OH (F2).

In certain embodiments, the acyl halide is of the formula:

Z¹—C(═O)-halogen (F3).

In certain embodiments, the amino is of the formula:

NH₃ (F4).

In certain embodiments, the mono-substituted amine is of the formula:

Z³—NH₂ (F5).

In certain embodiments, the disubstituted amine is of the formula:

Z³—NH—Z⁴ (F6).

In certain embodiments, the isocyanate is of the formula:

Z⁵—NCO (F7).

In certain embodiments, the aldehyde is of the formula:

Z¹—C(═O)—H (F8).

In certain embodiments, the hydroxyl is of the formula:

Z¹—OH (F9).

In some embodiments, a hydrophobe is an anhydride, a carboxylic acid, an acyl halide, an amino, a mono-substituted amine, an isocyanate, an aldehyde or a hydroxyl.

In certain embodiments, the anhydride is of the formula:

Z¹—C(═O)—O—C(═O)—Z² (H1).

In certain embodiments, the carboxylic acid is of the formula:

Z¹—C(═O)—OH (H2).

In certain embodiments, the acyl halide is of the formula:

Z¹—C(═O)-halogen (H3).

In certain embodiments, the amino is of the formula:

NH₃ (H4).

In certain embodiments, the mono-substituted amine is of the formula:

Z³—NH₂ (H5).

In certain embodiments, the disubstituted amine is of the formula:

Z³—NH—Z⁴ (H6).

In certain embodiments, the isocyanate is of the formula:

Z⁵—NCO (H7).

In certain embodiments, the aldehyde is of the formula:

Z¹—C(═O)—H (H8).

In certain embodiments, the hydroxyl is of the formula:

Z¹—OH (H9).

Each of Z¹ to Z⁵ is independently a first organic moiety, provided that the first organic moiety is not H. In certain embodiments, at least one Z¹ is optionally substituted alkyl or optionally substituted phenyl. In certain embodiments, at least one Z² is optionally substituted alkyl or optionally substituted phenyl. In certain embodiments, at least one Z³ is R¹. In certain embodiments, at least one Z³ is optionally substituted alkyl or optionally substituted phenyl. In certain embodiments, at least one Z⁴ is R¹. In certain embodiments, at least one Z⁴ is optionally substituted alkyl or optionally substituted phenyl. In certain embodiments, at least one Z⁵ is optionally substituted alkyl or optionally substituted phenyl.

In some of these embodiments, a hydrophobe comprising an isocyanate may be used. In further of these embodiments, a hydrophobe comprising an acyl halide may be used. In still further of these embodiments, a hydrophobe comprising a carboxylic acid may be used. In some embodiments, the polymer comprises a terminal amine group. In some of these embodiments, a hydrophobe comprising an isocyanate may be used. In further of these embodiments, a hydrophobe comprising an anhydride may be used. In still further of these embodiments, a hydrophobe comprising an acyl halide may be used. In still further of these embodiments, a hydrophobe comprising a carboxylic acid may be used. In some embodiments, the polymer comprises a terminal aldehyde group. In some of these embodiments, a hydrophobe comprising an amine may be used. In some embodiments, the polymer comprises a nucleophilic terminal group. In some of these embodiments, a hydrophobe comprising an electrophilic group may be used. In some embodiments, the polymer comprises an electrophilic terminal group. In some of these embodiments, a hydrophobe comprising a nucleophilic group may be used.

In some embodiments, the gel precursor comprises isocyanate. In some embodiments, the gel precursor comprises isocyanate, and the hydrophobe comprises amino or mono-substituted amino. In some embodiments, the gel precursor comprises isocyanate, and the hydrophobe comprises hydroxy. In some embodiments, the gel precursor comprises anhydride, carboxy, or acyl halide. In some embodiments, the gel precursor comprises anhydride, carboxy, or acyl halide, and the hydrophobe comprises amino or mono-substituted amino. In some embodiments, the gel precursor comprises anhydride, carboxy, or acyl halide, and the hydrophobe comprises hydroxy. In some embodiments, the gel precursor comprises amino or mono-substituted amino. In some embodiments, the gel precursor comprises amino or mono-substituted amino, and the hydrophobe comprises isocyanate. In some embodiments, the gel precursor comprises amino or mono-substituted amino, and the hydrophobe comprises anhydride, carboxy, or acyl halide. In some embodiments, the gel precursor comprises hydroxy. In some embodiments, the gel precursor comprises hydroxy, and the hydrophobe comprises isocyanate. In some embodiments, the gel precursor comprises hydroxy, and the hydrophobe comprises anhydride, carboxy, or acyl halide.

In certain embodiments, an isocyanate is useful in a method of preparing the aerogels. In some embodiments, the isocyanate comprises a triisocyanate; an aliphatic triisocyanate; an aromatic isocyanate comprising three or more isocyanate groups; an aromatic triisocyanate; a triisocyanate based on hexamethylene diisocyanate; the trimer of hexamethylenediisocyanate; hexamethylenediisocyanate; a triisocyanate comprising isocyanurate; a diisocyanate comprising isocyanurate; Desmodur® N3200; Desmodur N3300; Desmodur N100; Desmodur N3400; Desmodur N3390; Desmodur N3390 BA/SN; Desmodur N3300 BA; Desmodur N3600; Desmodur N3790 BA; Desmodur N3800; Desmodur N3900; Desmodur XP 2675; Desmodurblulogiq 3190; Desmodur XP 2860; Desmodur N3400; Desmodur XP 2840; Desmodur N3580 BA; Desmodur N3500; Desmodur RE; tris(isocyanatophenyl)methane; Desmodur RC; Mondur® MR; Mondur MRS; a methylene diphenyl diisocyanate; diphenylmethane 2,2′-, 2,4′- and/or 4,4′-diisocyanate (MDI); naphthylene 1,5-diisocyanate (NDI); a toluene diisocyanate; toluene 2,4- and/or 2,6-diisocyanate (TDI); 3,3′-dimethylbiphenyl diisocyanate; 1,2-diphenylethane diisocyanate and/or p-phenylenediisocyanate (PPDI); trimethylene, tetramethylene, pentamethylene, hexamethylene, heptamethylene and/or octamcthylcncdiisocyanate; 2-mcthylpentamcthylcnc 1,5-diisocyanate; 2-ethylbutylene 1,4-diisocyanate; pentamethylene 1,5-diisocyanate; butylene 1,4-diisocyanate; 1-isocyanato-3,3,5-trimethyl-5-isocyanatomethylcyclohexane (isophoronediisocyanate, IPDI); 1,4- and/or 1,3-bis(isocyanatomethyl)cyclohexane (HXDI); cyclohexane 1,4-diisocyanate; 1-methylcyclohexane 2,4-diisocyanate; 1-methylcyclohexane 2,6-diisocyanate; dicyclohexylmethane 4,4′-diisocyanate; dicyclohexylmethane 2,4′-diisocyanate; and/or dicyclohexylmethane 2,2′-diisocyanate. In some embodiments, the isocyanate comprises Desmodur N3300.

In certain embodiments, an anhydride is useful in a method of preparing the aerogels. In some embodiments, the anhydride comprises an aromatic dianhydride; an aromatic trianhydride; an aromatic tetraanhydride; an aromatic anhydride having between 6 and about 24 carbon atoms and between 1 and about 4 aromatic rings which may be fused, coupled by biaryl bonds, or linked by one or more linking groups selected from C1-6 alkylene, oxygen, sulfur, keto, sulfoxide, sulfone and the like; biphenyl-3,3′,4,4′-tetracarboxylic dianhydride (BPDA); 3,3′,4,4′-biphenyl tetracarboxylicdianhydride; 2,3,3′,4′-biphenyl tetracarboxylic acid dianhydride (a-BPDA); 2,2′,3,3′-biphenyl tetracarboxylicdianhydride; 3,3′,4,4′-benzophenone-tetracarboxylic dianhydride; benzophenone-3,3′,4,4′-tetracarboxylic dianhydride (BTDA); pyromelliticdianhydride; 4,4′-hexafluoro isopropylidenebisphthalicdianhydride (6FDA); 4,4′-(4,4′-isopropylidene diphenoxy)-bis(phthalic anhydride); 4,4′-oxydiphthalic anhydride (ODPA); 4,4′-oxydiphthalic dianhydride; 3,3′,4,4′-diphenylsulfonetetracarboxylicdianhydride (DSDA); hydroquinone dianhydride; hydroquinone diphthalic anhydride (HQDEA); 4,4′-bisphenol A dianhydride (BPADA); ethylene glycol bis(trimellitic anhydride) (TMEG); 2,2-bis(3,4-dicarboxyphenyl)propanedianhydride; bis(3,4-dicarboxyphenyl)sulfoxide dianhydride; poly(siloxane-containing dianhydride); 2,3,2′,3′-benzophenone tetracarboxylicdianhydride; 3,3′,4,4′-benzophenone tetracarboxylic dianhydride; naphthalene-2,3,6,7-tetracarboxylic dianhydride; naphthalene-1,4,5,8-tetracarboxylic dianhydride; 3,3′,4,4′-biphenylsulfone tetracarboxylicdianhydride; 3,4,9,10-perylene tetracarboxylicdianhydride; bis(3,4-dicarboxyphenyl)sulfide dianhydride; bis(3,4-dicarboxyphenyl)methane dianhydride; 2,2-bis(3,4-dicarboxyphenyl)propane dianhydride; 2,2-bis(3,4-dicarboxyphenyl)hexafluoropropene; 2,6-dichloro naphthalene 1,4,5,8-tetracarboxylic dianhydride; 2,7-dichloronaphthalene-1,4,5,8-tetracarboxylic dianhydride; 2,3,6,7-tetrachloronaphthalene-1,4,5,8-tetracarboxylic dianhydride; phenanthrene-8,9,10-tetracarboxylic dianhydride; pyrazine-2,3,5,6-tetracarboxylic dianhydride; benzene-1,2,3,4-tetracarboxylic dianhydride; and/or thiophene-2,3,4,5-tetracarboxylic dianhydride.

In certain embodiments, an amine is useful in a method of preparing the aerogels. In some embodiments, the amine comprises 3,4′-oxydianiline (3,4-ODA); 4,4′-oxydianiline (4,4-ODA or ODA); p-phenylene diamine (pPDA); m-phenylene diamine (mPDA); p-phenylene diamine (mPDA); 2,2′-dimethylbenzidine (DMBZ); 4,4′-bis(4-aminophenoxy)biphenyl; 2,2′-his[4-(4-aminophenoxyl)phenyl]propane; bisaniline-p-xylidene (BAX); 4,4′-methylene dianiline (MDA); 4,4′-[1,3-phenylenebis(1-methyl-ethylidene)]bisaniline (bisaniline-m); 4,4′-[1,4-phenylenebis(1-methyl-ethylidene)]bisaniline (bisaniline-p); 3,3′-dimethyl-4,4′-diaminobiphenyl (o-tolidine); 2,2-bis [4-(4-aminophenoxy)phenyl]propane (BAPP); 3,3′-dihydroxy-4,4′-diamino-biphenyl (HAB); 3,3′-diaminodiphenyl sulfone (3,3′-DDS); 4,4′-diaminodiphenyl sulfone (4,4′-DDS); 4,4′-diaminodiphenyl sulfide (ASD); 2,2-bis [4-(4-aminophenoxy) phenyl]sulfone (BAPS); 2,2-bis[4-(3-aminophenoxy) benzene](m-BAPS); 1,4-bis(4-aminophenoxy) benzene (TPE-Q); 1,3-bis(4-aminophenoxy) benzene (TPE-R); 1,3′-bis(3-aminophenoxy) benzene (APB-133); 4,4′-bis(4-aminophenoxy) biphenyl (BAPB); 4,4′-diaminobenzanilide (DABA); 9,9′-bis(4-aminophenyl) fluorene (FDA); o-tolidine sulfone (TSN); methelenebis(anthranilic acid) (MBAA); 1,3′-bis(4-aminophenoxy)-2,2-dimethylpropane (DANPG); 2,3,5,6-tetramethyl-1,4-phenylenediamine (TMPD); 3,3′,5,5′-tetramethylbenzidine (3355TMB); 1,5-bis(4-aminophenoxy) pentane (DA5MG); 2,5-diaminobenzotrifluoride (25DBTF); 3,5-diaminobenzotrifluoride (35DBTF); 1,3-diamino-2,4,5,6-tetrafluorobenzene (DTFB); 2,2′-bis(trifluoromethyl)benzidine (22TFMB); 3,3′-bis(trifluoromethyl)benzidine (33TFMB); 2,2-bis[4-(4-aminophenoxy phenyl)]hexafluoropropane (HFBAPP); 2,2-bis(4-aminophenyl)hexafluoropropane (Bis-A-AF); 2,2-bis(3-amino-4-hydroxyphenyl)hexafluoropropane (Bis-AP-AF); 2,2-bis(3-amino-4-methylphenyl)hexafluoropropane (Bis-AT-AF); o-phenylene diamine; diaminobenzanilide; 3,5-diaminobenzoic acid; 3,3′diaminodiphenylsulfone; 4,4′-diaminodiphenylsulfone; 1,3-bis-(4-aminophenoxy)benzene; 1,3-bis(3-aminophenoxy)benzene; 1,4-bis(4aminophenoxy)benzene; 1,4-bis(3-aminophenoxy)benzene; 2,2-bis[4-(4-aminophenoxy)phenyl]hexafluoropropane; 2,2-bis(3-aminophenyl)hexafluoropropane; 4,4′-isopropylidenedianiline; 1-(4-aminophenoxy)-3-(3-aminophenoxy)benzene; 1-(4-aminophenoxy)-4-(3-aminophenoxy)benzene; bis[4-(4aminophenoxy)phenyl]sulfone; his[4-(3-aminophenoxy)phenyl]sulfone; bis(4-[4-aminophenoxy]phenyl)ether; 2,2′-bis(4-aminophenyl)hexafluoropropene; 2,2′-bis(4-phenoxyaniline)isopropylidene; 1,2-diaminobenzene; 4,4′-diaminodiphenylmethane; 2,2-bis(4-aminophenyl)propane; 4,4′-diaminodiphenylpropane; 4,4′-diaminodiphenylsulfide; 4,4-diaminodiphenylsulfone; 3,4′-diaminodiphenylether; 4,4′-diaminodiphenylether; 2,6-diaminopyridine; bis(3-aminophenyl)diethylsilane; 4,4′-diaminodiphenyldiethylsilane; benzidine-3′-dichlorobenzidine; 3,3′-dimethoxybenzidine; 4,4′-diaminobenzophenone; N,N-bis(4-aminophenyl)butylamine; N,N-bis(4-aminophenyl)methylamine; 1,5-diaminonaphthalene; 3,3′-dimethyl-4,4′-diaminobiphenyl; 4-aminophenyl-3-aminobenzoate; N,N-bis(4-aminophenyl)aniline; bis(p-beta-amino tert-butyl phenyl)ether; p-bis-2-(2-methyl-4-aminopentyl)benzene; p-bis(1,1-dimethyl-5-aminopentyl)benzene; 1,3-bis(4-aminophenoxy)benzene; m-xylene diamine; p-xylene diamine; 4,4′-diamino diphenylether phosphine oxide: 4,4′-diamino diphenyl N-methylamine; 4,4′-diamino diphenyl N-phenylamine; amino-terminal polydimethylsiloxanes; amino-terminal polypropylene oxides; amino-terminal polybutylene oxides; 4,4′-methylene bis(2-methyl cyclohexylamine); 1,2-diaminoethane; 1,3-diaminopropane; 1,4-diaminobutane; 1,5-diaminopentane; 1,6-diaminohexane; 1,7-diaminoheptane; 1,8-diaminooctane; 1,9-diaminononane; 1,10-diaminodecane; 4,4′-methylene bis(benzeneamine); 2,2′-dimethyl benzidine; bisaniline-p-xylidene; 4,4′-bis(4-aminophenoxy)biphenyl; 3,3′-bis(4-aminophenoxy)biphenyl; 4,4′-(1,4-phenylene diisopropylidene)bisaniline; and/or 4,4′-(1,3-phenylene diisopropylidene)bisaniline,

In some embodiments, it can be particularly advantageous if the amine comprises 4,4′-oxydianiline (4,4-ODA or ODA), 2,2′-dimethylbenzidine (DMBZ), and/or 4,4′-[1,3-phenylenebis(1-methyl-ethylidene)]bisaniline (bisaniline-m).

In some embodiments, it can be particularly advantageous if the polyol comprises resorcinol, phloroglucinol, bisphenol A, tris(hydroxyphenyl)ethane, sulfonyldiphenol, dihydroxybenzonphenone, a polyether alcohol, ethylene glycol, propylene glycol, or another suitable polyol.

In some embodiments, solvents used to make polymer aerogel materials are used to make a gel material. In some embodiments, the solvent comprises a ketone; an aldehyde; an alkyl alkanoate; ethyl acetate; an amide such as formamide; N-methyl-2-pyrrolidone; a sulfoxide such as dimethyl sulfoxide; aliphatic halogenated hydrocarbons: cycloaliphatic halogenated hydrocarbons; halogenated aromatic compounds; and/or fluorinated ethers.

In some embodiments, an aldehyde and/or ketone solvent is used to make a gel material. In some embodiments, the solvent comprises acetaldehyde; propionaldehyde; n-butyraldehyde; isobutyraldehyde; 2-ethylbutyraldehyde; valeraldehyde; isopentaldehyde; 2-methylpentaldehyde; 2-ethylhexaldehyde; acrolein; methacrolein; crotonaldehyde; furfural; acrolein dimer; methacrolein dimer; 1,2,3,6-tetrahydrobenzaldehyde; 6-methyl-3-cyclohexenealdehyde; cyanacetaldehyde; ethyl glyoxylate; benzaldehyde; acetone; diethyl ketone; methyl ethyl ketone; methyl isobutyl ketone; methyl n-butyl ketone; ethyl isopropyl ketone; 2-acetylfuran; 2-methoxy-4-methylpentan-2-one; cyclohexanone; and/or acetophenone.

In some embodiments, an alkyl alkanoate solvent is used to make a gel material. In some embodiments, the solvent comprises methyl formate; methyl acetate; ethyl formate; butyl acetate; and/or ethyl acetate.

In some embodiments, an acetal solvent is used to make a gel material. In some embodiments, the solvent comprises diethoxymethane; dimethoxymethane; and/or 1,3-dioxolane.

In some embodiments, a dialkyl ether and/or a cyclic ether solvent is used to make a gel material. In some embodiments, the solvent comprises methyl ethyl ether; diethyl ether; methyl propyl ether; methyl isopropyl ether; propyl ethyl ether; ethyl isopropyl ether; dipropyl ether; propyl isopropyl ether; diisopropyl ether; methyl butyl ether; methyl isobutyl ether; methyl tert-butyl ether; ethyl n-butyl ether; ethyl isobutyl ether; and/or ethyl tert-butyl ether. In certain, although not necessarily all, embodiments, cyclic ether, especially tetrahydrofuran, dioxane, and/or tetrahydropyran, may be advantageous.

In some embodiments, a hydrocarbon solvent is used to make a gel material. In certain embodiments, the solvent comprises ethane; propane; n-butane; isobutane; n-pentane; isopentane; cyclopentane; neopentane; hexane; and/or cyclohexane.

In some embodiments, a fluorocarbon solvent is used to make a gel material. In certain embodiments, the solvent comprises difluoromethane; 1,2-difluoroethane; 1,1,1,4,4,4-hexafluorobutane; pentafluoroethane; 1,1,1,2-tetrafluoroethane; 1,1,2,2-tetrafluoroethane; pentafluorobutane and/or its isomers; tetrafluoropropane and/or its isomers; and/or pentafluoropropane and/or its isomers. Substantially fluorinated or perfluorinated (cyclo)alkanes having 2 to 10 carbon atoms may also be used.

In some embodiments, a chlorofluorocarbon solvent is used to make a gel material. In certain embodiments, the solvent comprises chlorodifluoromethane; 1,1-dichloro-2,2,2-trifluoroethane; 1,1-dichloro-1-fluoroethane; 1-chloro-1,1-difluoroethane; 1-chloro-2-fluoroethane; 1,1,1,2-tetrafluoro-2-chloroethane; trichlorofluoromethane; dichlorodifluoromethane; trichlorotrifluoroethane; tetrafluorodichloroethane; 1- and/or 2-chloropropane; dichloromethane; monochlorobenzene; and/or dichlorobenzene.

In some embodiments, a fluorine-containing ether solvent is used to make a gel material. In certain embodiments, the solvent comprises bis-(trifluoromethyl) ether; trifluoromethyldifluoromethyl ether; methyl fluoromethyl ether; methyl trifluoromethyl ether; bis(difluoromethyl) ether; fluoromethyldifluoromethyl ether; methyl difluoromethyl ether; bis(fluoromethyl) ether; 2,2,2-trifluoroethyl difluoromethyl ether; pentafluoroethyltrifluoromethyl ether; pentafluoroethyldifluoromethyl ether; 1,1,2,2-tetrafluoroethyldifluoromethyl ether; 1,2,2,2-tetrafluoroethylfluoromethyl ether; 1,2,2-trifluoroethyl difluoromethyl ether; 1,1-difluoroethyl methyl ether; and/or 1,1,1,3,3,3-hexafluoroprop-2-yl fluoromethyl ether.

In some embodiments, a crosslinking agent is used in the production of a polymer aerogel. In some embodiments, the crosslinking agent comprises a triamine; an aliphatic triamine; an aromatic amine comprising three or more amine groups; an aromatic triamine; 1,3,5-tris(aminophenoxy)benzene (TAB); tris(4-aminophenyl)methane (TAPM); tris(4-aminophenyl)benzene (TAPB); tris(4-aminophenyl)amine (TAPA); 2,4,6-tris(4-aminophenyl)pyridine (TAPP); 4,4′,4″-methanetriyltrianiline; N,N,N′,N′-tetrakis(4-aminophenyl)-1,4-phenylenediamine; a polyoxypropylenetriamine; N′,N′-bis(4-aminophenyl)benzene-1,4-diamine; a triisocyanate; an aliphatic triisocyanate; an aromatic isocyanate comprising three or more isocyanate groups; an aromatic triisocyanate; a triisocyanate based on hexamethylene diisocyanate; the trimer of hexamethylenediisocyanate; hexamethylenediisocyanate; a polyisocyanate; a polyisocyanate comprising isocyanurate; Desmodur® N3200; Desmodur N3300; Desmodur N100; Desmodur N3400; Desmodur N3390; Desmodur N3390 BA/SN; Desmodur N3300 BA; Desmodur N3600; Desmodur N3790 BA; Desmodur N3800; Desmodur N3900; Desmodur XP 2675; Desmodur blulogiq 3190; Desmodur XP 2860; Desmodur N3400; Desmodur XP 2840; Desmodur N3580 BA; Desmodur N3500; Desmodur RE; tris(isocyanatophenyl)methane; Desmodur RC; Mondur© MR; Mondur MRS; a methylene diphenyl diisocyanate; diphenylmethane 2,2′-, 2,4′- and/or 4,4′-diisocyanate (MDI); naphthylene 1,5-diisocyanate (NDI); a toluene diisocyanate; toluene 2,4- and/or 2,6-diisocyanate (TDI); 3,3′-dimethylbiphenyl diisocyanate; 1,2-diphenylethane diisocyanate and/or p-phenylenediisocyanate (PPDI); trimethylene-, tetramethylene-, pentamethylene-, hexamethylene-, heptamethylene-, and/or octamethylenediisocyanate; 2-methylpentamethylene 1,5-diisocyanate; 2-ethylbutylene 1,4-diisocyanate; pentamethylene 1,5-diisocyanate; butylene 1,4-diisocyanate; 1-isocyanato-3,3,5-trimethyl-5-isocyanatomethylcyclohexane (isophoronediisocyanate, IPDI); 1,4- and/or 1,3-bis(isocyanatomethyl)cyclohexane (HXDI); cyclohexane 1,4-diisocyanate; 1-methylcyclohexane 2,4- and/or 2,6-diisocyanate; dicyclohexylmethane 4,4′-, 2,4′- and/or 2,2′-diisocyanate; octa(aminophenoxy)silsesquioxane (OAPS); 4,4-oxydianiline (ODA); (3-aminopropyl)triethoxysilane (APTES); modified graphene oxides (m-GO); 1,3,5-benzenetricarbonyl trichloride (BTC); poly(maleic anhydride) (PMA); an imidazole or a substituted imidazole; a triazole or substituted triazole; a purine or substituted purine; a pyrazole or substituted pyrazole; and/or melamine. In some embodiments, the crosslinker comprises an isocyanurate group, a silicon-oxygen bridge, a trisubstituted benzene ring, a silsesquioxane group, a phenoxy group, a tris(phenyl)methyl group, an imidazole group, and/or an alkyl group.

In some embodiments, a method for synthesizing an aerogel is provided. In some embodiments, a method for synthesizing an aerogel comprises: forming a combination comprising a gel precursor and a solvent, and optionally a catalyst; forming a gel from the combination; and drying the gel to form the aerogel. In some embodiments, a hydrophobe is present at at least one point in time after the beginning of forming the combination and before the completion of drying the gel. The hydrophobe may comprise any of the hydrophobes described herein.

In certain embodiments, a method for synthesizing an aerogel comprises: forming a combination comprising a gel precursor and a solvent, and optionally a catalyst; forming a gel from the combination; and drying the gel to form the aerogel; wherein: a hydrophobe is present at at least one point in time after the beginning of forming the combination and before the completion of drying the gel; the hydrophobe is a compound of the formula: H—N(R¹)(R²); and the aerogel comprises one or more moieties of Formula (M):

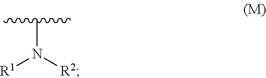

wherein: each of R¹ is independently a first organic moiety; each of R² is independently H or a second organic moiety; and the log P of H—R¹ and/or H—R² determined at about 25° C. and about 1 atm is not lower than 1; provided that each of the first and second organic moieties is not H. In some such embodiments, the log P of H—R¹ and H—R² determined at about 25° C. and about 1 atm is not lower than 1. In some embodiments in which neither R¹ nor R² is hydrogen, the log P of H—R¹ and H—R² determined at about 25° C. and about 1 atm is not lower than 1.

In some embodiments, a method for synthesizing an aerogel comprises forming a combination comprising a gel precursor and a solvent, and optionally a catalyst; forming a gel from the combination; and drying the gel to form the aerogel; wherein: a hydrophobe is present at at least one point in time after the beginning of forming the combination and before the completion of drying the gel; the hydrophobe is a compound of the formula: H—X; and the aerogel comprises one or more moieties of Formula (M101):

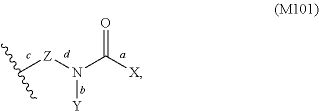

wherein:
each X is independently

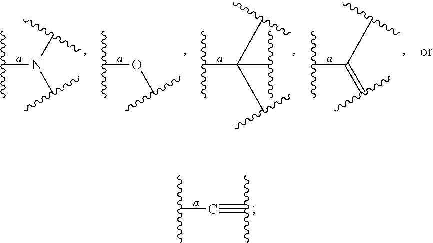

each Y is independently H,

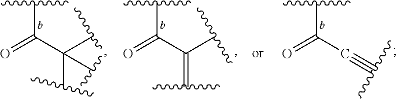

and
each Z is independently a third organic moiety or an inorganic moiety.

In some embodiments, the solvent comprises a first organic solvent, optionally a second organic solvent, and water. In some embodiments, the solvent is a combination of a first organic solvent, optionally a second organic solvent, and water. The first organic solvent is different from the second organic solvent. In some embodiments, the solvent is a combination of a first organic solvent and water. In some embodiments, the solvent is a combination of a first organic solvent, a second organic solvent, and water. In some embodiments, forming the combination comprises: combining mixture A comprising the gel precursor and the first organic solvent with water and optionally the catalyst to form mixture C; and combining mixture C with mixture B comprising the compound of the formula: H—N(R¹)(R²) and the second organic solvent. In some embodiments, mixture C is combined with mixture B before mixture C forms a gel. In some embodiments, mixture C is combined with mixture B at about 20° C.

In some embodiment, after forming the gel and before drying the gel, combining the gel with mixture B comprising the compound of the formula: H—N(R¹)(R²) and the second organic solvent.

In some embodiments, the first organic solvent is petroleum ether, diethyl ether, pentane, methylene chloride, methyl t-butyl ether, acetone, chloroform, methanol, tetrahydrofuran, hexane, carbon tetrachloride, ethyl acetate, ethanol, 2-butanone, benzene, cyclohexane, acetonitrile, t-butyl alcohol, 2-propanol, 1,2-dichloroethane, 1,2-dimethoxy-ethane, triethyl amine, 1-propanol, heptane, 2-butanol, 1,4-dioxane, nitromethane, water, heavy, toluene, pyridine, 1-butanol, acetic acid, chlorobenzene, p-xylene, m-xylene, o-xylene, hexamethylphosphorous triamide, dimethylformamide, diglyme, dimethyl sulfoxide, ethylene glycol, or N-methyl-2-pyrrolidinone. In some embodiments, the first organic solvent is ethanol, a propanol, or a butanol. In some embodiments, the first organic solvent is tert-butanol. In some embodiments, the second organic solvent is petroleum ether, diethyl ether, pentane, methylene chloride, methyl t-butyl ether, acetone, chloroform, methanol, tetrahydrofuran, hexane, carbon tetrachloride, ethyl acetate, ethanol, 2-butanone, benzene, cyclohexane, acetonitrile, t-butyl alcohol, 2-propanol, 1,2-dichloroethane, 1,2-dimethoxy-ethane, triethyl amine, 1-propanol, heptane, 2-butanol, 1,4-dioxane, nitromethane, water, heavy, toluene, pyridine. 1-butanol, acetic acid, chlorobenzene, p-xylene, m-xylene, o-xylene, hexamethylphosphorous triamide, dimethylformamide, diglyme, dimethyl sulfoxide, ethylene glycol, or N-methyl-2-pyrrolidinone. In some embodiments, the second organic solvent is acetone, methyl ethyl ketone, methyl propyl ketone, ethyl ethyl ketone, or methyl butyl ketone. In some embodiments, the second organic solvent is acetone. In some embodiments, the first organic solvent and/or the second organic solvent independently comprise tert-butanol and/or acetone.

R¹ and R² can correspond to their descriptions elsewhere in the present disclosure.

In some embodiments, R¹ is optionally substituted alkyl, and R² is H.

In some embodiments, each of R¹ and R² is independently optionally substituted alkyl.

In some embodiments, each of R¹ and/or R² are independently perfluoroalkyl.

In some embodiments, the molar ratio of the hydrophobe (e.g., the compound of the formula: H—N(R¹)(R²), or any other hydrophobes described herein) to the gel precursor is greater than or equal to 0.01, greater than or equal to 0.02, greater than or equal to 0.03, greater than or equal to 0.04, greater than or equal to 0.05, greater than or equal to 0.06, greater than or equal to 0.07, greater than or equal to 0.08, greater than or equal to 0.09, greater than or equal to 0.1, greater than or equal to 0.2, greater than or equal to 0.3, greater than or equal to 0.4, greater than or equal to 0.5, greater than or equal to 0.6, greater than or equal to 0.7, greater than or equal to 0.8, greater than or equal to 0.9, or greater than or equal to 1 (and/or, less than or equal to 1, less than or equal to 0.9, less than or equal to 0.8, less than or equal to 0.7, less than or equal to 0.6, or less than or equal to 0.5). In some embodiments, it can be particularly advantageous if a ratio of molar concentration of hydrophobe to gel precursor (e.g., monomers) is greater than or equal to 0.03 and less than 0.5.

In some embodiments, the liquid is removed from the gel by supercritical extraction. In some embodiments, the target solvent is removed from the gel by supercritical extraction.

In some embodiments, the liquid in the gel is first at least partially replaced by carbon dioxide after which the carbon dioxide is removed from the gel. In some embodiments, the target solvent in the gel is at least partially replaced by carbon dioxide after which the carbon dioxide is removed from the gel.

In some embodiments, the liquid in the gel is removed by subcritical extraction. In some embodiments, the target solvent in the gel is removed by subcritical extraction.

In some embodiments, the liquid in the gel is removed by evaporation and/or boiling. In some embodiments, the target solvent in the gel is removed by evaporation and/or boiling.

In some embodiments, the liquid in the gel is removed by freeze drying under vacuum. In some embodiments, the target solvent in the gel is removed by freeze drying under vacuum.

In some embodiments, the liquid in the gel is removed by freeze drying at atmospheric pressure. In some embodiments, the target solvent in the gel is removed by freeze drying at atmospheric pressure.

Definitions of specific functional groups and chemical terms are described in more detail below. The chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Thomas Sorrell, Organic Chemistry, University Science Books, Sausalito, 1999; Smith and March, March's Advanced Organic Chemistry, 5^{th} Edition, John Wiley & Sons, Inc., New York, 2001; Larock, Comprehensive Organic Transformations, VCH Publishers, Inc., New York, 1989; and Carruthers, Some Modern Methods of Organic Synthesis, 3^{rd} Edition, Cambridge University Press, Cambridge, 1987.

Compounds described herein can comprise one or more asymmetric centers, and thus can exist in various isomeric forms, e.g., enantiomers and/or diastereomers. For example, the compounds described herein can be in the form of an individual enantiomer, diastereomer or geometric isomer, or can be in the form of a mixture of stereoisomers, including racemic mixtures and mixtures enriched in one or more stereoisomer. Isomers can be isolated from mixtures by methods known to those skilled in the art, including chiral high pressure liquid chromatography (HPLC), supercritical fluid chromatography (SFC), and the formation and crystallization of chiral salts; or preferred isomers can be prepared by asymmetric syntheses. See, for example, Jacques et al., Enantiomers, Racemates and Resolutions (Wiley Interscience, New York, 1981); Wilen et al., Tetrahedron 33:2725 (1977); Eliel, Stereochemistry of Carbon Compounds (McGraw-Hill, NY, 1962); and Wilen, Tables of Resolving Agents and Optical Resolutions p. 268 (E. L. Eliel, Ed., Univ. of Notre Dame Press, Notre Dame, IN 1972). The present disclosure additionally encompasses compounds described herein as individual isomers substantially free of other isomers, and alternatively, as mixtures of various isomers.

Unless otherwise provided, a formula depicted herein includes compounds that do not include isotopically enriched atoms and also compounds that include isotopically enriched atoms. Compounds that include isotopically enriched atoms may be useful as, for example, analytical tools, and/or probes in biological assays.

When a range of values (“range”) is listed, it is intended to encompass each value and sub-range within the range. A range is inclusive of the values at the two ends of the range unless otherwise provided. For example, “an integer between 1 and 4” refers to 1, 2, 3, and 4. For example “C₁₋₆ alkyl” is intended to encompass, C₁, C₂, C₃, C₄, C₅, C₆, C₁₋₆, C₁₋₅, C₁₋₄, C₁₋₃, C₁₋₂, C₂₋₆, C₂₋₅, C₂₋₄, C₂₋₃, C₃₋₆, C₃₋₅, C₃₋₄, C₄₋₆, C₄₋₅, and C₅₋₆ alkyl.

“Alkyl” refers to a radical of a straight-chain or branched saturated hydrocarbon group having from 1 to 20 carbon atoms (“C₁₋₂₀ alkyl”). In some embodiments, an alkyl group has 1 to 18 carbon atoms (“C₁₋₁₈ alkyl”). In some embodiments, an alkyl group has 1 to 12 carbon atoms (“C₁₋₁₂ alkyl”). In some embodiments, an alkyl group has 1 to 10 carbon atoms (“C₁ 10 alkyl”).

In some embodiments, an alkyl group has 1 to 9 carbon atoms (“C₁₋₉ alkyl”). In some embodiments, an alkyl group has 1 to 8 carbon atoms (“C₁₋₈ alkyl”). In some embodiments, an alkyl group has 1 to 7 carbon atoms (“C₁₋₇ alkyl”). In some embodiments, an alkyl group has 1 to 6 carbon atoms (“C₁₋₆ alkyl”). In some embodiments, an alkyl group has 1 to 5 carbon atoms (“C₁₋₅ alkyl”). In some embodiments, an alkyl group has 1 to 4 carbon atoms (“C₁₋₄ alkyl”). In some embodiments, an alkyl group has 1 to 3 carbon atoms (“C₁₋₃ alkyl”). In some embodiments, an alkyl group has 1 to 2 carbon atoms (“C₁₋₂ alkyl”). In some embodiments, an alkyl group has 1 carbon atom (“C₁ alkyl”). In some embodiments, an alkyl group has 2 to 6 carbon atoms (“C₂₋₆ alkyl”). Examples of C₁₋₆ alkyl groups include methyl (C₁), ethyl (C₂), n-propyl (C₃), isopropyl (C₃), n-butyl (C₄), tert-butyl (C₄, sec-butyl (C₄), iso-butyl (C₄, n-pentyl (C₅), 3-pentanyl (C₅), amyl (C₅), neopentyl (C₅), 3-methyl-2-butanyl (C₅), tertiary amyl (C₅), and n-hexyl (C₆). Additional examples of alkyl groups include n-heptyl (C₇), n-octyl (C₈) and the like. Unless otherwise specified, each instance of an alkyl group is independently optionally substituted, e.g., unsubstituted (an “unsubstituted alkyl”) or substituted (a “substituted alkyl”) with one or more substituents. In certain embodiments, the alkyl group is unsubstituted C₁₋₁₂ alkyl (e.g., —CH₃ (Me), unsubstituted ethyl (Et), unsubstituted propyl (Pr, e.g., unsubstituted n-propyl (n-Pr), unsubstituted isopropyl (i-Pr)), unsubstituted butyl (Bu, e.g., unsubstituted n-butyl (n-Bu), unsubstituted tert-butyl (tert-Bu or t-Bu), unsubstituted sec-butyl (sec-Bu or s-Bu), unsubstituted isobutyl (i-Bu)). In certain embodiments, the alkyl group is substituted C₁₋₁₂ alkyl (such as substituted C₁₋₆ alkyl, e.g., —CH₂F, —CHF₂, —CF₃, —CH₂CH₂F, —CH₂CHF₂, —CH₂CF₃, or benzyl (Bn)).

In some embodiments, an alkyl group is substituted with one or more halogens. “Perhaloalkyl” is a substituted alkyl group as defined herein wherein all of the hydrogen atoms are independently replaced by a halogen, e.g., fluoro, bromo, chloro, or iodo. In some embodiments, the alkyl moiety has 1 to 8 carbon atoms (“C₁₋₈ perhaloalkyl”). In some embodiments, the alkyl moiety has 1 to 6 carbon atoms (“C₁₋₆ perhaloalkyl”). In some embodiments, the alkyl moiety has 1 to 4 carbon atoms (“C₁₋₄ perhaloalkyl”). In some embodiments, the alkyl moiety has 1 to 3 carbon atoms (“C₁₋₃ perhaloalkyl”). In some embodiments, the alkyl moiety has 1 to 2 carbon atoms (“C₁₋₂ perhaloalkyl”). In some embodiments, all of the hydrogen atoms are replaced with fluoro (“perfluoroalkyl”). In some embodiments, all of the hydrogen atoms are replaced with chloro. Examples of perhaloalkyl groups include —CF₃, —CF₂CF₃, —CF₂CF₂CF₃, —CCl₃, —CFCl₂, —CF₂CT, and the like.

“Alkenyl” refers to a radical of a straight-chain or branched hydrocarbon group having from 2 to 20 carbon atoms, one or more (e.g., two, three, or four, as valency permits) carbon-carbon double bonds, and no triple bonds (“C₂₋₂₀ alkenyl”). In some embodiments, an alkenyl group has 2 to 10 carbon atoms (“C₂₋₁₀ alkenyl”). In some embodiments, an alkenyl group has 2 to 9 carbon atoms (“C₂₋₉ alkenyl”). In some embodiments, an alkenyl group has 2 to 8 carbon atoms (“C₂₋₈ alkenyl”). In some embodiments, an alkenyl group has 2 to 7 carbon atoms (“C₂₋₇ alkenyl”). In some embodiments, an alkenyl group has 2 to 6 carbon atoms (“C₂₋₆ alkenyl”). In some embodiments, an alkenyl group has 2 to 5 carbon atoms (“C₂₋₅ alkenyl”). In some embodiments, an alkenyl group has 2 to 4 carbon atoms (“C₂₋₄ alkenyl”). In some embodiments, an alkenyl group has 2 to 3 carbon atoms (“C₂₋₃ alkenyl”). In some embodiments, an alkenyl group has 2 carbon atoms (“C₂ alkenyl”). The one or more carbon-carbon double bonds can be internal (such as in 2-butenyl) or terminal (such as in 1-butenyl). Examples of C₂₋₄ alkenyl groups include ethenyl (C₂), 1-propenyl (C₃), 2-propenyl (C₃), 1-butenyl (C₄), 2-butenyl (C₄), butadienyl (C₄), and the like. Examples of C₂₋₆ alkenyl groups include the aforementioned C₂₋₄ alkenyl groups as well as pentenyl (C₅), pentadienyl (C₅), hexenyl (C₆), and the like. Additional examples of alkenyl include heptenyl (C₇), octenyl (C₈), octatrienyl (C₈), and the like. Unless otherwise specified, each instance of an alkenyl group is independently optionally substituted, e.g., unsubstituted (an “unsubstituted alkenyl”) or substituted (a “substituted alkenyl”) with one or more substituents. In certain embodiments, the alkenyl group is unsubstituted C₂₋₁₀ alkenyl. In certain embodiments, the alkenyl group is substituted C₂₋₁₀ alkenyl. In an alkenyl group, a C═C double bond for which the stereochemistry is not specified (e.g., —CH═CHCH₃ or

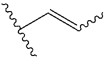

may be in the (E)- or (Z)-configuration.

“Alkynyl” refers to a radical of a straight-chain or branched hydrocarbon group having from 2 to 20 carbon atoms, one or more (e.g., two, three, or four, as valency permits) carbon-carbon triple bonds, and optionally one or more double bonds (“C₂₋₂₀ alkynyl”). In some embodiments, an alkynyl group has 2 to 10 carbon atoms (“C₂₋₁₀ alkynyl”). In some embodiments, an alkynyl group has 2 to 9 carbon atoms (“C₂₋₉ alkynyl”). In some embodiments, an alkynyl group has 2 to 8 carbon atoms (“C₂₋ₛ alkynyl”). In some embodiments, an alkynyl group has 2 to 7 carbon atoms (“C₂₋₇ alkynyl”). In some embodiments, an alkynyl group has 2 to 6 carbon atoms (“C₂₋₆ alkynyl”). In some embodiments, an alkynyl group has 2 to 5 carbon atoms (“C₂₋₅ alkynyl”). In some embodiments, an alkynyl group has 2 to 4 carbon atoms (“C₂₋₄ alkynyl”). In some embodiments, an alkynyl group has 2 to 3 carbon atoms (“C₂₋₃ alkynyl”). In some embodiments, an alkynyl group has 2 carbon atoms (“C₂ alkynyl”). The one or more carbon-carbon triple bonds can be internal (such as in 2-butynyl) or terminal (such as in 1-butynyl). Examples of C₂₋₄ alkynyl groups include ethynyl (C₂), 1-propynyl (C₃), 2-propynyl (C₃), 1-butynyl (C₄), 2-butynyl (C₄), and the like. Examples of C₂₋₆ alkenyl groups include the aforementioned C₂₋₄ alkynyl groups as well as pentynyl (C₅), hexynyl (C₆), and the like. Additional examples of alkynyl include heptynyl (C₇), octynyl (C₅), and the like. Unless otherwise specified, each instance of an alkynyl group is independently optionally substituted, e.g., unsubstituted (an “unsubstituted alkynyl”) or substituted (a “substituted alkynyl”) with one or more substituents. In certain embodiments, the alkynyl group is unsubstituted C₂₋₁₀ alkynyl. In certain embodiments, the alkynyl group is substituted C₂₋₁₀ alkynyl.

“Carbocyclyl” or “carbocyclic” refers to a radical of a non-aromatic cyclic hydrocarbon group having from 3 to 13 ring carbon atoms (“C₃₋₁₃ carbocyclyl”) and zero heteroatoms in the non-aromatic ring system. In some embodiments, a carbocyclyl group has 3 to 8 ring carbon atoms (“C₃₋₈ carbocyclyl”). In some embodiments, a carbocyclyl group has 3 to 7 ring carbon atoms (“C₃₋₇ carbocyclyl”). In some embodiments, a carbocyclyl group has 3 to 6 ring carbon atoms (“C₃₋₆ carbocyclyl”). In some embodiments, a carbocyclyl group has 5 to 10 ring carbon atoms (“C₅₋₁₀ carbocyclyl”). Exemplary C₃₋₆ carbocyclyl groups include cyclopropyl (C₃), cyclopropenyl (C₃), cyclobutyl (C₄), cyclobutenyl (C₄), cyclopentyl (C₅), cyclopentenyl (C₅), cyclohexyl (C₆), cyclohexenyl (C₆), cyclohexadienyl (C₆), and the like. Exemplary C₃₋₈ carbocyclyl groups include the aforementioned C₃₋₆ carbocyclyl groups as well as cycloheptyl (C₇), cycloheptenyl (C₇), cycloheptadienyl (C₇), cycloheptatrienyl (C₇), cyclooctyl (C₅), cyclooctenyl (C₅), bicyclo[2.2.1]heptanyl (C₇), bicyclo[2.2.2]octanyl (C₅), and the like. Exemplary C₃₋₁₀ carbocyclyl groups include the aforementioned C₃₋₈ carbocyclyl groups as well as cyclononyl (C₉), cyclononenyl (C₉), cyclodecyl (C₁₀), cyclodecenyl (C₁₀), octahydro-1H-indenyl (C₉), decahydronaphthalenyl (C₁₀), spiro[4.5]decanyl (C₁₀), and the like. As the foregoing examples illustrate, in certain embodiments, the carbocyclyl group is either monocyclic (“monocyclic carbocyclyl”) or contain a fused, bridged, or spiro ring system such as a bicyclic system (“bicyclic carbocyclyl”). Carbocyclyl can be saturated, and saturated carbocyclyl is referred to as “cycloalkyl.” In some embodiments, carbocyclyl is a monocyclic, saturated carbocyclyl group having from 3 to 10 ring carbon atoms (“C₃₋₁₀ cycloalkyl”). In some embodiments, a cycloalkyl group has 3 to 8 ring carbon atoms (“C₃₋₈ cycloalkyl”). In some embodiments, a cycloalkyl group has 3 to 6 ring carbon atoms (“C₃₋₆ cycloalkyl”). In some embodiments, a cycloalkyl group has 5 to 6 ring carbon atoms (“C₅₋₆ cycloalkyl”). In some embodiments, a cycloalkyl group has 5 to 10 ring carbon atoms (“C₅₋₁₀ cycloalkyl”). Examples of C₅₋₆ cycloalkyl groups include cyclopentyl (C₅) and cyclohexyl (C₅). Examples of C₃₋₆ cycloalkyl groups include the aforementioned C₅₋₈ cycloalkyl groups as well as cyclopropyl (C₃) and cyclobutyl (C₄). Examples of C₃₋₈ cycloalkyl groups include the aforementioned C₃₋₆ cycloalkyl groups as well as cycloheptyl (C₇) and cyclooctyl (C₈). Unless otherwise specified, each instance of a cycloalkyl group is independently unsubstituted (an “unsubstituted cycloalkyl”) or substituted (a “substituted cycloalkyl”) with one or more substituents. In certain embodiments, the cycloalkyl group is unsubstituted C₃₋₁₀ cycloalkyl. In certain embodiments, the cycloalkyl group is substituted C₃₋₁₀ cycloalkyl. Carbocyclyl can be partially unsaturated. Carbocyclyl may include zero, one, or more (e.g., two, three, or four, as valency permits) C═C double bonds in all the rings of the carbocyclic ring system that are not aromatic or heteroaromatic. Carbocyclyl including one or more (e.g., two or three, as valency permits) C═C double bonds in the carbocyclic ring is referred to as “cycloalkenyl.” Carbocyclyl including one or more (e.g., two or three, as valency permits) C═C triple bonds in the carbocyclic ring is referred to as “cycloalkynyl.” “Carbocyclyl” also includes ring systems wherein the carbocyclyl ring, as defined above, is fused with one or more aryl or heteroaryl groups wherein the point of attachment is on the carbocyclyl ring, and in such instances, the number of carbons continue to designate the number of carbons in the carbocyclic ring system. Unless otherwise specified, each instance of a carbocyclyl group is independently optionally substituted, e.g., unsubstituted (an “unsubstituted carbocyclyl”) or substituted (a “substituted carbocyclyl”) with one or more substituents. In certain embodiments, the carbocyclyl group is unsubstituted C₃₋₁₀ carbocyclyl. In certain embodiments, the carbocyclyl group is a substituted C₃₋₁₀ carbocyclyl. In certain embodiments, the carbocyclyl is substituted or unsubstituted, 3- to 7-membered, and monocyclic. In certain embodiments, the carbocyclyl is substituted or unsubstituted, 5- to 13-membered, and bicyclic.

In some embodiments, “carbocyclyl” is a monocyclic, saturated carbocyclyl group having from 3 to 10 ring carbon atoms (“C₃₋₁₀ cycloalkyl”). In some embodiments, a cycloalkyl group has 3 to 8 ring carbon atoms (“C₃₋₈ cycloalkyl”). In some embodiments, a cycloalkyl group has 3 to 6 ring carbon atoms (“C₃₋₆ cycloalkyl”). In some embodiments, a cycloalkyl group has 5 to 6 ring carbon atoms (“C₅₋₆ cycloalkyl”). In some embodiments, a cycloalkyl group has 5 to 10 ring carbon atoms (“C₅₋₁₀ cycloalkyl”). Examples of C₅₋₆ cycloalkyl groups include cyclopentyl (C₅) and cyclohexyl (C₅). Examples of C₃₋₆ cycloalkyl groups include the aforementioned C₅₋₆ cycloalkyl groups as well as cyclopropyl (C₃) and cyclobutyl (C₄). Examples of C₃₋₈ cycloalkyl groups include the aforementioned C₃_s cycloalkyl groups as well as cycloheptyl (C₇) and cyclooctyl (C₈). Unless otherwise specified, each instance of a cycloalkyl group is independently unsubstituted (an “unsubstituted cycloalkyl”) or substituted (a “substituted cycloalkyl”) with one or more substituents. In certain embodiments, the cycloalkyl group is unsubstituted C₃₋₁₀ cycloalkyl. In certain embodiments, the cycloalkyl group is substituted C₃₋₁₀ cycloalkyl. In certain embodiments, the carbocyclyl includes oxo substituted thereon.

“Heterocyclyl” or “heterocyclic” refers to a radical of a 3- to 13-membered non-aromatic ring system having ring carbon atoms and 1 to 4 ring heteroatoms, wherein each heteroatom is independently selected from nitrogen, oxygen, and sulfur (“3-13 membered heterocyclyl”). In heterocyclyl groups that contain one or more nitrogen atoms, the point of attachment can be a carbon or nitrogen atom, as valency permits. A heterocyclyl group can either be monocyclic (“monocyclic heterocyclyl”) or a fused, bridged, or spiro ring system such as a bicyclic system (“bicyclic heterocyclyl”). A heterocyclyl group can be saturated or can be partially unsaturated. Heterocyclyl may include zero, one, or more (e.g., two, three, or four, as valency permits) double bonds in all the rings of the heterocyclic ring system that are not aromatic or heteroaromatic. Heterocyclyl bicyclic ring systems can include one or more heteroatoms in one or both rings. “Heterocyclyl” also includes ring systems wherein the heterocyclyl ring, as defined above, is fused with one or more carbocyclyl groups wherein the point of attachment is either on the carbocyclyl or heterocyclyl ring, or ring systems wherein the heterocyclyl ring, as defined above, is fused with one or more aryl or heteroaryl groups, wherein the point of attachment is on the heterocyclyl ring, and in such instances, the number of ring members continue to designate the number of ring members in the heterocyclyl ring system. Unless otherwise specified, each instance of heterocyclyl is independently optionally substituted, e.g., unsubstituted (an “unsubstituted heterocyclyl”) or substituted (a “substituted heterocyclyl”) with one or more substituents. In certain embodiments, the heterocyclyl group is unsubstituted 3-10 membered heterocyclyl. In certain embodiments, the heterocyclyl group is substituted 3-10 membered heterocyclyl. In certain embodiments, the heterocyclyl is substituted or unsubstituted, 3- to 7-membered, and monocyclic. In certain embodiments, the heterocyclyl is substituted or unsubstituted, 5- to 13-membered, and bicyclic. In certain embodiments, the heterocyclyl includes oxo substituted thereon.

In some embodiments, a heterocyclyl group is a 5-10 membered non-aromatic ring system having ring carbon atoms and 1-4 ring heteroatoms, wherein each heteroatom is independently selected from nitrogen, oxygen, and sulfur (“5-10 membered heterocyclyl”). In some embodiments, a heterocyclyl group is a 5-8 membered non-aromatic ring system having ring carbon atoms and 1-4 ring heteroatoms, wherein each heteroatom is independently selected from nitrogen, oxygen, and sulfur (“5-8 membered heterocyclyl”). In some embodiments, a heterocyclyl group is a 5-6 membered non-aromatic ring system having ring carbon atoms and 1-4 ring heteroatoms, wherein each heteroatom is independently selected from nitrogen, oxygen, and sulfur (“5-6 membered heterocyclyl”). In some embodiments, the 5-6 membered heterocyclyl has 1-3 ring heteroatoms selected from nitrogen, oxygen, and sulfur. In some embodiments, the 5-6 membered heterocyclyl has 1-2 ring heteroatoms selected from nitrogen, oxygen, and sulfur. In some embodiments, the 5-6 membered heterocyclyl has one ring heteroatom selected from nitrogen, oxygen, and sulfur.

Exemplary 3-membered heterocyclyl groups containing one heteroatom include azirdinyl, oxiranyl, or thiiranyl. Exemplary 4-membered heterocyclyl groups containing one heteroatom include azetidinyl, oxetanyl and thietanyl. Exemplary 5-membered heterocyclyl groups containing one heteroatom include tetrahydrofuranyl, dihydrofuranyl, tetrahydrothiophenyl, dihydrothiophenyl, pyrrolidinyl, dihydropyrrolyl and pyrrolyl-2,5-dione. Exemplary 5-membered heterocyclyl groups containing two heteroatoms include dioxolanyl, oxasulfuranyl, disulfuranyl, and oxazolidin-2-one. Exemplary 5-membered heterocyclyl groups containing three heteroatoms include triazolinyl, oxadiazolinyl, and thiadiazolinyl. Exemplary 6-membered heterocyclyl groups containing one heteroatom include piperidinyl, tetrahydropyranyl, dihydropyridinyl, and thianyl. Exemplary 6-membered heterocyclyl groups containing two heteroatoms include piperazinyl, morpholinyl, dithianyl, and dioxanyl. Exemplary 6-membered heterocyclyl groups containing two heteroatoms include triazinanyl. Exemplary 7-membered heterocyclyl groups containing one heteroatom include azepanyl, oxepanyl and thiepanyl. Exemplary 8-membered heterocyclyl groups containing one heteroatom include azocanyl, oxecanyl, and thiocanyl. Exemplary 5-membered heterocyclyl groups fused to a C₆ aryl ring (also referred to herein as a 5,6-bicyclic heterocyclic ring) include indolinyl, isoindolinyl, dihydrobenzofuranyl, dihydrobenzothienyl, benzoxazolinonyl, and the like. Exemplary 6-membered heterocyclyl groups fused to an aryl ring (also referred to herein as a 6,6-bicyclic heterocyclic ring) include tetrahydroquinolinyl, tetrahydroisoquinolinyl, and the like.

“Aryl” refers to a radical of a monocyclic or polycyclic (e.g., bicyclic or tricyclic) 4n+2 aromatic ring system (e.g., having 6, 10, or 14 Tc electrons shared in a cyclic array) having 6-14 ring carbon atoms and zero heteroatoms provided in the aromatic ring system (“C₆₋₁₄ aryl”). In some embodiments, an aryl group has six ring carbon atoms (“C₆ aryl”; e.g., phenyl). In some embodiments, an aryl group has ten ring carbon atoms (“C₁₀ aryl”; e.g., naphthyl such as 1-naphthyl and 2-naphthyl). In some embodiments, an aryl group has fourteen ring carbon atoms (“C₁₄ aryl”; e.g., anthracyl). “Aryl” also includes ring systems wherein the aryl ring, as defined above, is fused with one or more carbocyclyl or heterocyclyl groups wherein the radical or point of attachment is on the aryl ring, and in such instances, the number of carbon atoms continue to designate the number of carbon atoms in the aryl ring system. Unless otherwise specified, each instance of an aryl group is independently optionally substituted, e.g., unsubstituted (an “unsubstituted aryl”) or substituted (a “substituted aryl”) with one or more substituents. In certain embodiments, the aryl group is unsubstituted C₆₋₁₄ aryl. In certain embodiments, the aryl group is substituted C₆₋₁₄ aryl.

“Heteroaryl” refers to a radical of a 5-10 membered monocyclic or bicyclic 4n+2 aromatic ring system (e.g., having 6 or 10 Tc electrons shared in a cyclic array) having ring carbon atoms and 1-4 ring heteroatoms provided in the aromatic ring system, wherein each heteroatom is independently selected from nitrogen, oxygen and sulfur (“5-10 membered heteroaryl”). In heteroaryl groups that contain one or more nitrogen atoms, the point of attachment can be a carbon or nitrogen atom, as valency permits. Heteroaryl bicyclic ring systems can include one or more heteroatoms in one or both rings. “Heteroaryl” includes ring systems wherein the heteroaryl ring, as defined above, is fused with one or more carbocyclyl or heterocyclyl groups wherein the point of attachment is on the heteroaryl ring, and in such instances, the number of ring members continue to designate the number of ring members in the heteroaryl ring system. “Heteroaryl” also includes ring systems wherein the heteroaryl ring, as defined above, is fused with one or more aryl groups wherein the point of attachment is either on the aryl or heteroaryl ring, and in such instances, the number of ring members designates the number of ring members in the fused (aryl/heteroaryl) ring system. Bicyclic heteroaryl groups wherein one ring does not contain a heteroatom (e.g., indolyl, quinolinyl, carbazolyl, and the like) the point of attachment can be on either ring, e.g., either the ring bearing a heteroatom (e.g., 2-indolyl) or the ring that does not contain a heteroatom (e.g., 5-indolyl).

In some embodiments, a heteroaryl group is a 5-10 membered aromatic ring system having ring carbon atoms and 1-4 ring heteroatoms provided in the aromatic ring system, wherein each heteroatom is independently selected from nitrogen, oxygen, and sulfur (“5-10 membered heteroaryl”). In some embodiments, a heteroaryl group is a 5-8 membered aromatic ring system having ring carbon atoms and 1-4 ring heteroatoms provided in the aromatic ring system, wherein each heteroatom is independently selected from nitrogen, oxygen, and sulfur (“5-8 membered heteroaryl”). In some embodiments, a heteroaryl group is a 5-6 membered aromatic ring system having ring carbon atoms and 1-4 ring heteroatoms provided in the aromatic ring system, wherein each heteroatom is independently selected from nitrogen, oxygen, and sulfur (“5-6 membered heteroaryl”). In some embodiments, the 5-6 membered heteroaryl has 1-3 ring heteroatoms selected from nitrogen, oxygen, and sulfur. In some embodiments, the 5-6 membered heteroaryl has 1-2 ring heteroatoms selected from nitrogen, oxygen, and sulfur. In some embodiments, the 5-6 membered heteroaryl has 1 ring heteroatom selected from nitrogen, oxygen, and sulfur. Unless otherwise specified, each instance of a heteroaryl group is independently optionally substituted, e.g., unsubstituted (“unsubstituted heteroaryl”) or substituted (“substituted heteroaryl”) with one or more substituents. In certain embodiments, the heteroaryl group is unsubstituted 5-14 membered heteroaryl. In certain embodiments, the heteroaryl group is substituted 5-14 membered heteroaryl. In certain embodiments, the heteroaryl group is 5-6 membered, monocyclic. In certain embodiments, the heteroaryl group is 8-14 membered, bicyclic.

Exemplary 5-membered heteroaryl groups containing one heteroatom include pyrrolyl, furanyl and thiophenyl. Exemplary 5-membered heteroaryl groups containing two heteroatoms include imidazolyl, pyrazolyl, oxazolyl, isoxazolyl, thiazolyl, and isothiazolyl. Exemplary 5-membered heteroaryl groups containing three heteroatoms include triazolyl, oxadiazolyl, and thiadiazolyl. Exemplary 5-membered heteroaryl groups containing four heteroatoms include tetrazolyl. Exemplary 6-membered heteroaryl groups containing one heteroatom include pyridinyl. Exemplary 6-membered heteroaryl groups containing two heteroatoms include pyridazinyl, pyrimidinyl, and pyrazinyl. Exemplary 6-membered heteroaryl groups containing three or four heteroatoms include triazinyl and tetrazinyl, respectively. Exemplary 7-membered heteroaryl groups containing one heteroatom include azepinyl, oxepinyl, and thiepinyl. Exemplary 5,6-bicyclic heteroaryl groups include indolyl, isoindolyl, indazolyl, benzotriazolyl, benzothiophenyl, isobenzothiophenyl, benzofuranyl, benzoisofuranyl, benzimidazolyl, benzoxazolyl, benzisoxazolyl, benzoxadiazolyl, benzthiazolyl, benzisothiazolyl, benzthiadiazolyl, indolizinyl, and purinyl. Exemplary 6,6-bicyclic heteroaryl groups include naphthyridinyl, pteridinyl, quinolinyl, isoquinolinyl, cinnolinyl, quinoxalinyl, phthalazinyl, and quinazolinyl.

“Partially unsaturated” refers to a group that includes at least one double or triple bond. The term “partially unsaturated” is intended to encompass rings having multiple sites of unsaturation, but is not intended to include aromatic groups (e.g., aryl or heteroaryl groups) as herein defined. Likewise, “saturated” refers to a group that does not contain a double or triple bond, i.e., contains all single bonds.

In some embodiments, alkyl, alkenyl, alkynyl, carbocyclyl, heterocyclyl, aryl, and heteroaryl groups, as defined herein, are optionally substituted (e.g., “substituted” or “unsubstituted” alkyl, “substituted” or “unsubstituted” alkenyl, “substituted” or “unsubstituted” alkynyl, “substituted” or “unsubstituted” carbocyclyl, “substituted” or “unsubstituted” heterocyclyl, “substituted” or “unsubstituted” aryl or “substituted” or “unsubstituted” heteroaryl group). In general, the term “substituted”, whether preceded by the term “optionally” or not, means that at least one hydrogen present on a group (e.g., a carbon or nitrogen atom) is replaced with a permissible substituent, e.g., a substituent which upon substitution results in a stable compound, e.g., a compound which does not spontaneously undergo transformation such as by rearrangement, cyclization, elimination, or other reaction. Unless otherwise indicated, a “substituted” group has a substituent at one or more substitutable positions of the group, and when more than one position in any given structure is substituted, the substituent is either the same or different at each position. The term “substituted” is contemplated to include substitution with all permissible substituents of organic compounds, any of the substituents described herein that results in the formation of a stable compound. The present disclosure contemplates any and all such combinations in order to arrive at a stable compound. For purposes of this disclosure, heteroatoms such as nitrogen may have hydrogen substituents and/or any suitable substituent as described herein which satisfy the valencies of the heteroatoms and results in the formation of a stable moiety.

Exemplary carbon atom substituents include halogen, —CN, —NO₂, —N₃, —SO₂H, —SO₃H, —OH, —OR^{aa}, —ON(R^{bb})₂, —N(R^{bb})₂, —N(R^{bb})₃+X⁻, —N(OR^{cc})R^{bb}, —SH, —SR^{aa}, —SSR^{cc}, —C(═O)R^{aa}, —CO₂H, —CHO, —C(OR^{cc})₂, —CO₂R^{aa}, —OC(═O)R^{aa}, —OCO₂R^{aa}, —C(═O)N(R^{bb})₂, —OC(═O)N(R^{bb})₂, —NR^{bb}C(═O)R^{aa}, —NR^{bb}CO₂R^{aa}, —NR^{bb}C(═O)N(R^{bb})₂, —C(═NR^{bb})R^{aa}, —C(═NR^{bb})OR^{aa}, —OC(═NR^{bb})R^{aa}, —OC(═NR^{bb})OR^{aa}, —C(═NR^{bb})N(R^{bb})₂, —OC(═NR^{bb})N(R^{bb})₂, —NR^{bb}C(═NR^{bb})N(R^{bb})₂, —C(═O)NR^{bb}SO₂R^{aa}, —NR^{bb}SO₂R^{aa}, —SO₂N(R^{bb})₂, —SO₂R^{aa}, —SO₂OR^{aa}, —OSO₂R^{aa}, —S(═O)R^{aa}, —OS(═O)R^{aa}, —Si(R^{aa})₃, —OSi(R^{aa})₃, —C(═S)N(R^{bb})₂, —C(═O)SR^{aa}, —C(═S)SR^{aa}, —SC(═S)SR^{aa}, —SC(═O)SR^{aa}, —OC(═O)SR^{aa}, —SC(═O)OR^{aa}, —SC(═O)R^{aa}, —P(═O)(R^{aa})₂, —P(═O)(OR^{cc})₂, —OP(═O)(R^{aa})₂, —OP(═O)(OR^{aa})₂, —P(═O)(N(R^{bb})₂)₂, —OP(═O)(N(R^{bb})₂)₂, —NR^{bb}P(═O)(R^{aa})₂, —NR^{bb}P(═O)(OR^{cc})₂, —NR^{bb}P(═O)(N(R^{bb})₂)₂, —P(R^{cc})₂, —P(OR^{cc})₂, —P(R^{cc})₃+X⁻, —P(OR^{cc})₃+X⁻, —P(R^{cc})₄, —P(OR^{cc})₄, —OP(R^{cc})₂, —OP(R^{cc})₃+X⁻, —OP(OR^{cc})₂, —OP(OR^{cc})₃+X⁻, —OP(R^{cc})₄, —OP(OR^{cc})₄, —B(R^{aa})₂, —B(OR^{cc})₂, —BR^{aa}(OR^{cc}), C₁₋₁₀ alkyl, C₁₋₁₀ perhaloalkyl, C₂₋₁₀ alkenyl, C₂₋₁₀ alkynyl, heteroC₁₋₁₀ alkyl, heteroC₂₋₁₀ alkenyl, heteroC₂₋₁₀ alkynyl, C₃₋₁₀ carbocyclyl, 3-14 membered heterocyclyl, C₆₋₁₄ aryl, and 5-14 membered heteroaryl, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups; wherein X⁻ is a counterion;
or two geminal hydrogens on a carbon atom are replaced with the group ═O, ═S, ═NN(R^{bb})₂, ═NNR^{bb}C(═O)R^{aa}, =NNR^{bb}C(═O)OR^{aa}, =NNR^{bb}S(═O)₂R^{aa}, =NR^{bb}, or =NOR^{cc};
each instance of R^{aa} is, independently, selected from C₁₋₁₀ alkyl, C₁₋₁₀ perhaloalkyl, C₂₋₁₀ alkenyl, C₂₋₁₀ alkynyl, heteroC₁₋₁₀ alkyl, heteroC₂₋₁₀ alkenyl, heteroC₂₋₁₀ alkynyl, C₃₋₁₀ carbocyclyl, 3-14 membered heterocyclyl, C₆₋₁₄ aryl, and 5-14 membered heteroaryl, or two R^{aa} groups are joined to form a 3-14 membered heterocyclyl or 5-14 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups;
each instance of R^{bb} is, independently, selected from hydrogen, —OH, —OR^{aa}, —N(R^{cc})₂—CN, —C(═O)R^{aa}, —C(═O)N(R^{cc})₂, —CO₂R^{aa}, —SO₂R^{aa}, —C(═NR^{cc})OR^{aa}, —C(═NR^{cc})N(R^{cc})₂, —SO₂N(R^{cc})₂, —SO₂R^{cc}, —SO₂OR^{cc}, —SOR^{aa}, —C(═S)N(R^{cc})₂, —C(═O)SR^{cc}, —C(═S)SR^{cc}, —P(═O)(R^{aa})₂, —P(═O)(OR^{cc})₂, —P(═O)(N(R^{cc})₂)₂, C₁₋₁₀ alkyl, C₁₋₁₀ perhaloalkyl, C₂₋₁₀ alkenyl, C₂₋₁₀ alkynyl, heteroC₁₋₁₀alkyl, heteroC₂₋₁₀alkenyl, heteroC₂₋₁₀alkynyl, C₃₋₁₀ carbocyclyl, 3-14 membered heterocyclyl, C₆₋₁₄ aryl, and 5-14 membered heteroaryl, or two R^{bb} groups are joined to form a 3-14 membered heterocyclyl or 5-14 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups; wherein X⁻ is a counterion;
each instance of R^{cc} is, independently, selected from hydrogen, C₁₋₁₀ alkyl, C₁₋₁₀ perhaloalkyl, C₂₋₁₀ alkenyl, C₂₋₁₀ alkynyl, heteroC₁₋₁₀ alkyl, heteroC₂₋₁₀ alkenyl, heteroC₂₋₁₀ alkynyl, C₃₋₁₀ carbocyclyl, 3-14 membered heterocyclyl, C₆₋₁₄ aryl, and 5-14 membered heteroaryl, or two R^{cc} groups are joined to form a 3-14 membered heterocyclyl or 5-14 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups;
each instance of R^{dd} is, independently, selected from halogen, —CN, —NO₂, —N₃, —SO₂H, —SO₃H, —OH, —OR^{ee}, —ON(R^{ff})₂, —N(R^{ff})₂, —N(R^{ff})₃⁺X⁻, —N(OR^{ee})R^{ff}, —SH, —SR^{ee}, —SSR^{ee}, —C(═O)R^{ee}, —CO₂H, —CO₂R^{ee}, —OC(═O)R^{ee}, —OCO₂R^{ee}, —C(═O)N(R^{ff})₂, —OC(═O)N(R^{ff})₂, —NR^{ff}C(═O)R^{ee}, —NR^{ff}CO₂R^{ee}, —NR^{ff}C(═O)N(R^{ff})₂, —C(═NR^{ff})OR^{ee}, —OC(═NR^{ff})R^{ee}, —OC(═NR^{ff})OR^{ee}, —C(═NR^{ff})N(R^{ff})₂, —OC(═NR^{ff})N(R^{ff})₂, —NR^{ff}C(═NR)N(R)₂, —NR^{ff}SO₂R^{ee}, —SO₂N(R^{ff})₂, —SO₂R^{ee}, —SO₂OR^{ee}, —OSO₂R^{ee}, —S(═O)R^{ee}, —Si(R^{ee})₃, —OSi(R^{ee})₃, —C(═S)N(R^{ff})₂, —C(═O)SR^{ee}, —C(═S)SR^{ee}, —SC(═S)SR^{ee}, —P(═O)(OR^{ee})₂, —P(═O)(R^{ee})₂, —OP(═O)(R^{ee})₂, —OP(═O)(OR^{ee})₂, C₁₋₆ alkyl, C₁₋₆ perhaloalkyl, C₂₋₆ alkenyl, C₂₋₆ alkynyl, heteroC₁₋₆alkyl, heteroC₂₋₆alkenyl, heteroC₂₋₆alkynyl, C₃₋₁₀ carbocyclyl, 3-10 membered heterocyclyl, C₆₋₁₀ aryl, 5-10 membered heteroaryl, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{gg} groups, or two geminal R^{dd} substituents can be joined to form O or =S; wherein X⁻ is a counterion;
each instance of R^{ee} is, independently, selected from C₁₋₆ alkyl, C₁₋₆ perhaloalkyl, C₂₋₆ alkenyl, C₂₋₆ alkynyl, heteroC₁₋₆ alkyl, heteroC₂₋₆alkenyl, heteroC₂₋₆ alkynyl, C₃₋₁₀ carbocyclyl, C₆₋₁₀ aryl, 3-10 membered heterocyclyl, and 3-10 membered heteroaryl, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{gg} groups;
each instance of R^{ff} is, independently, selected from hydrogen, C₁₋₆ alkyl, C₁₋₆ perhaloalkyl, C₂₋₆ alkenyl, C₂₋₆ alkynyl, heteroC₁₋₆alkyl, heteroC₂₋₆alkenyl, heteroC₂₋₆alkynyl, C₃₋₁₀ carbocyclyl, 3-10 membered heterocyclyl, C₆₋₁₀ aryl and 5-10 membered heteroaryl, or two R^{aa} groups are joined to form a 3-10 membered heterocyclyl or 5-10 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{gg} groups; and
each instance of R^{gg} is, independently, halogen, —CN, —NO₂, —N₃, —SO₂H, —SO₃H, —OH, —OC₁₋₆ alkyl, —ON(C₁₋₆ alkyl)₂, —N(C₁₋₆ alkyl)₂, —N(C₁₋₆ alkyl)₃+X⁻, —NH(C₁₋₆ alkyl)₂+X⁻, —NH₂(C₁₋₆ alkyl)+X⁻, —NH₃+X⁻, —N(OC₁₋₆ alkyl)(C₁₋₆ alkyl), —N(OH)(C₁₋₆ alkyl), —NH(OH), —SH, —SC₁₋₆ alkyl, —SS(C₁₋₆ alkyl), —C(═O)(C₁₋₆ alkyl), —CO₂H, —CO₂(C₁₋₆ alkyl), —OC(═O)(C₁₋₆ alkyl), —OCO₂(C₁₋₆ alkyl), —C(═O)NH₂, —C(═O)N(C₁₋₆ alkyl)₂, —OC(═O)NH(C₁₋₆ alkyl), —NHC(═O)(C₁₋₆ alkyl), —N(C₁₋₆ alkyl)C(═O)(C₁₋₆ alkyl), —NHCO₂(C₁₋₆ alkyl), —NHC(═O)N(C₁₋₆ alkyl)₂, —NHC(═O)NH(C₁₋₆ alkyl), —NHC(═O)NH₂, —C(═NH)O(C₁₋₆ alkyl), —OC(═NH)(C₁₋₆ alkyl), —OC(═NH)OC₁₋₆ alkyl, —C(═NH)N(C₁₋₆ alkyl)₂, —C(═NH)NH(C₁₋₆ alkyl), —C(═NH)NH₂, —OC(═NH)N(C₁₋₆ alkyl)₂, —OC(NH)NH(C₁₋₆ alkyl), —OC(NH)NH₂, —NHC(NH)N(C₁₋₆ alkyl)₂, —NHC(═NH)NH₂, —NHSO₂(C₁₋₆ alkyl), —SO₂N(C₁₋₈ alkyl)₂, —SO₂NH(C₁₋₈ alkyl), —SO₂NH₂, —SO₂C₁₋₆ alkyl, —SO₂OC₁₋₆ alkyl, —OSO₂C₁₋₆ alkyl, —SOC₁₋₆ alkyl, —Si(C₁₋₆ alkyl)₃, —OSi(C₁₋₆ alkyl)₃-C(═S)N(C₁₋₈ alkyl)₂, C(═S)NH(C₁₋₆ alkyl), C(═S)NH₂, —C(═O)S(C₁₋₆ alkyl), —C(═S)SC₁₋₆ alkyl, —SC(═S)SC₁₋₆ alkyl, —P(═O)(OC₁₋₆ alkyl)₂, —P(═O)(C₁₋₆ alkyl)₂, —OP(═O)(C₁₋₆ alkyl)₂, —OP(═O)(OC₁₋₆ alkyl)₂, C₁₋₆ alkyl, C₁₋₆ perhaloalkyl, C₂₋₆ alkenyl, C₂₋₆ alkynyl, heteroC₁₋₆alkyl, heteroC₂₋₆alkenyl, heteroC₂₋₆alkynyl, C₃₋₁₀ carbocyclyl, C₆₋₁₀ aryl, 3-10 membered heterocyclyl, 5-10 membered heteroaryl; or two geminal R⁹⁹ substituents can be joined to form ═O or =S; wherein X⁻ is a counterion.

In certain embodiments, the carbon atom substituents are independently halogen, substituted (e.g., substituted with one or more halogen) or unsubstituted C₁₋₆ alkyl, —OR^{aa}, —SR^{aa}, —N(R^{bb})₂, —CN, —SCN, —NO₂, —C(═O)R^{aa}, —CO₂R^{aa}, —C(═O)N(R^{bb})₂, —OC(═O)R^{aa}, —OCO₂R^{aa}, —OC(═O)N(R^{bb})₂, —NR^{bb}C(═O)R^{aa}, —NR^{bb}CO₂R^{aa}, or —NR^{bb}C(═O)N(R^{bb})₂. In certain embodiments, the carbon atom substituents are independently halogen, substituted (e.g., substituted with one or more halogen) or unsubstituted C₁₋₆ alkyl, —OR^{aa}, —SR^{aa}, —N(R^{bb})₂, —CN, —SCN, —NO₂, —C(═O)R^{aa}, —CO₂R^{aa}, —C(═O)N(R^{bb})₂, —OC(═O)R^{aa}, —OCO₂R^{aa}, —OC(═O)N(R^{bb})₂, —NR^{bb}C(═O)R^{aa}, —NR^{bb}CO₂R^{aa}, or —NR^{bb}C(═O)N(R^{bb})₂, wherein R^{aa} is hydrogen, substituted (e.g., substituted with one or more halogen) or unsubstituted C₁₋₆ alkyl, an oxygen protecting group when attached to an oxygen atom, or a sulfur protecting group (e.g., acetamidomethyl, t-Bu, 3-nitro-2-pyridine sulfenyl, 2-pyridine-sulfenyl, or triphenylmethyl) when attached to a sulfur atom; and each R^{bb} is independently hydrogen, substituted (e.g., substituted with one or more halogen) or unsubstituted C₁₋₆ alkyl, or a nitrogen protecting group. In certain embodiments, the carbon atom substituents are independently halogen, substituted (e.g., substituted with one or more halogen) or unsubstituted C₁₋₆ alkyl, —OR^{aa}, —SR^{aa}, —N(R^{bb})₂, —CN, —SCN, or —NO₂. In certain embodiments, the carbon atom substituents are independently halogen, substituted (e.g., substituted with one or more halogen moieties) or unsubstituted C₁₋₆ alkyl, —OR^{aa}, —SR^{aa}, —N(R^{bb})₂, —CN, —SCN, or —NO₂, wherein R^{aa} is hydrogen, substituted (e.g., substituted with one or more halogen) or unsubstituted C₁₋₆ alkyl, an oxygen protecting group when attached to an oxygen atom, or a sulfur protecting group (e.g., acetamidomethyl, t-Bu, 3-nitro-2-pyridine sulfenyl, 2-pyridine-sulfenyl, or triphenylmethyl) when attached to a sulfur atom; and each R^{bb} is independently hydrogen, substituted (e.g., substituted with one or more halogen) or unsubstituted C₁₋₆ alkyl, or a nitrogen protecting group.

A “counterion” or “anionic counterion” is a negatively charged group associated with a positively charged group in order to maintain electronic neutrality. An anionic counterion may be monovalent (i.e., including one formal negative charge). An anionic counterion may also be multivalent (i.e., including more than one formal negative charge), such as divalent or trivalent. Exemplary counterions include halide ions (e.g., F⁻, Cl⁻, Br⁻, I⁻), NO₃⁻, ClO₄⁻, OH⁻, H₂PO₄⁻, HCO₃⁻, HSO₄⁻, sulfonate ions (e.g., methansulfonate, trifluoromethanesulfonate, p-toluenesulfonate, benzenesulfonate, 10-camphor sulfonate, naphthalene-2-sulfonate, naphthalene-1-sulfonic acid-5-sulfonate, ethan-1-sulfonic acid-2-sulfonate, and the like), carboxylate ions (e.g., acetate, propanoate, benzoate, glycerate, lactate, tartrate, glycolate, gluconate, and the like), BF₄⁻, PF₄⁻, PF₆⁻, AsF₆⁻, SbF₆⁻, B[3,5-(CF₃)₂C₆H₃]₄]⁻, B(C₆F₅)₄⁻, BPh₄⁻, Al(OC(CF₃)₃)₄⁻, and carborane anions (e.g., CB₁₁H₁₂⁻ or (HCB₁₁Me₅Br₆)⁻). Exemplary counterions which may be multivalent include CO₃²⁻, HPO₄²⁻, PO₄³⁻, B₄O₇²⁻, SO₄²⁻, S₂O₃²⁻, carboxylate anions (e.g., tartrate, citrate, fumarate, maleate, malate, malonate, gluconate, succinate, glutarate, adipate, pimelate, suberate, azelate, sebacate, salicylate, phthalates, aspartate, glutamate, and the like), and carboranes.

“Halo” or “halogen” refers to fluorine (fluoro, F), chlorine (chloro, Cl), bromine (bromo, Br), or iodine (iodo, I).

Nitrogen atoms can be substituted or unsubstituted as valency permits, and include primary, secondary, tertiary, and quaternary nitrogen atoms. Exemplary nitrogen atom substituents include hydrogen, —OH, —OR^{aa}, —N(R^{aa})₂, —CN, —C(═O)R^{aa}, —C(═O)N(R^{cc})₂—CO₂R^{aa}, —SO₂R^{aa}, —C(═NR^{bb})R^{aa}, —C(═NR^{cc})OR^{aa}, —C(═NR^{cc})N(R^{cc})₂, —SO₂N(R^{cc})₂, —SO₂R^{cc}, —SO₂OR^{cc}, —SOR^{aa}, —C(═S)N(R^{cc})₂, —C(═O)SR^{aa}, —C(═S)SR^{aa}, —P(═O)(OR^{cc})₂, —P(═O)(R^{cc})₂, —P(═O)(N(R^{cc})₂)₂, C₁₋₁₀ alkyl, C₁₋₁₀ perhaloalkyl, C₂₋₁₀ alkenyl, C₂₋₁₀ alkynyl, heteroC₁₋₁₀alkyl, heteroC₂₋₁₀alkenyl, heteroC₂₋₁₀alkynyl, C₃₋₁₀ carbocyclyl, 3-14 membered heterocyclyl, C₆₋₁₄ aryl, and 5-14 membered heteroaryl, or two R^{cc} groups attached to an N atom are joined to form a 3-14 membered heterocyclyl or 5-14 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups, and wherein R^{aa}, R^{bb}, R^{cc} and R^{dd} are as defined above.

In certain embodiments, the nitrogen atom substituents are independently substituted (e.g., substituted with one or more halogen) or unsubstituted C₁₋₆ alkyl, —C(═O)R^{aa}, —CO₂R^{aa}, —C(═O)N(R^{bb})₂, or a nitrogen protecting group. In certain embodiments, the nitrogen atom substituents are independently substituted (e.g., substituted with one or more halogen) or unsubstituted C₁₋₆ alkyl, —C(═O)R^{aa}, —CO₂R^{aa}, —C(═O)N(R^{bb})₂, or a nitrogen protecting group, wherein R^{aa} is hydrogen, substituted (e.g., substituted with one or more halogen) or unsubstituted C₁₋₆ alkyl, or an oxygen protecting group when attached to an oxygen atom; and each R^{bb} is independently hydrogen, substituted (e.g., substituted with one or more halogen) or unsubstituted C₁₋₆ alkyl, or a nitrogen protecting group. In certain embodiments, the nitrogen atom substituents are independently substituted (e.g., substituted with one or more halogen) or unsubstituted C₁₋₆ alkyl or a nitrogen protecting group.

In certain embodiments, the substituent present on a nitrogen atom is a nitrogen protecting group (also referred to as an amino protecting group). Nitrogen protecting groups include —OH, —OR^{aa}, —N(R^{cc})₂, —C(═O)R^{aa}, —C(═O)N(R^{cc})₂, —CO₂R^{aa}, —SO₂R^{aa}, —C(═NR^{c}c)R^{aa}, —C(═NR^{cc})OR^{aa}, —C(═NR^{cc})N(R^{cc})₂, —SO₂N(R^{cc})₂, —SO₂R^{cc}, —SO₂OR^{cc}, —SOR^{aa}, —C(═S)N(R^{cc})₂, —C(═O)SR^{cc}, —C(═S)SR^{cc}, C₁₋₁₀ alkyl (e.g., aralkyl, heteroaralkyl), C₂₋₁₀ alkenyl, C₂₋₁₀ alkynyl, C₃₋₁₀ carbocyclyl, 3-14 membered heterocyclyl, C₆₋₁₄ aryl, and 5-14 membered heteroaryl groups, wherein each alkyl, alkenyl, alkynyl, carbocyclyl, heterocyclyl, aralkyl, aryl, and heteroaryl is independently substituted with 0, 1, 2, 3, 4, or 5 R^{dd} groups, and wherein R^{aa}, R^{bb}, R^{cc}, and R^{dd} are as defined herein. Nitrogen protecting groups are well known in the art and include those described in detail in Protecting Groups in Organic Synthesis, T. W. Greene and P. G. M. Wuts, 3^{rd} edition, John Wiley & Sons, 1999, incorporated herein by reference.

Amide nitrogen protecting groups (e.g., —C(═O)R^{aa}) include formamide, acetamide, chloroacetamide, trichloroacetamide, trifluoroacetamide, phenylacetamide, 3-phenylpropanamide, picolinamide, 3-pyridylcarboxamide, N-benzoylphenylalanyl derivative, benzamide, p-phenylbenzamide, o-nitophenylacetamide, o-nitrophenoxyacetamide, acetoacetamide, (N′-dithiobenzyloxyacylamino)acetamide, 3-(p-hydroxyphenyl)propanamide, 3-(o-nitrophenyl)propanamide, 2-methyl-2-(o-nitrophenoxy)propanamide, 2-methyl-2-(o-phenylazophenoxy)propanamide, 4-chlorobutanamide, 3-methyl-3-nitrobutanamide, o-nitrocinnamide, N-acetylmethionine, o-nitrobenzamide, and o-(benzoyloxymethyl)benzamide.

Carbamate nitrogen protecting groups (e.g., —C(═O)OR^{aa}) include methyl carbamate, ethyl carbamante, 9-fluorenylmethyl carbamate (Fmoc), 9-(2-sulfo)fluorenylmethyl carbamate, 9-(2,7-dibromo)fluoroenylmethyl carbamate, 2,7-di-t-butyl-[9-(10,10-dioxo-10,10,10,10-tetrahydrothioxanthyl)]methyl carbamate (DBD-Tmoc), 4-methoxyphenacyl carbamate (Phenoc), 2,2,2-trichloroethyl carbamate (Troc), 2-trimethylsilylethyl carbamate (Teoc), 2-phenylethyl carbamate (hZ), 1-(1-adamantyl)-1-methylethyl carbamate (Adpoc), 1,1-dimethyl-2-haloethyl carbamate, 1,1-dimethyl-2,2-dibromoethyl carbamate (DB-t-BOC), 1,1-dimethyl-2,2,2-trichloroethyl carbamate (TCBOC), 1-methyl-1-(4-biphenylyl)ethyl carbamate (Bpoc), 1-(3,5-di-t-butylphenyl)-1-methylethyl carbamate (t-Bumeoc), 2-(2′- and 4′-pyridyl)ethyl carbamate (Pyoc), 2-(N,N-dicyclohexylcarboxamido)ethyl carbamate, t-butyl carbamate (BOC), 1-adamantyl carbamate (Adoc), vinyl carbamate (Voc), allyl carbamate (Alloc), 1-isopropylallyl carbamate (Ipaoc), cinnamyl carbamate (Coc), 4-nitrocinnamyl carbamate (Noc), 8-quinolyl carbamate, N-hydroxypiperidinyl carbamate, alkyldithio carbamate, benzyl carbamate (Cbz), p-methoxybenzyl carbamate (Moz), p-nitobenzyl carbamate, p-bromobenzyl carbamate, p-chlorobenzyl carbamate, 2,4-dichlorobenzyl carbamate, 4-methylsulfinylbenzyl carbamate (Msz), 9-anthrylmethyl carbamate, diphenylmethyl carbamate, 2-methylthioethyl carbamate, 2-methylsulfonylethyl carbamate, 2-(p-toluenesulfonyl)ethyl carbamate, [2-(1,3-dithianyl)]methyl carbamate (Dmoc), 4-methylthiophenyl carbamate (Mtpc), 2,4-dimethylthiophenyl carbamate (Bmpc), 2-phosphonioethyl carbamate (Peoc), 2-triphenylphosphonioisopropyl carbamate (Ppoc), 1,1-dimethyl-2-cyanoethyl carbamate, m-chloro-p-acyloxybenzyl carbamate, p-(dihydroxyboryl)benzyl carbamate, 5-benzisoxazolylmethyl carbamate, 2-(trifluoromethyl)-6-chromonylmethyl carbamate (Tcroc), m-nitrophenyl carbamate, 3,5-dimethoxybenzyl carbamate, o-nitrobenzyl carbamate, 3,4-dimethoxy-6-nitrobenzyl carbamate, phenyl(o-nitrophenyl)methyl carbamate, t-amyl carbamate, S-benzyl thiocarbamate, p-cyanobenzyl carbamate, cyclobutyl carbamate, cyclohexyl carbamate, cyclopentyl carbamate, cyclopropylmethyl carbamate, p-decyloxybenzyl carbamate, 2,2-dimethoxyacylvinyl carbamate, o-(N,N-dimethylcarboxamido)benzyl carbamate, 1,1-dimethyl-3-(N,N-dimethylcarboxamido)propyl carbamate, 1,1-dimethylpropynyl carbamate, di(2-pyridyl)methyl carbamate, 2-furanylmethyl carbamate, 2-iodoethyl carbamate, isoborynl carbamate, isobutyl carbamate, isonicotinyl carbamate, p-(p′-methoxyphenylazo)benzyl carbamate, 1-methylcyclobutyl carbamate, 1-methylcyclohexyl carbamate, 1-methyl-1-cyclopropylmethyl carbamate, 1-methyl-1-(3,5-dimethoxyphenyl)ethyl carbamate, 1-methyl-1-(p-phenylazophenyl)ethyl carbamate, 1-methyl-1-phenylethyl carbamate, 1-methyl-1-(4-pyridyl)ethyl carbamate, phenyl carbamate, p-(phenylazo)benzyl carbamate, 2,4,6-tri-t-butylphenyl carbamate, 4-(trimethylammonium)benzyl carbamate, and 2,4,6-trimethylbenzyl carbamate.

Sulfonamide nitrogen protecting groups (e.g., —S(═O)₂R^{aa}) include p-toluenesulfonamide (Ts), benzenesulfonamide, 2,3,6,-trimethyl-4-methoxybenzenesulfonamide (Mtr), 2,4,6-trimethoxybenzenesulfonamide (Mtb), 2,6-dimethyl-4-methoxybenzenesulfonamide (Pme), 2,3,5,6-tetramethyl-4-methoxybenzenesulfonamide (Mte), 4-methoxybenzenesulfonamide (Mbs), 2,4,6-trimcthylbenzenesulfonamide (Mts), 2,6-dimethoxy-4-methylbenzenesulfonamide (iMds), 2,2,5,7,8-pentamethylchroman-6-sulfonamide (Pme), methanesulfonamide (Ms), (3-trimethylsilylethanesulfonamide (SES), 9-anthracenesulfonamide, 4-(4′,8′-dimethoxynaphthylmethyl)benzenesulfonamide (DNMBS), benzylsulfonamide, trifluoromethylsulfonamide, and phenacylsulfonamide.

Other nitrogen protecting groups include phenothiazinyl-(10)-acyl derivative, N′-p-toluenesulfonylaminoacyl derivative, N′-phenylaminothioacyl derivative, N-benzoylphenylalanyl derivative, N-acetylmethionine derivative, 4,5-diphenyl-3-oxazolin-2-one, N-phthalimide, N-dithiasuccinimide (Dts), N-2,3-diphenylmaleimide, N-2,5-dimethylpyrrole, N-1,1,4,4-tetramethyldisilylazacyclopentane adduct (STABASE), 5-substituted 1,3-dimethyl-1,3,5-triazacyclohexan-2-one, 5-substituted 1,3-dibenzyl-1,3,5-triazacyclohexan-2-one, 1-substituted 3,5-dinitro-4-pyridone, N-methylamine, N-allylamine, N-[2-(trimethylsilyl)ethoxy]methylamine (SEM), N-3-acetoxypropylamine, N-(1-isopropyl-4-nitro-2-oxo-3-pyroolin-3-yl)amine, quaternary ammonium salts, N-benzylamine, N-di(4-methoxyphenyl)methylamine, N-5-dibenzosuberylamine, N-triphenylmethylamine (Tr), N-[(4-methoxyphenyl)diphenylmethyl]amine (MMTr), N-9-phenylfluorenylamine (PhF), N-2,7-dichloro-9-fluorenylmethyleneamine, N-ferrocenylmethylamino (Fcm), N-2-picolylamino N′-oxide, N-1,1-dimethylthiomethyleneamine, N-benzylideneamine, N-p-methoxybenzylideneamine, N-diphenylmethyleneamine, N-[(2-pyridyl)mesityl]methyleneamine, N—(N′,N′-dimethylaminomethylene)amine, N,N′-isopropylidenediamine, N-p-nitrobenzylideneamine, N-salicylideneamine, N-5-chlorosalicylideneamine, N-(5-chloro-2-hydroxyphenyl)phenylmethyleneamine, N-cyclohexylideneamine, N-(5,5-dimethyl-3-oxo-1-cyclohexenyl)amine, N-borane derivative, N-diphenylborinic acid derivative, N-[phenyl(pentaacylchromium- or tungsten)acyl]amine, N-copper chelate, N-zinc chelate, N-nitroamine, N-nitrosoamine, amine N-oxide, diphenylphosphinamide (Dpp), dimethylthiophosphinamide (Mpt), diphenylthiophosphinamide (Ppt), dialkyl phosphoramidates, dibenzyl phosphoramidate, diphenyl phosphoramidate, benzenesulfenamide, o-nitrobenzenesulfenamide (Nps), 2,4-dinitrobenzenesulfenamide, pentachlorobenzenesulfenamide, 2-nitro-4-methoxybenzenesulfenamide, triphenylmethylsulfenamide, and 3-nitropyridinesulfenamide (Npys).

In certain embodiments, a nitrogen protecting group is Bn, Boc, Cbz, Fmoc, trifluoroacetyl, triphenylmethyl, acetyl, or Ts.

In certain embodiments, the oxygen atom substituents are independently substituted (e.g., substituted with one or more halogen) or unsubstituted C₁₋₆ alkyl, —C(═O)R^{aa}, —CO₂R^{aa}, —C(═O)N(R^{bb})₂, or an oxygen protecting group. In certain embodiments, the oxygen atom substituents are independently substituted (e.g., substituted with one or more halogen) or unsubstituted C₁₋₆ alkyl, —C(═O)R^{aa}, —CO₂R^{aa}, —C(═O)N(R^{bb})₂, or an oxygen protecting group, wherein R^{aa} is hydrogen, substituted (e.g., substituted with one or more halogen) or unsubstituted C₁₋₈ alkyl, or an oxygen protecting group when attached to an oxygen atom; and each R^{bb} is independently hydrogen, substituted (e.g., substituted with one or more halogen) or unsubstituted C₁₋₈ alkyl, or a nitrogen protecting group. In certain embodiments, the oxygen atom substituents are independently substituted (e.g., substituted with one or more halogen) or unsubstituted C₁₋₆ alkyl or an oxygen protecting group.

In certain embodiments, the substituent present on an oxygen atom is an oxygen protecting group (also referred to herein as an “hydroxyl protecting group”). Oxygen protecting groups include —R^{aa}, —N(R^{bb})₂, —C(═O)SR^{aa}, —C(═O)R^{aa}, —CO₂R^{aa}, —C(═O)N(R^{bb})₂, —C(═NR^{bb})R^{aa}, —C(═NR^{bb})OR^{aa}, —C(═NR^{bb})N(R^{bb})₂, —S(═O)R^{aa}, —SO₂R^{aa}, —Si(R^{aa})₃, —P(R^{aa})₂, —P(R^{cc})₃⁺X⁻, —P(OR^{cc})₂, —P(OR^{cc})₃+X⁻, —P(═O)(R^{aa})₂, —P(═O)(OR^{cc})₂, and —P(═O)(N(R^{bb})₂)₂, wherein X⁻, R^{aa}, R^{bb}, and R^{cc} are as defined herein. Oxygen protecting groups are well known in the art and include those described in detail in Protecting Groups in Organic Synthesis, T. W. Greene and P. G. M. Wuts, 3^{rd} edition, John Wiley & Sons, 1999, incorporated herein by reference.

Exemplary oxygen protecting groups include methyl, methoxylmethyl (MOM), methylthiomethyl (MTM), t-butylthiomethyl, (phenyldimethylsilyl)methoxymethyl (SMOM), benzyloxymethyl (BOM), p-methoxybenzyloxymethyl (PMBM), (4-methoxyphenoxy)methyl (p-AOM), guaiacolmethyl (GUM), t-butoxymethyl, 4-pentenyloxymethyl (POM), siloxymethyl, 2-methoxyethoxymethyl (MEM), 2,2,2-trichloroethoxymethyl, bis(2-chloroethoxy)methyl, 2-(trimethylsilyl)ethoxymethyl (SEMOR), tetrahydropyranyl (THP), 3-bromotetrahydropyranyl, tetrahydrothiopyranyl, 1-methoxycyclohexyl, 4-methoxytetrahydropyranyl (MTHP), 4-methoxytetrahydrothiopyranyl, 4-methoxytetrahydrothiopyranyl S,S-dioxide, 1-[(2-chloro-4-methyl)phenyl]-4-methoxypiperidin-4-yl (CTMP), 1,4-dioxan-2-yl, tetrahydrofuranyl, tetrahydrothiofuranyl, 2,3,3a,4,5,6,7,7a-octahydro-7,8,8-trimethyl-4,7-methanobenzofuran-2-yl, 1-ethoxyethyl, 1-(2-chloroethoxy)ethyl, 1-methyl-1-methoxyethyl, 1-methyl-1-benzyloxyethyl, 1-methyl-1-benzyloxy-2-fluoroethyl, 2,2,2-trichloroethyl, 2-trimethylsilylethyl, 2-(phenylselenyl)ethyl, t-butyl, allyl, p-chlorophenyl, p-methoxyphenyl, 2,4-dinitrophenyl, benzyl (Bn), p-methoxybenzyl, 3,4-dimethoxybenzyl, o-nitrobenzyl, p-nitrobenzyl, p-halobenzyl, 2,6-dichlorobenzyl, p-cyanobenzyl, p-phenylbenzyl, 2-picolyl, 4-picolyl, 3-methyl-2-picolyl N-oxido, diphenylmethyl, p,p′-dinitrobenzhydryl, 5-dibenzosuberyl, triphenylmethyl, α-naphthyldiphenylmethyl, p-methoxyphenyldiphenylmethyl, di(p-methoxyphenyl)phenylmethyl, tri(p-methoxyphenyl)methyl, 4-(4′-bromophenacyloxyphenyl)diphenylmethyl, 4,4′,4″-tris(4,5-dichlorophthalimidophenyl)methyl, 4,4′,4″-tris(levulinoyloxyphenyl)methyl, 4,4′,4″-tris(benzoyloxyphenyl)methyl, 3-(imidazol-1-yl)bis(4′,4″-dimethoxyphenyl)methyl, 1,1-bis(4-methoxyphenyl)-1′-pyrenylmethyl, 9-anthryl, 9-(9-phenyl)xanthenyl, 9-(9-phenyl-10-oxo)anthryl, 1,3-benzodisulfuran-2-yl, benzisothiazolyl S,S-dioxido, trimethylsilyl (TMS), triethylsilyl (TES), triisopropylsilyl (TIPS), dimethylisopropylsilyl (IPDMS), diethylisopropylsilyl (DEIPS), dimethylthexylsilyl, t-butyldimethylsilyl (TBDMS), t-butyldiphenylsilyl (TBDPS), tribenzylsilyl, tri-p-xylylsilyl, triphenylsilyl, diphenylmethylsilyl (DPMS), t-butylmethoxyphenylsilyl (TBMPS), formate, benzoylformate, acetate, chloroacetate, dichloroacetate, trichloroacetate, trifluoroacetate, methoxyacetate, triphenylmethoxyacetate, phenoxyacetate, p-chlorophenoxyacetate, 3-phenylpropionate, 4-oxopentanoate (levulinate), 4,4-(ethylenedithio)pentanoate (levulinoyldithioacetal), pivaloate, adamantoate, crotonate, 4-methoxycrotonate, benzoate, p-phenylbenzoate, 2,4,6-trimethylbenzoate (mesitoate), alkyl methyl carbonate, 9-fluorenylmethyl carbonate (Fmoc), alkyl ethyl carbonate, alkyl 2,2,2-trichloroethyl carbonate (Troc), 2-(trimethylsilyl)ethyl carbonate (TMSEC), 2-(phenylsulfonyl) ethyl carbonate (Psec), 2-(triphenylphosphonio) ethyl carbonate (Peoc), alkyl isobutyl carbonate, alkyl vinyl carbonate alkyl allyl carbonate, alkyl p-nitrophenyl carbonate, alkyl benzyl carbonate, alkyl p-methoxybenzyl carbonate, alkyl 3,4-dimethoxybenzyl carbonate, alkyl o-nitrobenzyl carbonate, alkyl p-nitrobenzyl carbonate, alkyl S-benzyl thiocarbonate, 4-ethoxy-1-napththyl carbonate, methyl dithiocarbonate, 2-iodobenzoate, 4-azidobutyrate, 4-nitro-4-methylpentanoate, o-(dibromomethyl)benzoate, 2-formylbenzenesulfonate, 2-(methylthiomethoxy)ethyl, 4-(methylthiomethoxy)butyrate, 2-(methylthiomethoxymethyl)benzoate, 2,6-dichloro-4-methylphenoxyacetate, 2,6-dichloro-4-(1,1,3,3-tetramethylbutyl)phenoxyacetate, 2,4-bis(1,1-dimethylpropyl)phenoxyacetate, chlorodiphenylacetate, isobutyrate, monosuccinoate, (E)-2-methyl-2-butenoate, o-(methoxyacyl)benzoate, α-naphthoate, nitrate, alkyl N,N,N′,N′-tetramethylphosphorodiamidate, alkyl N-phenylcarbamate, borate, dimethylphosphinothioyl, alkyl 2,4-dinitrophenylsulfenate, sulfate, methanesulfonate (mesylate), benzylsulfonate, and tosylate (Ts).

In certain embodiments, an oxygen protecting group is silyl, TBDPS, TBDMS, TIPS, TES, TMS, MOM, THP, t-Bu, Bn, allyl, acetyl, pivaloyl, or benzoyl.

In certain embodiments, the sulfur atom substituents are independently substituted (e.g., substituted with one or more halogen) or unsubstituted C₁₋₆ alkyl, —C(═O)R^{aa}, —CO₂R^{aa}, —C(═O)N(R^{bb})₂, or a sulfur protecting group. In certain embodiments, the sulfur atom substituents are independently substituted (e.g., substituted with one or more halogen) or unsubstituted C₁₋₆ alkyl, —C(═O)R^{aa}, —CO₂R^{aa}, —C(═O)N(R^{bb})₂, or a sulfur protecting group, wherein R^{aa} is hydrogen, substituted (e.g., substituted with one or more halogen) or unsubstituted C₁₋₆ alkyl, or an oxygen protecting group when attached to an oxygen atom; and each R^{bb} is independently hydrogen, substituted (e.g., substituted with one or more halogen) or unsubstituted C₁₋₆ alkyl, or a nitrogen protecting group. In certain embodiments, the sulfur atom substituents are independently substituted (e.g., substituted with one or more halogen) or unsubstituted C₁₋₆ alkyl or a sulfur protecting group.

In certain embodiments, the substituent present on a sulfur atom is a sulfur protecting group (also referred to as a “thiol protecting group”). Sulfur protecting groups include —R^{aa}, —N(R^{bb})₂, —C(═O)SR^{aa}, —C(═O)R^{aa}, —CO₂R^{aa}, —C(═O)N(R^{bb})₂, —C(═NR^{bb})R^{aa}, —C(═NR^{bb})OR^{aa}, —C(═NR^{bb})N(R^{bb})₂, —S(═O)R^{aa}, —SO₂R^{aa}, —Si(R^{aa})₃, —P(R^{cc})₂, —P(R^{cc})₃+X⁻, —P(OR^{cc})₂, —P(OR^{cc})₃+X⁻, —P(═O)(R^{cc})₂, —P(═O)(OR^{cc})₂, and —P(═O)(N(R^{bb})₂)₂, wherein R^{aa}, R^{bb}, and R^{cc} are as defined herein. Sulfur protecting groups are well known in the art and include those described in detail in Protecting Groups in Organic Synthesis, T. W. Greene and P. G. M. Wuts, 3^{rd} edition, John Wiley & Sons, 1999, incorporated herein by reference. In certain embodiments, a sulfur protecting group is acetamidomethyl, t-Bu, 3-nitro-2-pyridine sulfenyl, 2-pyridine-sulfenyl, or triphenylmethyl.

The “molecular weight” of —R, wherein —R is any monovalent moiety, is calculated by subtracting the atomic weight of a hydrogen atom from the molecular weight of the molecule R—H. The “molecular weight” of -L-, wherein -L- is any divalent moiety, is calculated by subtracting the combined atomic weight of two hydrogen atoms from the molecular weight of the molecule H-L-H.

In certain embodiments, the molecular weight of a substituent is lower than 200, lower than 150, lower than 100, lower than 50, or lower than 25 g/mol. In certain embodiments, a substituent consists of carbon, hydrogen, fluorine, chlorine, bromine, iodine, oxygen, sulfur, nitrogen, and/or silicon atoms. In certain embodiments, a substituent consists of carbon, hydrogen, fluorine, chlorine, bromine, and/or iodine atoms. In certain embodiments, a substituent consists of carbon, hydrogen, and/or fluorine atoms. In certain embodiments, a substituent does not comprise one or more, two or more, or three or more hydrogen bond donors. In certain embodiments, a substituent does not comprise one or more, two or more, or three or more hydrogen bond acceptors.

In some embodiments, it can be particularly advantageous if polyimide aerogels comprising polyimide chains that comprise repeating segments of this moiety wherein the moiety repeats 1 time, 2 times, 3 times, 4 times, 5 times, or more than 5 times. In some embodiments, it can be particularly advantageous if polyimide chains comprising this moiety are connected to each other by a crosslinker. In some embodiments, it can be particularly advantageous if the pattern of specifically alternating constituent monomers from which the moiety is derived gives rise to the hydrophobic and/or water-resistant properties of the polyimide aerogel. Without wishing to be bound to any particular theory, this moiety may impart enhanced water-resistance properties to polyimide aerogels because of its high density of aryl, isopropylidene, and methyl groups, which are all hydrophobic groups, to counteract hydrophilicity inherent to the imide group. Without wishing to be bound by any particular theory, the inclusion of one unit of ODA, which comprises a flexible oxygen bridge, may impart flexibility into the moiety that provides for a polyimide aerogel with reduced fragility compared to a moiety that does not comprise a flexible oxygen bridge.

In accordance with certain embodiments, aerogel materials may be made from a precursor gel material. For example, some embodiments comprise preparing a precursor gel and removing liquid from the gel to form an aerogel. Various methods of forming aerogels are described below and elsewhere herein. Similarly, various methods of forming aerogel precursors (e.g., gels) are described below.

Certain aspects are related to methods of forming aerogels, gels, or precursors thereof.

In certain embodiments, the method described herein comprises combining an amount of biphenyl-3,3′,4,4′-tetracarboxylic dianhydride (BPDA), a first diamine, and a solvent. The combination can be performed in any of a variety of ways. Some embodiments comprise first combining the BPDA and the solvent and subsequently adding the first diamine. Other embodiments comprise first combining the first diamine and the solvent and subsequently adding the BPDA. Still other embodiments comprise simultaneously combining the BPDA, the first diamine, and the solvent

In some embodiments, combining the amount of BPDA, the first diamine, and the solvent is performed such that a first intermediate medium comprising anhydride-capped poly(amic acid) trimer is formed.

In certain embodiments, the method comprises combining the first intermediate medium and a second diamine. In some embodiments, combining the first intermediate medium and the second diamine is performed such that a second intermediate medium comprising pentamer is formed.

In some embodiments, the method comprises combining the second intermediate medium and an additional amount of BPDA. In certain embodiments, combining the second intermediate and the additional amount of BPDA is performed such that a third intermediate comprising heptamer is formed.

In some embodiments, the method comprises combining the third intermediate medium and a third diamine such that a fourth intermediate medium is formed. In certain embodiments, combining the third intermediate and third diamine is performed such that a fourth intermediate medium comprising oligomer chains is formed.

In certain embodiments, the method comprises combining the fourth intermediate medium and a crosslinking reagent. In some embodiments, combining the fourth intermediate medium and the crosslinking reagent is performed such that a gel is formed. In some embodiments, the crosslinking agent comprises three or more amine groups. In some embodiments, the crosslinking agent comprises a functional group that reacts with a terminal group on the oligomers to produce a crosslinking-agent-terminated oligomer. In some embodiments, the crosslinking agent comprises functional groups that react with another crosslinking agent molecule and/or another crosslinking-agent-terminated oligomer to connect crosslinking-agent-terminated oligomers together. In some embodiments, the crosslinking agent is introduced at a balanced stoichiometry of a functional group on the crosslinking agent that is reactive towards a terminal group on the polyimide oligomer to the complementary terminal groups on the polyimide oligomers. In some embodiments, two or more oligomers are attached to the same crosslinking agent. In some embodiments, the resulting network is chemically imidized to yield a porous crosslinked polyimide network. In some embodiments, the oligomers are imidized prior to crosslinking. In some embodiments, the oligomers are imidized concurrently with crosslinking.

In some embodiments, the first diamine is different from the second diamine and the third diamine. In certain embodiments, the second diamine is different from the third diamine.

In some embodiments, the first diamine, the second diamine, and the third diamine are selected from the group consisting of 3,4′-oxydianiline (3,4-ODA); 4,4′-oxydianiline (4,4-ODA or ODA); p-phenylene diamine (pPDA); n-phenylene diamine (mPDA); p-phenylene diamine (mPDA); 2,2′-dimethylbenzidine (DMBZ); 4,4′-bis(4-aminophenoxy)biphenyl; 2,2′-bis[4-(4-aminophenoxyl)phenyl]propane; bisaniline-p-xylidene (BAX); 4,4′-methylene dianiline (MDA); 4,4′-[1,3-phenylenebis(1-methyl-ethylidene)]bisaniline (bisaniline-m); 4,4′-[1,4-phenylenebis(1-methyl-ethylidene)]bisaniline (bisaniline-p); 3,3′-dimethyl-4,4′-diaminobiphenyl (o-tolidine); 2,2-bis [4-(4-aminophenoxy)phenyl]propane (BAPP); 3,3′-dihydroxy-4,4′-diamino-biphenyl (HAB); 3,3′-diaminodiphenyl sulfone (3,3′-DDS); 4,4′-diaminodiphenyl sulfone (4,4′-DDS); 4,4′-diaminodiphenyl sulfide (ASD); 2,2-bis[4-(4-aminophenoxy) phenyl]sulfone (BAPS); 2,2-bis[4-(3-aminophenoxy) benzene](m-BAPS); 1,4-bis(4-aminophenoxy) benzene (TPE-Q); 1,3-bis(4-aminophenoxy) benzene (TPE-R); 1,3′-bis(3-aminophenoxy) benzene (APB-133); 4,4′-bis(4-aminophenoxy) biphenyl (BAPB); 4,4′-diaminobenzanilide (DABA); 9,9′-bis(4-aminophenyl) fluorene (FDA); o-tolidine sulfone (TSN); methylene bis(anthranilic acid) (MBAA); 1,3′-bis(4-aminophenoxy)-2,2-dimethylpropane (DANPG); 2,3,5,6-tetramethyl-1,4-phenylenediamine (TMPD); 3,3′,5,5′-tetramethylbenzidine (3355TMB); 1,5-bis(4-aminophenoxy) pentane (DA5MG); 2,5-diaminobenzotrifluoride (25DBTF); 3,5-diaminobenzotrifluoride (35DBTF); 1,3-diamino-2,4,5,6-tetrafluorobenzene (DTFB); 2,2′-bis(trifluoromethyl)benzidine (22TFMB); 3,3′-bis(trifluoromethyl)benzidine (33TFMB); 2,2-bis[4-(4-aminophenoxy phenyl)]hexafluoropropane (HFBAPP); 2,2-bis(4-aminophenyl)hexafluoropropane (Bis-A-AF); 2,2-bis(3-amino-4-hydroxyphenyl)hexafluoropropane (Bis-AP-AF); 2,2-bis(3-amino-4-methylphenyl)hexafluoropropane (Bis-AT-AF); o-phenylene diamine; diaminobenzanilide; 3,5-diaminobenzoic acid; 3,3′diaminodiphenylsulfone; 4,4′-diaminodiphenylsulfone; 1,3-bis(4-aminophenoxy)benzene; 1,3-bis(3-aminophenoxy)benzene; 1,4-bis(4-aminophenoxy)benzene; 1,4-bis(3-aminophenoxy)benzene; 2,2-bis[4-(4-aminophenoxy)phenyl]hexafluoropropane; 2,2-bis(3-aminophenyl)hexafluoropropane; 4,4′-isopropylidenedianiline; 1-(4-aminophenoxy)-3-(3-aminophenoxy)benzene; 1-(4-aminophenoxy)-4-(3-aminophenoxy)benzene; bis[4-(4-aminophenoxy)phenyl]sulfone; bis[4-(3-aminophenoxy)phenyl]sulfone; bis(4-[4-aminophenoxy]phenyl)ether; 2,2′-bis(4-aminophenyl)hexafluoropropene; 2,2′-bis(4-phenoxyaniline)isopropylidene; 1,2-diaminobenzene; 4,4′-diaminodiphenylmethane; 2,2-bis(4-aminophenyl)propane; 4,4′-diaminodiphenylpropane; 4,4′-diaminodiphenylsulfide; 4,4-diaminodiphenylsulfone; 3,4′-diaminodiphenylether; 4,4′-diaminodiphenylether; 2,6-diaminopyridine; bis(3-aminophenyl)diethylsilane; 4,4′-diaminodiphenyldiethylsilane; benzidine-3′-dichlorobenzidine; 3,3′-dimethoxybenzidine; 4,4′-diaminobenzophenone; N,N-bis(4-aminophenyl)butylamine; N,N-bis(4-aminophenyl)methylamine; 1,5-diaminonaphthalene; 3,3′-dimethyl-4,4′-diaminobiphenyl; 4-aminophenyl-3-aminobenzoate; N,N-bis(4-aminophenyl)aniline; bis(p-beta-amino tert-butyl phenyl)ether; p-bis-2-(2-methyl-4-aminopentyl)benzene; p-bis(1,1-dimethyl-5-aminopentyl)benzene; 1,3-bis(4-aminophenoxy)benzene; m-xylene diamine; p-xylene diamine; 4,4′-diamino diphenylether phosphine oxide; 4,4′-diamino diphenyl N-methylamine; 4,4′-diamino diphenyl N-phenylamine; amino-terminal polydimethylsiloxanes; amino-terminal polypropylene oxides; amino-terminal polybutylene oxides; 4,4′-methylene bis(2-methyl cyclohexylamine); 1,2-diaminoethane; 1,3-diaminopropane; 1,4-diaminobutane; 1,5-diaminopentane; 1,6-diaminohexane; 1,7-diaminoheptane; 1,8-diaminooctane; 1,9-diaminononane; 1,10-diaminodecane; 4,4′-methylene bis(benzeneamine); 2,2′-dimethyl benzidine; bisaniline-p-xylidene; 4,4′-bis(4-aminophenoxy)biphenyl; 3,3′-bis(4-aminophenoxy)biphenyl; 4,4′-(1,4-phenylene diisopropylidene)bisaniline; and/or 4,4′-(1,3-phenylene diisopropylidene)bisaniline.

In some embodiments, it can be particularly advantageous if the first diamine, the second diamine, and the third diamine are selected from the group consisting of 2,2′-dimethylbenzidine (DMBZ), 4,4′-oxydianiline (4,4-ODA), and 4,4′-[1,3-phenylenebis(1-methyl-ethylidene)]bisaniline (bisaniline-m).

In certain embodiments, the first diamine is DMBZ, the second diamine is 4,4-ODA, and the third diamine is bisaniline-m. In certain embodiments, the first diamine is bisaniline-m, the second diamine is DMBZ, and the third diamine is 4,4-ODA. In certain embodiments the first diamine is bisaniline-m, the second diamine is 4,4-ODA, and the third diamine is DMBZ. In certain embodiments the first diamine is 4,4-ODA, the second diamine is bisaniline-m, and the third diamine is DMBZ. In some embodiments, it can be particularly advantageous if the first diamine is DMBZ, the second diamine is bisaniline-m, and the third diamine is 4,4-ODA.

In some embodiments, combining the amount of BPDA, the first diamine, and the solvent comprises combining the first diamine and the amount of BPDA in a relative amount, based on a ratio of the amount of BPDA to the first diamine, of between 0.9:1 and 1.1:1, between 1.4:1 and 1.6:1, between 1.6:1 and 1.8:1, between 1.9:1 and 2.1:1, and/or between 2.9:1 and 3.1:1. In some embodiments, it can be particularly advantageous if the ratio is between 1.9:1 and 2.1:1. In some embodiments, combining the first intermediate medium and a second diamine comprises combining the anhydride capped poly(amic acid) trimer and the second diamine in a relative amount, based on a molar ratio of the second diamine to the anhydride-capped poly(amic acid) trimer of between 0.9:1 and 1.1:1, between 1.4:1 and 1.6:1, between 1.6:1 and 1.8:1, between 1.9:1 and 2.1:1, and/or between 2.9:1 and 3.1:1. In some embodiments, it can be particularly advantageous if the ratio is between 1.9:1 and 2.1:1. In some embodiments, combining the second intermediate medium and the additional amount of BPDA comprises combining the pentamer and the additional amount of BPDA in a relative amount, based on a molar ratio of the additional amount of BPDA to the pentamer, of between 0.9:1 and 1.1:1, between 1.4:1 and 1.6:1, between 1.6:1 and 1.8:1, between 1.9:1 and 2.1:1, and/or between 2.9:1 and 3.1:1. In some embodiments, it can be particularly advantageous if the ratio is between 1.9:1 and 2.1:1. In some embodiments, combining the third intermediate medium and the third diamine comprises combining the heptamer and the third diamine in a relative amount, based on the molar ratio of the third diamine to the heptamer, of between 0.4:1 and 0.6:1, between 0.8:1 and 1.1:1, between 0.8:1 and 1.1:1, between 1.8:1 and 2.2:1. In some embodiments, it can be particularly advantageous if the ratio is between 0.8:1 and 1.1:1. In some embodiments, combining the fourth intermediate medium and the crosslinking reagent comprises combining the oligomer chains and the crosslinking reagent in a relative amount, based on the molar ratio of the crosslinker to the oligomer chain, of between 0.5:1 and 0.75:1, 0.8:1 and 1.1:1, an/or between 1.4:1 and 1.6:1. In some embodiments the ratio is between 0.9:1 and 1.1:1, between 1.4:1 and 1.6:1, between 1.6:1 and 1.8:1, between 1.9:1 and 2.1:1, and/or between 2.9:1 and 3.1:1. In some embodiments, it can be particularly advantageous if the ratio is between 1.9:1 and 2.1:1.

In some embodiments, combining the fourth intermediate medium and the crosslinking agent also comprises combining a catalyst with the fourth intermediate medium and the crosslinking agent. In some embodiments the catalyst comprises pyridine; a methylpyridine; quinoline; isoquinoline; 1,8-diazabicyclo[5.4.0]undec-7-ene (DBU); DBU phenol salts; carboxylic acid salts of DBU; triethylenediamine; a carboxylic acid salt of triethylenediamine; lutidine; n-methylmorpholine; triethylamine; tripropylamine; tributylamine; N,N-dimethylbenzylamine; N,N′-dimethylpiperazine; N,N-dimethylcyclohexylamine; N,N′,N″-tris(dialkylaminoalkyl)-s-hexahydrotriazines, for example N,N′,N″-tris(dimethylaminopropyI)-s-hexahydrotriazine; tris(dimethylaminomethyl)phenol; bis(2-dimethylaminoethyl) ether; N,N,N,N,N-pentamethyldiethylenetriamine; methylimidazole; dimethylimidazole; dimethylbenzylamine; 1,6-diazabicyclo[5.4.0]undec-7-ene (IUPAC: 1,4-diazabicyclo[2.2.2]octane); triethylenediamine; dimethylaminoethanolamine; dimethylaminopropylamine; N,N-dimethylaminoethoxyethanol; N,N,N-trimethylaminoethylethanolamine; triethanolamine; diethanolamine; triisopropanolamine; diisopropanolamine; and/or any suitable trialkylamine. In some embodiments, it can be particularly advantageous if the catalyst comprises triethylamine and/or tripropylamine.

In some embodiments, combining the fourth intermediate medium and the crosslinking reagent also comprises combing a water scavenger with the fourth intermediate medium and the crosslinking agent. In some embodiments, combining the fourth intermediate medium and the crosslinking reagent comprises combining the oligomer chains and the water scavenger in a relative amount, based on the molar ratio of the water scavenger to BPDA, of between 2:1 and 4:1, between 4:1 and 6:1, between 6:1 and 8:1, and or between 8:1 and 10:1. In some embodiments, it can be particularly advantageous if the ratio is between 7:1 and 9:1. In some embodiments the water scavenger comprises acetic anhydride, propionic anhydride, n-butyric anhydride, benzoic anhydride, trifluoroacetic anhydride, phosphorous trichloride, and/or dicyclohexylcarbodiimide. In some embodiments, it can be particularly advantageous if the water scavenger comprises acetic anhydride.

In some embodiments, a solvent is used. In some embodiments the solvent comprises dimethylsulfoxide; diethylsulfoxide; N,N-dimethylformamide; N,N-diethylformamide; N,N-dimethylacetamide; N,N-diethylacetamide; N-methyl-2-pyrrolidone; 1-methyl-2-pyrrolidinone; N-cyclohexyl-2-imidazolidinone; diethylene glycol dimethoxyether; o-dichlorobenzene; phenols; cresols; xylenol; catechol; butyrolactones; acetone; methyl ethyl ketone; ethyl ethyl ketone; methyl propyl ketone; acetonitrile; ethyl acetate; and/or hexamethylphosphoramides. In some embodiments, it can be particularly advantageous if the solvent comprises N-methyl-2-pyrrolidone.

In some embodiments, the total amount of monomer is determined relative to the amount of solvent used. In certain embodiments, the total mass of all monomers is greater than 5% of the total mass of the solvent.

In some embodiments, a gel is formed. In some embodiments, the liquid is removed from the gel to produce an aerogel.

In some embodiments, a polyimide aerogel may be made from a suitable polyimide gel using any suitable drying technique, for example, supercritical CO₂ drying, evaporative drying, vacuum freeze drying, and/or atmospheric-pressure freeze drying.

In some embodiments, the gel is solvent exchanged into an organic solvent, i.e., the pore fluid, also called pore liquor, within the gels is substantially replaced by the organic solvent through diffusive soaking in a bath of the target organic solvent, after which the gel was subsequently dried via any suitable method for making an aerogel. In some embodiments, the gel is solvent exchanged into acetone, and then subsequently dried via any suitable method for making an aerogel. In some embodiments the liquid in the gel is first at least partially replaced by carbon dioxide, after which the carbon dioxide is then removed from the gel. In some embodiments, the drying method comprises subcritical CO₂ evaporative drying, supercritical drying from CO₂, supercritical drying from organic solvent, ambient-pressure evaporation of solvent from gel, freeze drying of the gel and or ambient-pressure freeze drying of the gel.

Aerogels may be fabricated by removing the liquid from a gel in a way that substantially preserves both the porosity and integrity of the gel's intricate nanostructured solid network. For most gel materials, if the liquid in the gel is evaporated, capillary stresses will arise as the vapor-liquid interface recedes into and/or from the gel, causing the gel's solid network to shrink and/or pull inwards on itself, and collapse. The resulting material is a dry, comparatively dense, low-porosity (generally <10% by volume) material that is often referred to as a xerogel material, or a solid formed from the gel by drying with unhindered shrinkage. However, the liquid in the gel may instead be heated and pressurized past its critical point, a specific temperature and pressure at which the liquid will transform into a semi-liquid/semi-gas, or supercritical fluid, that exhibits little surface tension, if at all. Below the critical point, the liquid is in equilibrium with a vapor phase. As the system is heated and pressurized towards its critical point, however, molecules in the liquid develop an increasing amount of kinetic energy, moving past each other increasingly fast until eventually their kinetic energy exceeds the intermolecular adhesion forces that give the liquid its cohesion. Simultaneously, the pressure in the vapor also increases, bringing molecules on average closer together until the density of the vapor becomes nearly and/or substantially as dense as the liquid phase. As the system reaches the critical point, the liquid and vapor phases become substantially indistinguishable and merge into a single phase that exhibits a density and thermal conductivity comparable to a liquid, yet is also able to expand and compress in a manner similar to a gas. Although technically a gas, the term supercritical fluid may refer to fluids near but past their critical point as such fluids, due to their density and kinetic energy, exhibit liquid-like properties that are not typically exhibited by ideal gases, for example, the ability to dissolve other substances. Since phase boundaries do not typically exist past the critical point, a supercritical fluid exhibits no surface tension and thus exerts no capillary forces, and can be removed from a gel without causing the gel's solid skeleton to collapse by isothermal depressurization of the fluid. After fluid removal, the resulting dry, low-density, high-porosity material is an aerogel.

The critical point of most substances typically lies at relatively high temperatures and pressures, thus, supercritical drying generally involves heating gels to elevated temperatures and pressures and, hence, is performed in a pressure vessel. For example, if a gel contains ethanol as its pore fluid, the ethanol can be supercritically extracted from the gel by placing the gel in a pressure vessel containing additional ethanol, slowly heating the vessel past the critical temperature of ethanol (241° C.), and allowing the autogenic vapor pressure of the ethanol to pressurize the system past the critical pressure of ethanol (60.6 atm). At these conditions, the vessel can then be quasi-isothermally depressurized so that the ethanol diffuses out of the pores of the gel without recondensing into a liquid. Likewise, if a gel contains a different solvent in its pores, the vessel may be heated and pressurized past the critical point of that solvent. Extraction of organic solvent from a gel requires specialized equipment, however, since organic solvents at their critical points can be dangerously flammable and explosive. Instead of supercritically extracting an organic solvent directly from a gel, the liquid in the pores of the gel may instead first be exchanged with a safer, nonflammable liquid, namely, carbon dioxide, which is typically miscible with most organic solvents and which has a relatively low critical point of 31.1° C. and 72.9 atm. In some embodiments, instead of first replacing the liquid in the pores of the gel with liquid CO₂ and then performing supercritical extraction of the CO₂, the liquid in a gel may instead be extracted by flowing supercritical CO₂ over the gel. Such so-called supercritical CO₂ drying processes are commonly employed in the manufacture of aerogel materials. In accordance some embodiments described herein, supercritical CO₂ drying may be used to make aerogels.

In some embodiments, aerogels may be fabricated by removing the liquid from a gel by evaporative drying of the solvent. In some embodiments, the pore fluid exhibits a sufficiently low surface tension to prevent damaging the gel when evaporated, for example, less than or equal to 20 dynes/cm, less than or equal to 15 dynes/cm, less than or equal to 12 dynes/cm, or less than or equal to 10 dynes/cm. In certain embodiments, the surface tension of the solvent is less than or equal to 20 dynes/cm, less than or equal to 15 dynes/cm, less than or equal to 12 dynes/cm, or less than or equal to 10 dynes/cm. Combinations of these ranges are also possible (e.g., at least 5 and less than or equal to 25). Other ranges are also possible. In some embodiments, it can be particularly advantageous if the pore fluid selected for evaporative drying is ethoxynonafluorobutane (e.g., Novec 7200). In some embodiments, the solvent is evaporated at room temperature. In some embodiments, it can be particularly advantageous if the solvent is evaporated in an atmosphere of dry air (i.e., substantially water-free), nitrogen, and/or another substantially water-free inert gas. In some embodiments, it can be particularly advantageous if the pore fluid selected for evaporative drying is carbon dioxide at a temperature below its critical temperature and pressure of approximately 31.1° C. and 72.8 atm (1071 psi). In one such embodiment, the gel is evaporatively dried from liquid carbon dioxide at a temperature of approximately 28° C. and a pressure of about 68.0 atm (1000 psi).

In some embodiments, aerogels may be fabricated from gels by sublimation of a frozen pore fluid rather than evaporation of liquid-phase pore fluid. The pore fluid may be suitably frozen and sublimated with little to no capillary force, resulting in an aerogel. That is, rather than removing the solvent via evaporation from a liquid state, the solvent is sublimated from a solid state (having been frozen), hence, minimizing capillary forces that may otherwise result via evaporation. In some embodiments, the sublimation of the frozen pore fluid is performed under vacuum, or partial vacuum conditions, e.g., lyophilization. In some embodiments, the sublimation of the frozen pore fluid is performed at atmospheric pressure. In some embodiments, the method includes providing a gel material having a solvent located within pores of the gel material, freezing the solvent within the pores of the gel material, and sublimating the solvent at ambient conditions to remove the solvent from the pores of the gel material to produce an aerogel material. In some embodiments, the sublimation of the solvent is performed in dry (i.e., substantially water-free) air, nitrogen, and/or another substantially water-free inert gas. In some embodiments, it can be particularly advantageous if the pore fluid selected for this process is tert-butanol.

Aerogels can be made of a variety of materials and can exhibit a number of geometries. Generally speaking, aerogels are dry, highly porous, solid-phase materials that may exhibit a diverse array of extreme and valuable materials properties, e.g., low density, low thermal conductivity, high density-normalized strength and stiffness, and/or high specific internal surface area. In some embodiments, the pores within an aerogel material are less than about 100 nm in diameter. In some embodiments, it can be particularly advantageous if the diameter of the pores within an aerogel material fall between about 2-50 nm in diameter, i.e., the aerogel is mesoporous. In some embodiments, aerogels may contain pores with diameters greater than about 100 nm, and in some embodiments, aerogels may even contain pores with diameters of several microns. In some embodiments, at least 50%, at least 60%, at least 70%, at least 80%, at least 90%, at least 95%, at least 99%, or more of the pore volume is made up of pores having diameters of less than 100 nm. In some embodiments, at least 50%, at least 60%, at least 70%, at least 80%, at least 90%, at least 95%, at least 99%, or more of the pore volume is made up of pores having diameters of less than 50 nm. In some embodiments, it can be particularly advantageous if at least 50%, at least 60%, at least 70%, at least 80%, at least 90%, at least 95%, at least 99%, or more of the pore volume is made up of pores having diameters of less than 25 nm. In some embodiments, an aerogel may contain a monomodal distribution of pores, a bimodal distribution of pores, or a polymodal distribution of pores. Suitable aerogel material compositions may include, for example, silica, metal and/or metalloid oxides, metal chalcogenides, metals and/or metalloids, metal and/or metalloid carbides, metal and/or metalloid nitrides, organic polymers, biopolymers, amorphous carbon, graphitic carbon, diamond, and discrete nanoscale objects such as carbon nanotubes, boron nitride nanotubes, viruses, semiconducting quantum dots, graphene, 2D boron nitride, or combinations thereof.

In some embodiments, polymer aerogels comprising an organic polymer may provide certain advantages over more commercially widespread inorganic aerogels such as silica aerogels. For example, silica aerogels often exhibit low fracture toughness and are accordingly brittle and friable. As a result, most silica aerogel materials are generally considered unsuitable for use as structural elements. In some embodiments, polymer aerogels comprising an organic polymer may exhibit improved strength, stiffness, and toughness properties over silica aerogels and thus may be used in lightweight structural elements as an alternative to traditional plastics or fiber-reinforced composites, which are much denser in comparison.

In some embodiments, it can be particularly advantageous if a polymer aerogel comprises a three-dimensional network of organic polymer comprising monomers and/or crosslinks of functionality three or greater, e.g., it comprises the reaction product of a crosslinking agent and three or more oligomers and/or the reaction product of a monomer with three or more other monomers. In some embodiments, it can be particularly advantageous if a polymer network comprising trifunctional or higher functionality monomers and/or crosslinking agents provides for an aerogel with suitable strength, stiffness, and toughness properties for use as a structural material. In some embodiments, the strength, stiffness, and toughness properties of the aerogel are suitable for production of aerogel parts with large, e.g., greater than about 30 cm, dimensions. As would be understood by those of ordinary skill in the art, the length of a particular dimension of an aerogel corresponds to the distance between the exterior boundaries of the aerogel along that dimension. As also would be understood by those of ordinary skill in the art, when measuring three dimensions of an aerogel, each dimension would be perpendicular to the other two (such that the second dimension would be perpendicular to the first dimension, and the third dimension would be perpendicular to the first and second dimensions).

In some embodiments, the weight, i.e., mass, percent polymer in solution is controlled during gel synthesis (e.g., polyimide gel synthesis). The term weight percent polymer in solution refers to the weight of monomers in solution minus the weight of byproducts resulting from condensation reactions among the monomers, relative to the weight of the solution. The weight percent polymer in solution can be less than or equal to about 1%, less than or equal to about 2%, less than or equal to about 3%, less than or equal to about 4%, less than or equal to about 5%, less than or equal to about 6%, less than or equal to about 7%, less than or equal to about 8%, less than or equal to about 9%, less than or equal to about 10%, less than or equal to about 12%, less than or equal to about 14%, less than or equal to about 16%, less than or equal to about 18%, less than or equal to about 20%, and/or less than or equal to about 30% (e.g., between about 20% and about 30%). In some embodiments, it can be particularly advantageous if the weight percent polymer is between 5% and 15%.

In some embodiments, the reaction of diamine and dianhydride produces an oligomer comprising a repeating unit of at least a diamine and a dianhydride. In some embodiments, the oligomer comprises about 1 repeat unit, about 2 repeat units, less than about 5 repeat units, less than about 10 repeat units, less than about 20 repeat units, less than about 30 repeat units, less than about 40 repeat units, less than about 50 repeat units, less than about 60 repeat units, less than about 80 repeat units, less than about 100 repeat units, or less than about 200 repeat units. In some embodiments, the oligomer has an average degree of polymerization of less than about 10, less than about 20, less than about 30, less than about 40, less than about 60, less than about 80, or less than about 100. In some embodiments, the oligomer comprises terminal anhydride groups, i.e., both ends of the oligomer comprise a terminal anhydride group. In some embodiments, the oligomer comprises terminal amine groups, i.e., both ends of the oligomer comprise a terminal amine group.

In accordance with embodiments, aerogels exhibit ease of production and are cost-effective to produce. For example, samples of an aerogel with dimensions of 3.5″×15″×0.5″ containing intricate features have been produced through both CNC milling and direct molding with a polydimethylsiloxane (PDMS) mold. Both material samples showed very high feature resolution and validated the ease of machining and molding this material to shape, noting that molding may be a cost effective way to produce complex parts from this material in large quantities.

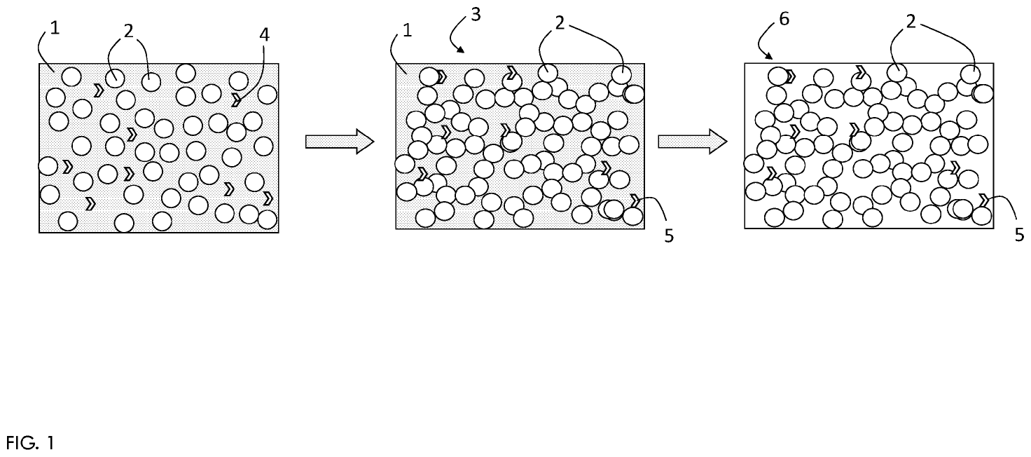

As noted above, certain aspects are related to methods of forming aerogels. One non-limiting example of such a method is shown in FIG. 1.

In some embodiments, the polymer aerogel precursor forms a polymer gel (e.g., a polyimide gel). For example, in the left-hand panel of FIG. 1, solvent 1 contains aerogel precursor 2. Aerogel precursor 2 can gel to form a solid domain within gel 3 shown in the middle panel of FIG. 1, in accordance with some embodiments. In some embodiments, hydrophobe 4 may also be present in the solvent. In some such embodiments, the hydrophobe forms moieties 5 on the gel before, during, and/or after gelation. In certain embodiments, solvent 1 is removed from the gel (e.g., directly, or via one or more transfer solvents) to form aerogel 6 (see, e.g., the right-hand panel in FIG. 1).

In some embodiments, the polymer aerogel precursor forms a polymer gel in a time period of less than or equal to 1 minute, less than or equal to 2 minutes, less than or equal to 3 minutes, less than or equal to 5 minutes, less than or equal to 10 minutes, less than or equal to 15 minutes, less than or equal to 20 minutes, less than or equal to 30 minutes, less than or equal to 45 minutes, less than or equal to 60 minutes, less than or equal to 120 minutes, less than or equal to 180 minutes, less than or equal to 240 minutes, or less than or equal to 300 minutes. In some embodiments, the polymer aerogel precursor forms a polymer gel in a time period of greater than or equal to 0.01 seconds, greater than or equal to 0.1 seconds, or greater than or equal to 1 second.

In some embodiments, the polymer aerogel precursor forms a polymer gel in an environment with a temperature of greater than or equal to −25° C., greater than or equal to −10° C., greater than or equal to 0° C., greater than or equal to 10° C., greater than or equal to 25° C., greater than or equal to 50° C., greater than or equal to 75° C., or greater than or equal to 100° C. In some embodiments, the polymer aerogel precursor forms a polymer gel in an environment with a temperature of less than or equal to 202° C., less than or equal to 150° C., less than or equal to 100° C., less than or equal to 90° C., less than or equal to 80° C., less than or equal to 70° C., less than or equal to 50° C., less than or equal to 40° C., less than or equal to 30° C., less than or equal to 20° C., less than or equal to 10° C., less than or equal to 0° C., or less than or equal to −10° C. In certain embodiments, the temperature of the environment in which the polymer aerogel precursor forms a polymer gel is between the freezing point of the sol and the boiling point of the sol.

In some embodiments, at least a portion (e.g., at least 50 vol %, at least 75 vol %, at least 90 vol %, at least 95 vol %, at least 99 vol %, at least 99.9 vol %, or all) of the liquid in the pores of the gel is exchanged for a transfer solvent. Generally, when used, the transfer solvent is different than the liquid in the pores of the gel. In some embodiments, the transfer solvent is chosen because it is useful or necessary for a chosen drying method that is used to form the aerogel. In some embodiments, the transfer solvent is chosen because it imparts a desired effect on the final aerogel. In some embodiments, the gel is solvent exchanged into an organic solvent. For example, in some embodiments, the pore fluid within the gel is substantially replaced by the organic solvent (e.g., through diffusive soaking in a bath of the transfer organic solvent), after which the gel was subsequently dried via any suitable method for making an aerogel (e.g., described in more detail below).

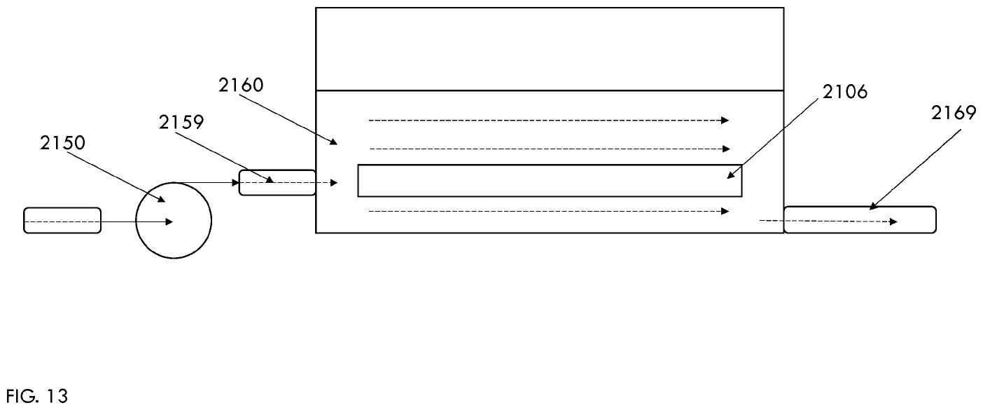

In some embodiments, liquid in the pores of the gel is exchanged for a transfer solvent in a continuous manner. For example, in some embodiments, the liquid in the pores of the gel is exchanged for a transfer solvent by moving the gel through a bath of the transfer solvent (e.g., using countercurrent flow). For example, FIG. 13 schematically depicts pump 2150 continuously pumping liquid through conduit 2159 into bath 2160, within which gel 2106 is located, which refreshes the transfer liquid (e.g., transfer solvent) as the exchanged liquid from the original gel is transported out of conduit 2169 (along with some of the transfer liquid). In some embodiments, the liquid in the pores of the gel is exchanged for a transfer solvent by moving the gel through a series of baths of the transfer solvent. In some embodiments, the liquid in the pores of the gel is considered to be sufficiently exchanged when the purity of the transfer solvent in the pores of the gel is greater than or equal to 10 wt %, greater than or equal to 15 wt %, greater than or equal to 30 wt %, greater than or equal to 50 wt %, greater than or equal to 60 wt %, greater than or equal to 70 wt %, greater than or equal to 80 wt %, greater than or equal to 90 wt %, greater than or equal to 95 wt %, greater than or equal to 99 wt %, greater than or equal to 99.5 wt %, greater than or equal to 99.95 wt %, or greater than or equal to 99.995 wt %. The purity of the transfer solvent in the pores of the gel can be measured using well known characterization methods such as UV spectroscopy or IR spectroscopy.

In some embodiments, the transfer solvent comprises an alcohol, a ketone, a nitrile, an acetate, a pyrrolidone, an alkane, a pentone, dimethyl sulfoxide, and/or liquid carbon dioxide. In some embodiments, the transfer solvent comprises an alcohol (e.g., methanol, ethanol, isopropyl alcohol, and/or tertiary-butyl alcohol), a ketone (e.g., acetone, methyl ethyl ketone, propyl methyl ketone, and/or ethyl ethyl ketone), a nitrile (e.g., acetonitrile), an acetate (e.g., ethyl acetate), a pyrrolidone (e.g., n-methyl-2-pyrrolidone), a pentone, an alkane (e.g., hexane), dimethyl sulfoxide, and/or liquid carbon dioxide. In certain embodiments, it can be particularly advantageous to use tertiary-butyl alcohol as a transfer solvent. In some embodiments, the transfer solvent comprises a hydrophobe. In some embodiments, the transfer solvent is more compatible with a drying method than the liquid in the pores of the gel after the aerogel precursor has gelled. In some embodiments, the transfer solvent is used to purify the liquid in the pores of the gel.

In some embodiments, the transfer solvent is frozen after exchange. In some embodiments, the transfer solvent is frozen in a continuous manner. In some embodiments, the gel is moved through a bath of liquid nitrogen to freeze the transfer solvent. In some embodiments, the gel is moved through a stream of liquid nitrogen to freeze the transfer solvent. In some embodiments, the gel is moved through a stream of cold, dry air to freeze the transfer solvent. In some embodiments, the gel is moved through a stream of carbon dioxide snow to freeze the transfer solvent. In some embodiments, the transfer solvent is frozen in a time period of less than or equal to 24 hours, less than or equal to 20 hours, less than or equal to 15 hours, less than or equal to 10 hours, less than or equal to 5 hours, less than or equal to 4 hours, less than or equal to 3 hours, less than or equal to 2 hours, less than or equal to 1 hour, less than or equal to 30 minutes, less than or equal to 20 minutes, less than or equal to 10 minutes, less than or equal to 5 minutes, less than or equal to 1 minutes, less than or equal to 30 seconds, less than or equal to 5 seconds, or less than or equal to 1 second (and/or, in some embodiments, greater than or equal to 0.01 seconds, greater than or equal to 0.1 seconds, or greater than or equal to 1 second.

In some embodiments, the gel is dried to produce an aerogel. Formation of the aerogel can involve removal of liquid (e.g., the transfer solvent, when used) from the gel. In this context, “removal” does not necessarily require that all of the liquid be removed, and in some cases, there may remain some amount of residual liquid in the aerogel. In certain embodiments, the removal of liquid from the gel to form the aerogel involves removing at least 95 vol %, at least 98 vol %, at least 98.5 vol %, at least 99 vol %, at least 99.9 vol %, at least 99.99 vol %, at least 99.999 vol %, at least 99.9999 vol %, or at least 99.99999 vol % of the liquid from the gel. In some embodiments, the liquid in the pores of the gel is removed by supercritical extraction. In some embodiments, the transfer solvent in the pores of the gel is removed by supercritical extraction. In some embodiments, the liquid in the pores of the gel is first at least partially replaced by carbon dioxide after which the carbon dioxide is then removed from the gel. In some embodiments, the liquid in the pores of the gel is first at least partially replaced by carbon dioxide after which the carbon dioxide is then removed from the gel. In some embodiments the carbon dioxide is removed from the gel via supercritical extraction. In some embodiments, the carbon dioxide is removed from the gel via subcritical extraction.

Aerogel may be fabricated by removing the liquid from a gel in a way that substantially preserves both the porosity and integrity of the gel's intricate nanostructured solid network. For most gels, if the liquid in the gel is evaporated, capillary stresses will arise as the vapor-liquid interface recedes into and/or from the gel, causing the gel to shrink and/or pull inwards on itself, and collapse. The resulting material is a dry, comparatively dense, low-porosity (generally <10% by volume) material that is often referred to as a xerogel, or a solid formed from the gel by drying with unhindered shrinkage. However, the liquid in the gel may instead be heated and pressurized past its critical point, a specific temperature and pressure at which the liquid will transform into a semi-liquid/semi-gas, or supercritical fluid, that exhibits little, if any, surface tension. Below the critical point, the liquid is in equilibrium with a vapor phase. As the system is heated and pressurized towards its critical point, however, molecules in the liquid develop an increasing amount of kinetic energy, moving past each other increasingly fast until eventually their kinetic energy exceeds the intermolecular adhesion forces that give the liquid its cohesion. Simultaneously, the pressure in the vapor also increases, bringing molecules on average closer together until the density of the vapor becomes nearly and/or substantially as dense as the liquid phase. As the system reaches the critical point, the liquid and vapor phases become substantially indistinguishable and merge into a single phase that exhibits a density and thermal conductivity comparable to a liquid, yet is also able to expand and compress in a manner similar to a gas. Although technically a gas, the term supercritical fluid may refer to fluids near but past their critical point as such fluids, due to their density and kinetic energy, exhibit liquid-like properties that are not typically exhibited by ideal gases, for example, the ability to dissolve other substances. Since phase boundaries do not typically exist past the critical point, a supercritical fluid exhibits no surface tension and thus exerts no capillary forces, and can be removed from a gel without causing the gel's solid skeleton to collapse by isothermal depressurization of the fluid. After fluid removal, the resulting dry, low-density, high-porosity material is an aerogel.

The critical point of most substances typically lies at relatively high temperatures and pressures; thus, supercritical drying generally involves heating gels to elevated temperatures and pressures and, hence, is performed in a pressure vessel. For example, if a gel contains ethanol as its pore fluid, the ethanol can be supercritically extracted from the gel by placing the gel in a pressure vessel containing additional ethanol, slowly heating the vessel past the critical temperature of ethanol (241° C.), and allowing the autogenic vapor pressure of the ethanol to pressurize the system past the critical pressure of ethanol (60.6 atm). At these conditions, the vessel can then be quasi-isothermally depressurized so that the ethanol diffuses out of the pores of the gel without recondensing into a liquid. Likewise, if a gel contains a different solvent in its pores, the vessel may be heated and pressurized past the critical point of that solvent. Extraction of organic solvent from a gel generally requires specialized equipment, however, since organic solvents at their critical points can be dangerously flammable and explosive. Instead of supercritically extracting an organic solvent directly from a gel, the liquid in the pores of the gel may instead first be exchanged with a safer, nonflammable liquid, such as carbon dioxide, which is typically miscible with most organic solvents and which has a relatively low critical point of 31.1° C. and 72.9 atm. In some embodiments, instead of first replacing the liquid in the pores of the gel with liquid CO₂ and then performing supercritical extraction of the CO₂, the liquid in a gel may instead be extracted by flowing supercritical CO₂ over the gel. Such so-called supercritical CO₂ drying processes are commonly employed in the manufacture of aerogel materials. In accordance some embodiments described herein, supercritical CO₂ drying may be used to make aerogel.

In some embodiments, the liquid in the pores of the gel is removed by evaporation and/or boiling. In some embodiments, the transfer solvent in the pores of the gel is removed by evaporation and/or boiling. In some embodiments, aerogels may be fabricated by removing the liquid from a gel by evaporative drying of the liquid. In some embodiments, the pore fluid exhibits a sufficiently low surface tension to prevent damaging the gel when evaporated, for example, less than or equal to 20 dynes/cm, less than or equal to 15 dynes/cm, less than or equal to 12 dynes/cm, or less than or equal to 10 dynes/cm, and/or greater than or equal to 0.1 dynes/cm, greater than or equal to 1 dyne/cm, or greater than or equal to 5 dynes/cm. In certain embodiments, the surface tension of the liquid is less than or equal to 20 dynes/cm, less than or equal to 15 dynes/cm, less than or equal to 12 dynes/cm, or less than or equal to 10 dynes/cm, and/or greater than or equal to 0.1 dynes/cm, greater than or equal to 1 dyne/cm, or greater than or equal to 5 dynes/cm. Combinations of these ranges are also possible (e.g., greater than or equal to 5 dynes/cm and less than or equal to 25 dynes/cm). Other ranges are also possible.

In some embodiments, the solvent comprises a carbon atom, a fluorine atom, and an oxygen atom. In some embodiments, Novec™ brand solvents obtainable from 3M® may be particularly well-suited. In some embodiments, the solvent comprises 1-methoxyheptafluoropropane (e.g., Novec 7000), methoxynonafluorobutane (e.g., Novec 7100), ethoxynonafluorobutane (e.g., Novec 7200), 3-methoxy-4-trifluoromethyldecafluoropentane (e.g., Novec 7300), 2-trifluoromethyl-3-ethoxydodecafluorohexane (e.g., Novec 7500), 1,1,1,2,3,3-hexafluoro-4-(1,1,2,3,3,3-hexafluoropropoxy)-pentane (e.g., Novec 7600), 2,3,3,4,4-pentafluorotetrahydro-5-methoxy-2,5-bis[1,2,2,2-tetrafluoro-1-(trifluoromethyl)ethyl]-furan (Novec 7700), a fluorinated ketone such as CF₃CF₂C(═O)CF(CF₃)₂ dodecafluoro-2-methylpentan-3-one (e.g., Novec 1230/649), tetradecafluoro-2-methylhexan-3-one/tetradecafluoro-2,4-dimethylpentan-3-one (e.g., Novec 774), a fluorinated ether, tetradecafluorohexane/perfluoropentane/perfluorobutane (e.g., Fluorinert FC-72), a fluorinated hydrocarbon such as 2,3-dihydrodecafluoropentane (e.g., Vertrel® XF), or any other appropriate organic solvent that includes fluorine. In some embodiments, it can be particularly advantageous if the pore fluid selected for evaporative drying is methoxynonafluorobutane (e.g., Novec 7100). In some embodiments, it can be particularly advantageous if the pore fluid selected for evaporative drying is ethoxynonafluorobutane (e.g., Novec 7200).

In some embodiments, the pore liquid is evaporated at room temperature. In some embodiments, it can be particularly advantageous if the pore liquid is evaporated in an atmosphere of dry air (i.e., substantially water-free), nitrogen, and/or another substantially water-free inert gas. In some embodiments, it can be particularly advantageous if the pore fluid selected for evaporative drying is carbon dioxide at a temperature below its critical temperature and pressure of approximately 31.1° C. and 72.8 atm (1071 psi). In one such embodiment, the gel is evaporatively dried from liquid carbon dioxide at a temperature of approximately 28° C. and a pressure of about 68.0 atm (1000 psi).

In some embodiments, aerogel may be fabricated from a gel by sublimation of a frozen pore fluid rather than evaporation of liquid-phase pore fluid. The pore fluid may be suitably frozen and sublimated with little to no capillary force, resulting in a gel that includes frozen pore fluid. That is, rather than removing the solvent via evaporation from a liquid state, the solvent can be sublimated from a solid state (having been frozen), hence, minimizing capillary forces that may otherwise result via evaporation. In some embodiments, the sublimation of the frozen pore fluid is performed under vacuum, or partial vacuum conditions, e.g., lyophilization. In some embodiments, the liquid in the pores of the gel is removed by freeze drying under vacuum. In some embodiments, the transfer solvent in the pores of the gel is removed by freeze drying under vacuum. In some embodiments, the sublimation of the frozen pore fluid is performed at atmospheric pressure. In some embodiments, the liquid in the pores of the gel is removed by freeze drying at or above atmospheric pressure. In some embodiments, the transfer solvent in the pores of the gel is removed by freeze drying at or above atmospheric pressure. In some embodiments, the method includes providing a gel having a solvent located within pores of the gel, freezing the solvent within the pores of the gel, and sublimating the solvent (e.g., at ambient conditions) to remove the solvent from the pores of the gel to produce an aerogel. In some embodiments, the sublimation of the solvent is performed in air, nitrogen, and/or another inert gas. In some such embodiments, the gas is substantially water free (e.g., it contains water in an amount of 0 wt % to 1 wt %, 0 wt % to 0.1 wt %, 0 wt % to 0.01 wt %, 0 wt % to 0.001 wt %, 0 wt % to 0.0001 wt %, 0 wt % to 0.00001 wt %, 0 wt % to 0.000001 wt %, 0 wt % to 0.0000001 wt %, or at 0 wt %). In some embodiments, it can be particularly advantageous if the pore fluid selected for this process is tert-butanol. Examples of techniques that can be used to dry aerogels that involve sublimation are described, for example, in International Patent Application Publication No. WO 2016/127084, published Aug. 11, 2016, and entitled “Systems and Methods for Producing Aerogel Material,” which is incorporated herein by reference in its entirety for all purposes.

In some embodiments, the liquid in the pores of the gel is removed in a continuous manner. In some embodiments, the transfer solvent in the pores of the gel is removed in a continuous manner. In some embodiments, the gel is moved on a moving object (e.g., a conveyor belt) through a chamber (e.g., a chamber controlled to a specific temperature and pressure) where the liquid in the pores of the gel is removed.

In some embodiments, the temperature of the environment in which the liquid is removed from the gel (e.g., in the chamber) is controlled to less than or equal to 25° C., less than or equal to 20° C., less than or equal to 15° C., less than or equal to 10° C., less than or equal to 5° C., less than or equal to 0° C., less than or equal to −5° C., less than or equal to −10° C., less than or equal to −15° C., less than or equal to −20° C., less than or equal to −25° C., or less than or equal to −30° C. In some embodiments (e.g., in certain embodiments in which freeze drying is used to remove the solvent), the temperature of the environment in which the liquid is removed (e.g., in the chamber) can be below the freezing point of the liquid within the gel. In some embodiments (e.g., in certain embodiments in which supercritical drying is used to remove the solvent), the temperature of the environment in which the liquid is removed (e.g., in the chamber) can be above the critical point of the liquid within the gel. In some embodiments (e.g., in certain embodiments in which ambient atmosphere drying is used to remove the solvent), the temperature of the environment in which the liquid is removed can be the temperature of the ambient environment (e.g., between 15° C. and 30° C., or between 20° C. and 25° C.).

In some embodiments, the pressure of the environment in which the liquid is removed from the gel is ambient pressure. For example, in some embodiments, the pressure of the environment in which the liquid is removed from the gel is 0.9 atmospheres to 1.1 atmospheres (absolute). In some embodiments, the pressure of the environment in which the liquid is removed from the gel (e.g., in the chamber) is higher than ambient pressure. In some embodiments, the pressure of the environment in which the liquid is removed from the gel (e.g., in the chamber) is lower than ambient pressure.

In some embodiments, the period of time over which liquid is removed from the gel to form the aerogel (e.g., the period of time in the chamber) is greater than or equal to 1 second, greater than or equal to 10 seconds, greater than or equal to 30 seconds, greater than or equal to 1 minute, greater than or equal to 2 minutes, greater than or equal to 3 minutes, greater than or equal to 5 minutes, greater than or equal to 10 minutes, greater than or equal to 20 minutes, greater than or equal to 30 minutes, greater than or equal to 1 hour, greater than or equal to 2 hours, greater than or equal to 3 hours, greater than or equal to 4 hours, greater than or equal to 5 hours, greater than or equal to 6 hours, greater than or equal to 7 hours, greater than or equal to 8 hours, greater than or equal to 9 hours, or greater than or equal to 10 hours (and/or, in some embodiments, as much as 24 hours, as much as 48 hours, as much as 7 days, as much as 21 days, or longer).

In some embodiments, evaporation of the liquid to form the aerogel may occur at atmospheric or ambient conditions (e.g., with or without a stream of gas flowing along the surface of the gel), thus, not requiring the use of a pressure vessel to remove the liquid. Ambient conditions may include ambient pressure conditions and ambient temperature conditions including temperatures near room temperature, e.g., about 0-50° C. Those of ordinary skill in the art would understand that ambient pressure corresponds to the pressure of the ambient environment, within the normal variations caused by elevation and/or barometric pressure fluctuations in normal operations under various weather conditions and locations of installation. Ambient pressure conditions may be distinguished from gage pressure conditions, in which the pressure (e.g., in a vacuum chamber, pressure vessel, or other enclosure in which pressure can be controlled) is described in terms of pressure relative to the ambient pressure (e.g., from a pressure measurement from a gauge or sensor). Because such manufacturing processes in accordance with certain embodiments of the present disclosure do not require a pressure vessel, the size of the resulting aerogel is not limited by the size of a pressure vessel chamber. In some embodiments, evaporation of liquid from the gel may result in an aerogel material in a matter of hours or minutes. Because such manufacturing processes in accordance with certain embodiments of the present disclosure are relatively fast, aerogel materials such as boards, panels, blankets, and thin films may be manufactured in a continuous fashion as opposed to a batch fashion as typically imposed when supercritical drying or freeze drying. Depending on the type of liquid that is evaporated from the gel, such aerogel manufacture may also occur without risk of flammability or combustion.

In some embodiments, liquid is removed from the gel by simply exposing the gel to ambient atmosphere (with or without a flow of gas). In some embodiments, the liquid is removed under a flow of gas. In some embodiments, it can be particularly advantageous if the gas is substantially dry. In some embodiments, the gas comprises dry air. In some embodiments, the gas comprises nitrogen. In some embodiments, the gas comprises carbon dioxide. In some embodiments, the flow rate of the gas is at least 10, at least 100, at least 1000, or at least 10,000 (and/or, up to 100,000, up to 1,000,000, or more) standard liters per minute (SLM) per square meter of exposed gel envelope surface area. In some embodiments, the liquid is removed at a rate of at least 10, at least 50, at least 100, at least 150, at least 200, at least 500, or at least 1000 grams per hour per square meter of exposed gel envelope surface area.

Examples of techniques that can be used to evaporatively dry aerogels are described, for example, in International Patent Application Publication No. WO 2016/161123, published Oct. 6, 2016, and entitled “Aerogel Materials and Methods for Their Production,” which is incorporated herein by reference in its entirety for all purposes.

In some embodiments, a solvent is used. The solvents can be used in the original gel formulation or as a transfer solvent (i.e., a solvent that replaces a solvent already present in the gel). Any of a variety of suitable solvents can be used. In some embodiments the solvent comprises dimethylsulfoxide; diethylsulfoxide; N,N-dimethylformamide; N,N-diethylformamide; N,N-dimethylacetamide; N,N-diethylacetamide; N-methyl-2-pyrrolidone; 1-methyl-2-pyrrolidinone; N-cyclohexyl-2-imidazolidinone; diethylene glycol dimethoxyether; o-dichlorobenzene; phenols; cresols; xylenol; catechol; butyrolactones; acetone; methyl ethyl ketone; ethyl ethyl ketone; methyl propyl ketone; acetonitrile; ethyl acetate; and/or hexamethylphosphoramides. In some embodiments, it can be particularly advantageous if the solvent comprises N-methyl-2-pyrrolidone.

In some embodiments in which drying of the gel to form the aerogel involves evaporative drying, it can be particularly advantageous to use a low surface tension solvent as a transfer solvent. In certain embodiments in which supercritical drying of the gel is used to produce the aerogel, it can be particularly advantageous to use CO₂, ethanol, methanol, acetone, or acetonitrile as a transfer solvent. In some embodiments in which drying of the gel to form the aerogel involves atmospheric pressure freeze drying, it can be particularly advantageous to use tert-butanol, water, or other freeze drying solvents as a transfer solvent (with tert-butanol being particularly advantageous, in certain cases).

In some embodiments, multiple solvent exchange processes are used to form the aerogel from the gel.

As noted above, the gel within the gel can be formed via gelation. The gelation can comprise, in certain embodiments, polymerization and/or cross-linking (and, typically, both) of aerogel precursor material. The selection of pre-polymer material and cross-linking agent generally depends on the type of aerogel material being formed. Examples for different aerogel materials are provided below.

In some embodiments, the aerogel comprises a polyurea aerogel. For example, in some embodiments, at least 25 wt %, at least 50 wt %, at least 75 wt %, at least 90 wt %, at least 95 wt %, at least 98 wt %, at least 99 wt %, at least 99.9 wt %, or all of the aerogel is made of polyurea. The polyurea can be derived, in some embodiments, from the reaction of an isocyanate with water, in which amines are formed in situ. In some embodiments, the polyurea is derived from the reaction of an isocyanate with an amine. Fabrication of polyurea aerogels is described, for example, in U.S. Pat. No. 10,301,445, issued on May 28, 2019, and entitled “Three-Dimensional Porous Polyurea Networks and Methods of Manufacture,” which is incorporated herein by reference in its entirety for all purposes. In some embodiments, isocyanate can react with amine to form an isocyanate, and then an isocyanate can react with water to form a urea and then isocyanurate monomer.

In some embodiments, the aerogel comprises a polyurethane aerogel. For example, in some embodiments, at least 25 wt %, at least 50 wt %, at least 75 wt %, at least 90 wt %, at least 95 wt %, at least 98 wt %, at least 99 wt %, at least 99.9 wt %, or all of the aerogel is made of polyurethane. The polyurethane can be derived, in some embodiments, from the reaction of an isocyanate and polyol. Fabrication of polyurethane aerogels is described, for example, in U.S. Pat. No. 8,927,079, issued on Jan. 6, 2015, and entitled “Porous Polyurethane Networks and Methods of Preparation,” which is incorporated herein by reference in its entirety for all purposes.

In some embodiments, the aerogel comprises a polyimide aerogel. For example, in some embodiments, at least 25 wt %, at least 50 wt %, at least 75 wt %, at least 90 wt %, at least 95 wt %, at least 98 wt %, at least 99 wt %, at least 99.9 wt %, or all of the aerogel is made of polyimide. The polyimide can be derived, in some embodiments, from the reaction of a dianhydride with a diisocyanate. Fabrication of polyimide aerogels is described, for example, in U.S. Pat. No. 9,745,198, issued on Aug. 29, 2017, and entitled “Porous Nanostructured Polyimide Networks and Methods of Manufacture,” which is incorporated herein by reference in its entirety for all purposes.

In some embodiments, the aerogel comprises a polyamide aerogel. For example, in some embodiments, at least 25 wt %, at least 50 wt %, at least 75 wt %, at least 90 wt %, at least 95 wt %, at least 98 wt %, at least 99 wt %, at least 99.9 wt %, or all of the aerogel is made of polyamide. The polyamide can be derived, in some embodiments, from the reaction of an amine and a carboxyl group. Polyamide can be derived, in some embodiments, from the reaction of an amine and an acyl chloride.

In some embodiments, the aerogel comprises a polyisocyanurate aerogel. For example, in some embodiments, at least 25 wt %, at least 50 wt %, at least 75 wt %, at least 90 wt %, at least 95 wt %, at least 98 wt %, at least 99 wt %, at least 99.9 wt %, or all of the aerogel is made of polyisocyanurate. Polyisocyanurate can be derived from the reaction of methylene diphenyl diisocyanate and polyol.

In some embodiments, the aerogel comprises a polyester aerogel. For example, in some embodiments, at least 25 wt %, at least 50 wt %, at least 75 wt %, at least 90 wt %, at least 95 wt %, at least 98 wt %, at least 99 wt %, at least 99.9 wt %, or all of the aerogel is made of polyester. Polyester can be derived, in some embodiments, from the reaction of acids and alcohols. In certain embodiments, polyester is derived from the alcoholysis and/or acidolysis of low-molecular weight esters. In some embodiments, polyester is derived from alcoholysis of acyl chlorides.

Generally speaking, aerogels are dry, highly porous, solid-phase materials that may exhibit a diverse array of extreme and valuable materials properties, e.g., low density, low thermal conductivity, high density-normalized strength and stiffness, and/or high specific internal surface area. In some embodiments, the pores within an aerogel material are less than or equal to 100 nm in diameter, while in some embodiments, the diameter of the pores within an aerogel material fall between 2-50 nm in diameter, i.e., the aerogel is mesoporous. In some embodiments, aerogels may contain pores with diameters greater than 100 nm, and in some embodiments, aerogels may even contain pores with diameters of several microns. In some embodiments, at least 50%, at least 60%, at least 70%, at least 80%, at least 90%, at least 95%, at least 99%, or more of the pore volume is made up of pores having diameters of less than or equal to 100 nm. In some embodiments, at least 50%, at least 60%, at least 70%, at least 80%, at least 90%, at least 95%, at least 99%, or more of the pore volume is made up of pores having diameters of less than or equal to 50 nm. In some embodiments, it can be particularly advantageous if at least 50%, at least 60%, at least 70%, at least 80%, at least 90%, at least 95%, at least 99%, or more of the pore volume is made up of pores having diameters of less than or equal to 25 nm. In some embodiments, an aerogel may contain a monomodal distribution of pores, a bimodal distribution of pores, or a polymodal distribution of pores.

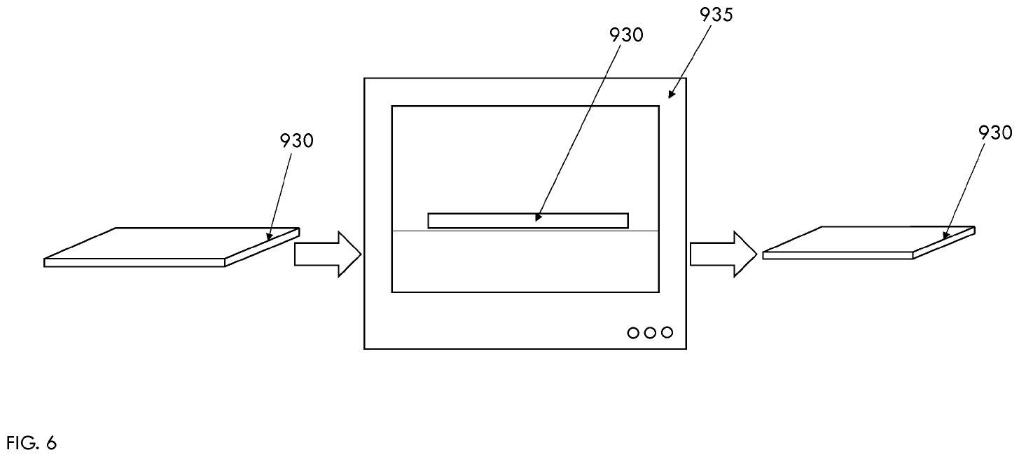

In some embodiments, the aerogels described herein are capable of performing in high-temperature applications. Testing of the performance of aerogels at high temperatures can be conducted by analyzing the thermal performance of the aerogel when it is subjected to what is referred to herein as a “standard heating cycle.” As used herein, a “standard heating cycle” involves transfer of an object from (1) a steel plate at 25° C. in an air environment at 25° C. and 1 atm pressure, where the object is at a uniform temperature of 25° C. (also referred to herein as “starting low-temperature conditions”), to (2) for 60 minutes, an air environment over a steel plate, the steel plate and the air being at a specified elevated temperature, and the air environment being sufficiently large that its size does not impact heat transfer rates, then back to (3) starting low-temperature conditions until the object is cooled to a uniform temperature of 25° C. FIG. 6 shows, schematically, this process for an aerogel. In FIG. 6, aerogel 930 is transferred from a steel plate at 25° C. in an air environment at 25° C. and 1 atm pressure (left), to an air environment over a steel plate within oven 935 for 60 minutes (middle), and then back to starting low-temperature conditions until aerogel 935 is cooled to a uniform temperature of 25° C. (right).

In some embodiments, the aerogels described herein are capable of withstanding dimensional change at 200° C., which is a temperature that is indicative of the upper end of the operating temperature range for many high-temperature applications, such as engine cover applications, and is also a point at which native polymer aerogels, such as polyimide aerogels, often begin to show obvious dimensional change due to temperature. For example, in some embodiments, the aerogels described herein can be subjected to a standard heating cycle in which the elevated temperature is 200° C. (or 250° C., 300° C., or 350° C.) and no dimension of the aerogel changes by more than 10% (or, in some embodiments, more than 5%, more than 2%, more than 1%, or more than 0.1%).

In some embodiments, the aerogel has desirable materials properties for engineering applications. In some embodiments, the aerogel is capable of operating at temperatures of at least 100° C., at least 200° C., at least 250° C., at least 300° C., at least 325° C., and/or at least 350° C. In some embodiments, the aerogel does not ignite in air at any temperature below 100° C., at any temperature below 200° C., at any temperature below 250° C., at any temperature below 300° C., at any temperature below 325° C., or at any temperature below 350° C. In some embodiments, for at least one dimension of the aerogel, the dimension does not change by more than 20%, by more than 10%, by more than 5%, or by more than 2% at any temperature below 100° C., at any temperature below 200° C., at any temperature below 250° C., at any temperature below 300° C., at any temperature below 325° C., or at any temperature below 350° C.

In some embodiments, when the aerogel is subjected to a standard heating cycle in which the elevated temperature is 200° C. (or to a temperature of 250° C., 300° C., or 350° C.) at least one (or at least two, or all three) dimensions of the aerogel fall within 50%, within 30%, within 20%, within 10%, within 5%, or within 3% (and/or, in some embodiments, down to within 1%, within 0.1%, within 0.01%, or less) of the dimensions of the aerogel prior to the standard heating cycle.

In some embodiments, the aerogel undergoes irreversible one-time linear shrinkage of less than or equal to 20%, less than or equal to 15%, less than or equal to 10%, or less than or equal to 5% (and/or, as little as 0%) when exposed to flame for two cycles.

In some embodiments, when the aerogel is exposed to its maximum operating temperature for the first time, the aerogel undergoes irreversible one-time linear shrinkage of less than or equal to 20%, less than or equal to 15%, less than or equal to 10%, or less than or equal to 5% (and/or, as little as 0%). In some embodiments, when the aerogel is subjected to a standard heating cycle having an elevated temperature of 200° C. (or an elevated temperature of 250° C., 300° C., 325° C., 350° C., or its maximum operating temperature), the aerogel undergoes irreversible one-time linear shrinkage of at least one dimension (or of at least two dimensions, or of all three dimensions) of less than or equal to 20%, less than or equal to 15%, less than or equal to 10%, or less than or equal to 5% (and/or, as little as 0%) relative to the dimension prior to the standard heating cycle. In some embodiments, when the aerogel is subjected to two standard heating cycles having an elevated temperature of 200° C. (or an elevated temperature of 250° C., 300° C., 325° C., 350° C., or its maximum operating temperature), the aerogel undergoes irreversible one-time linear shrinkage of at least one dimension (or of at least two dimensions, or of all three dimensions) of less than or equal to 20%, less than or equal to 15%, less than or equal to 10%, or less than or equal to 5% (and/or, as little as 0%) relative to the dimension prior to the standard heating cycle. As is well known, objects in three-dimensional space exhibit three orthogonal dimensions length, width, and height. Linear shrinkage generally corresponds to the percent change in one of the three orthogonal dimensions following a treatment of the object under given conditions comparing the same dimensional axis before and after treatment.

In some embodiments, when the aerogel is subjected to a standard heating cycle having an elevated temperature of 200° C. (or a temperature of 250° C., 300° C., 325° C., 350° C., or its maximum operating temperature), the BET surface area of the aerogel is greater than or equal to 10 m²/g, greater than or equal to 20 m²/g, greater than or equal to 40 m²/g, greater than or equal to 60 m²/g greater than or equal to 80 m²/g, greater than or equal to 100 m²/g, greater than or equal to 150 m²/g, greater than or equal to 200 m²/g, greater than or equal to 250 m²/g, greater than or equal to 300 m²/g, greater than or equal to 350 m²/g, greater than or equal to 400 m²/g, greater than or equal to 600 m²/g, or greater than or equal to 800 m²/g (and/or, in some embodiments, as much as 2,000 m²/g; as much as 4,000 m²/g, as much as 8,000 m²/g, or more).

In some embodiments, when the aerogel is subjected to a standard heating cycle having an elevated temperature of 200° C. (or a temperature of 250° C., 300° C., 325° C., 350° C., or its maximum operating temperature), the flatness of the aerogel changes by less than or equal to 10%, less than or equal to 9%, less than or equal to 8%, less than or equal to 7%, less than or equal to 6%, less than or equal to 5%, less than or equal to 4%, less than or equal to 3% less than or equal to 2%, or less than or equal to 1% (and/or, in some embodiments, as little as 0%) relative to its initial flatness.

In some embodiments, when the aerogel is subjected to a standard heating cycle having an elevated temperature of 200° C. (or a temperature of 250° C., 300° C., 325° C., 350° C., or its maximum operating temperature), the thickness of the aerogel changes by less than or equal to 10%, less than or equal to 9%, less than or equal to 8%, less than or equal to 7%, less than or equal to 6%, less than or equal to 5%, less than or equal to 4%, less than or equal to 3% less than or equal to 2%, or less than or equal to 1% (and/or, in some embodiments, as little as 0%) relative to its initial thickness.

As used herein, the phrase “maximum operating temperature” refers to the highest temperature at which an article is designed to operate for extended periods of time with acceptable stability in its mechanical and thermal properties. The maximum operating temperature is usually a temperature above which the article undergoes substantial chemical and/or mechanical degradation. Examples of chemical degradation include denaturing, decomposition, phase change, and ignition. Examples of mechanical degradation include mechanical warping, falling apart, and the like. In some embodiments, the maximum operating temperature is set by a loss of surface area of greater than or equal to 90%, greater than or equal to 80%, greater than or equal to 70%, greater than or equal to 60%, greater than or equal to 50%, greater than or equal to 40%, greater than or equal to 30%, greater than or equal to 20%, greater than or equal to 10%, greater than or equal to 5%, or greater than or equal to 1%. In some embodiments, it can be particularly advantageous if the maximum operating temperature is set by a loss of surface area of greater than or equal to 40%.

In some embodiments, the mechanical degradation temperature refers to the temperature above which the article falls apart. In some embodiments, the ignition temperature refers to the temperature above which the article ignites (i.e., catches on fire) in air. In some embodiments, the chemical degradation temperature refers to the temperature above which the article continues to lose mass even once reaching thermal equilibrium.

In some embodiments, the aerogel undergoes irreversible one-time linear shrinkage of less than or equal to 20%, less than or equal to 15%, less than or equal to 10%, or less than or equal to 5% when contacted with a 1.5″ Bunsen burner flame. Irreversible one-time linear shrinkage according to this test can be determined by taking an aerogel initially at a temperature of 25° C., contacting the aerogel with a 1.5″ Bunsen burner flame, transferring the aerogel back into an environment at 25° C. and 1 atm pressure of air and allowing it to cool until the aerogel reaches a temperature of 25° C., measuring the dimensions of the aerogel, contacting the aerogel to the same flame in the same manner again, transferring the aerogel back into an environment at 25° C. and 1 atm pressure of air and allowing it to cool until the aerogel reaches a temperature of 25° C., measuring the dimensions of the aerogel, and comparing the dimensions of the aerogel after the second contact with the flame to the dimensions measured after the initial contact with the flame. In some embodiments, the dimensions of the aerogel after the second contact with the flame are within 5%, within 4%, within 3%, within 2%, or within 1% of the dimensions of the aerogel after the first contact with the flame.

In some embodiments, the aerogel is nonflammable. Non-flammability generally refers to the ability of the aerogel to meet the criteria of a burn certification. In some embodiments, the aerogel meets the criteria for flame time, drip flame time, and/or burn length set forth in Part 25.853a of the United States Federal Aviation Regulations. In some embodiments, the aerogel meets the criteria for Class A1, Class A2, and/or Class B fire behavior of the European classification standard EN 13501-1.

In some embodiments, the aerogel exhibits low flammability upon contact with flame. In some embodiments, when subjected to a vertical burn test above a Bunsen burner burning propane, the aerogel is nonflammable.

In certain embodiments, the aerogel is capable of passing a vertical burn test based on the procedures described in section 25.853 of the United States Federal Aviation Regulations (FAR) burn requirements for aviation interiors, modified as follows: The sample to be used for the test is 2.5 inches in width by 3.5 inches in height by 0.25 inches in thickness; the sample is prepared by conditioning at 50% relative humidity and 70° F. (21.1° C.); the flame source is a Bunsen burner using propane fuel, adjusted to a 1.5 inch flame height; the sample is hung with the shorter 2.5 inch edge 0.75 inches from the top of the Bunsen burner flame such that the 3.5 inch edge is vertical (i.e., parallel to the force of gravity); the flame is applied to the sample for a period of 1 minute and then removed. In some embodiments, the sample, when tested in this manner, will self-extinguish in less than or equal to 1 second after removal of the flame. In some embodiments, the aerogel samples will not substantially burn or sustain flame at any point, but rather, will char in the presence of the flame.

In certain embodiments, the aerogel can have water-resistant properties.

In some embodiments, the aerogel may exhibit hydrophobicity. The term hydrophobicity refers to the absence and/or partial absence of attractive force between a material and a mass of water. The hydrophobicity of a bulk material generally refers to this behavior as it applies to an external surface of the bulk material. The apparent hydrophobicity of an external surface (e.g., a textured external surface) can be, in some cases, higher than the hydrophobicity of the bulk material.

Hydrophobicity of an aerogel can be expressed in terms of the liquid water uptake. The term liquid water uptake refers to the ability of a material or composition to absorb, adsorb, or otherwise retain water due to contact with water in the liquid state. Liquid water uptake can be expressed one of several ways, for example, as a fraction or percent of the open pore volume or envelope volume of the aerogel, or as a fraction or percent relative to the mass of the unwetted aerogel. The liquid water uptake reported is understood to be a measurement undertaken under specific conditions. A material that has superior or improved liquid water uptake relative to a different material is understood to have a lower uptake of liquid water.

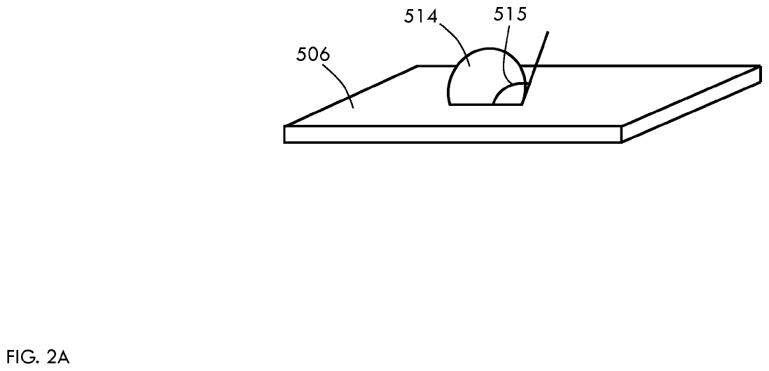

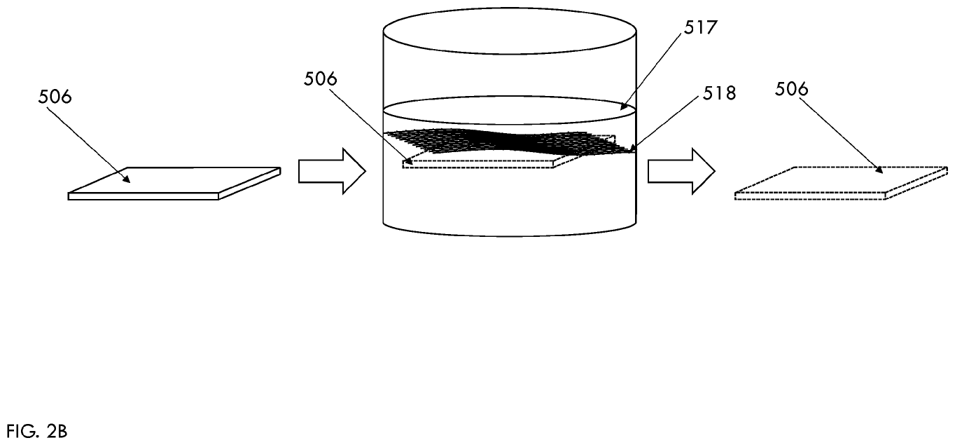

It may be beneficial to measure the uptake of water of an aerogel. This may be achieved by submerging the aerogel in water. By way of illustration, FIG. 2B schematically shows aerogel 506 submerged in water 517. A submerged aerogel 506 may then uptake (or not uptake) water over a period of time (e.g., 24 hours). A mesh 518 can be used to keep the aerogel submerged in water during the duration of time. After submerging, the aerogel can be recovered, as shown in FIG. 2B as a recovered aerogel 506. The recovered aerogel can then be compared (e.g., a weight comparison) to aerogel 506 prior to submersion. In some embodiments, when the aerogel is submerged under water at 25° C. for 24 hours, the aerogel uptakes a mass of water within its outer boundaries of less than or equal to 200 wt %, less than or equal to 150 wt %, less than or equal to 100 wt %, less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 10 wt %, less than or equal to 5 wt %, less than or equal to 4 wt %, less than or equal to 3 wt %, less than or equal to 2 wt %, less than or equal to 1 wt %, or less than or equal to 0.1 wt % (and/or, in some embodiments, as little as 0.01 wt %, as little as 0.001 wt %, as little as 0.0001 wt %, or less) relative to the dry mass of the aerogel prior to submerging the aerogel in the water. In some embodiments, the aerogel exhibits any of these properties after being subjected to a standard heating cycle in which the elevated temperature is 200° C. (or 250° C., 300° C., or 350° C.).

In some embodiments, the liquid water uptake of the aerogel may be less than or equal to 200 wt %, less than or equal to 150 wt %, less than or equal to 100 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 10 wt %, less than or equal to 5 wt %, less than or equal to 4 wt %, less than or equal to 3 wt %, less than or equal to 2 wt %, less than or equal to 1 wt %, or less than or equal to 0.1 wt % (and/or, in some embodiments, as little as 0.01 wt %, as little as 0.001 wt %, as little as 0.0001 wt %, or less) relative to the weight of the aerogel before contact with liquid water when measured according to standard ASTM C1511. In some embodiments, the aerogel exhibits any of these properties after being subjected to a standard heating cycle in which the elevated temperature is 200° C. (or 250° C., 300° C., or 350° C.).

In some embodiments, the liquid water uptake of the aerogel may be less than or equal to 200 wt %, less than or equal to 150 wt %, less than or equal to 100 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 10 wt %, less than or equal to 5 wt %, less than or equal to 4 wt %, less than or equal to 3 wt %, less than or equal to 2 wt %, less than or equal to 1 wt %, or less than or equal to 0.1 wt % (and/or, in some embodiments, as little as 0.01 wt %, as little as 0.001 wt %, as little as 0.0001 wt %, or less) relative to the weight of the aerogel before contact with liquid water when measured according to standard ASTM C1763. In some embodiments, the aerogel exhibits any of these properties after being subjected to a standard heating cycle in which the elevated temperature is 200° C. (or 250° C., 300° C., or 350° C.).

In some embodiments, the liquid water uptake of the aerogel may be less than or equal to 200 wt %, less than or equal to 150 wt %, less than or equal to 100 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 10 wt %, less than or equal to 5 wt %, less than or equal to 4 wt %, less than or equal to 3 wt %, less than or equal to 2 wt %, less than or equal to 1 wt %, or less than or equal to 0.1 wt % (and/or, in some embodiments, as little as 0.01 wt %, as little as 0.001 wt %, as little as 0.0001 wt %, or less) relative to the weight of the aerogel before contact with liquid water when measured according to standard EN 1609. In some embodiments, the aerogel exhibits any of these properties after being subjected to a standard heating cycle in which the elevated temperature is 200° C. (or 250° C., 300° C., or 350° C.).

Hydrophobicity of an aerogel can also be expressed in terms of the water vapor uptake. The term water vapor uptake refers to the ability for a material or composition to absorb, adsorb, or otherwise retain water due to contact with water in the vapor state. Water vapor uptake can be expressed as a fraction or percent of water retained relative to the mass of the article before exposure to water vapor. The water vapor uptake reported is understood to be a measurement undertaken under specific conditions. An article which has superior or improved water vapor uptake relative to a different material is understood to have a lower sorption or retention of water vapor. In some embodiments, the water vapor uptake of the aerogel may be less than or equal to 100 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 10 wt %, less than or equal to 5 wt %, less than or equal to 4 wt %, less than or equal to 3 wt %, less than or equal to 2 wt %, less than or equal to 1 wt %, or less than or equal to 0.1 wt % (and/or, in some embodiments, as little as 0.01 wt %, as little as 0.001 wt %, as little as 0.0001 wt %, or less) relative to the weight of the aerogel before exposure to water vapor, when measured according to standard ASTM C1104. In some embodiments, the aerogel exhibits any of these properties after being subjected to a standard heating cycle in which the elevated temperature is 200° C. (or 250° C., 300° C., or 350° C.).

Hydrophobicity of an aerogel can also be expressed in terms of the water contact angle. The term water contact angle refers to the equilibrium contact angle of a drop of water in contact with an external surface of the material. A material that has superior or improved hydrophobicity relative to a different material generally has a higher water contact angle. For example, in FIG. 2A, aerogel 506 has a water droplet 514 on its surface, and contact angle 515 is shown. In some embodiments, the water contact angle of the aerogel may be greater than 90°, greater than 100°, greater than 110°, greater than 120°, greater than 130°, greater than 140°, greater than 150°, greater than 160°, greater than 1700 (and/or, in some embodiments, up to 175°, up to 178°, up to 179°, up to 179.9°, or greater) when measured according to standard ASTM D7490. In some embodiments, particularly advantageous aerogels exhibit a contact angle with water, in an ambient air environment at 1 atm and 25° C., of greater than 90°, greater than 100°, greater than 110°, greater than 120°, greater than 130°, greater than 140°, greater than 150°, greater than 160°, greater than 1700 (and/or, in some embodiments, up to 175°, up to 178°, up to 179°, up to 179.9°, or greater) when measured according to standard ASTM D7490. In some embodiments, the aerogel exhibits any of these properties after being subjected to a standard heating cycle in which the elevated temperature is 200° C. (or 250° C., 300° C., or 350° C.).

In accordance with certain embodiments, the hydrophobic aerogel does not contain any fluorine or contains only a limited amount of fluorine (e.g., the amount of fluorine in the aerogel is 0-0.1 wt %, 0-0.01 wt %, or 0-0.001 wt %).

In some embodiments, the aerogel is surfactant resistant. In some embodiments, the aerogel is launderable. In some embodiments, the aerogel has a relatively low detergent uptake. Detergent uptake can be determined according to the following test. 0.97 g of sodium dodecyl sulfate is added to 1 liter of analytical reagent grade deionized (DI) water and dissolved to make a detergent solution. 50 mL of the detergent solution is added to a 1.5-inch tall by 3-inch wide cylindrical vial. A sample of the aerogel that is 1 cm×1 cm×2 mm is prepared and added to the vial. Wire mesh is press fit into the vial such that the sample remains totally submerged for 24 hours at 20° C. The sample is then removed from the detergent solution, and the surface liquid is mechanically removed. The sample is then weighed. The difference in mass between the sample after the test and before the test is the detergent uptake, and it is generally expressed as a percentage increase in mass relative to the original mass of the sample. In some embodiments, the aerogel exhibits a detergent uptake, according to this test, of less than or equal to 300%, less than or equal to 200%, less than or equal to 100%, less than or equal to 50%, less than or equal to 10%, less than or equal to 5%, less than or equal to 1% (and/or, as little as 0.1%, at little as 0.01%, as little as 0.001%, or less).

In certain embodiments, the aerogel can have a desirable bulk density. The bulk density of an aerogel may be determined by dimensional analysis. For example, bulk density may be measured by first carefully machining a specimen into a regular shape, e.g., a block or a rod. The length, width, and thickness (or length and diameter) may be measured using calipers (accuracy ±0.001″). These measurements may then be used to calculate the specimen volume by, in the case of a block, multiplying length*width*height, or in the case of a disc, multiplying the height*the radius squared*pi. Mass may be measured using a digital analytical balance with a precision of 0.001 g. Bulk density may then be calculated as density=mass/volume. In some embodiments, the bulk density of the aerogel may be greater than or equal to 0.01 g/cc, greater than or equal to 0.05 g/cc, greater than or equal to 0.1 g/cc, greater than or equal to 0.2 g/cc, greater than or equal to 0.3 g/cc, greater than or equal to 0.4 g/cc, greater than or equal to 0.5 g/cc, greater than or equal to 0.6 g/cc, greater than or equal to 0.7 g/cc, or less than or equal to 0.8 g/cc (and/or, in some embodiments, as little as 0.1 g/cc, as little as 0.01 g/cc, or less). In certain embodiments, the bulk density of the aerogel may be between 0.01 g/cc and 0.8 g/cc (endpoints inclusive). In some embodiments, it can be particularly advantageous if the aerogel exhibits a bulk density of greater than or equal to 0.01 g/cc and less than or equal to 0.5 g/cc. In some embodiments, the aerogel exhibits any of these properties after being subjected to a standard heating cycle in which the elevated temperature is 200° C. (or 250° C., 300° C., or 350° C.).

The aerogel may exhibit any of a variety of suitable skeletal densities. One of ordinary skill in the art would appreciate that skeletal density refers to density of the solid component of the aerogel as opposed to the bulk density of the aerogel, which includes the volume of its pores. Skeletal density may be measured by measuring the skeletal volume of specimen using a pycnometer, for example, a Micromeritics AccuPyc II 1340 Gas Pycnometer, employing helium as the working gas. Specimens may be dried under a flow of nitrogen or helium prior to measurement to remove moisture or other solvent from the pores of the aerogel. Skeletal volume measurements may be taken by averaging 100 measurements. Mass may be measured using a digital analytical balance with a precision of 0.001 g. Skeletal density may be calculated as skeletal density=mass/skeletal volume. In some embodiments, the skeletal density of the aerogel is greater than or equal to 1 g/cc, greater than or equal to 1.2 g/cc, greater than or equal to 1.3 g/cc, greater than or equal to 1.4 g/cc, greater than or equal to 1.5 g/cc, greater than or equal to 1.6 g/cc, greater than or equal to 1.7 g/cc, greater than or equal to 1.8 g/cc, greater than or equal to 1.9 g/cc, greater than or equal to 2.0 g/cc, greater than or equal to 2.1 g/cc, greater than or equal to 2.2 g/cc, greater than or equal to 2.3 g/cc, greater than or equal to 2.4 g/cc, greater than or equal to 2.5 g/cc, greater than or equal to 3 g/cc, greater than or equal to 4 g/cc (and/or, in some embodiments, less than or equal to 5 g/cc, less than or equal to 4.5 g/cc, less than or equal to 4 g/cc, less than or equal to 3.5 g/cc, less than or equal to 3 g/cc, less than or equal to 2.5 g/cc, less than or equal to 2 g/cc, less than or equal to 1.5 g/cc, less than or equal to 1.4 g/cc, less than or equal to 1.3 g/cc). In some embodiments, the aerogel exhibits any of these properties after being subjected to a standard heating cycle in which the elevated temperature is 200° C. (or 250° C., 300° C., or 350° C.).

The aerogel may exhibit any of a variety of suitable pore structures. Pore width distribution, pore area distribution, and mean pore size may be calculated from the nitrogen desorption isotherm using the Barrett-Joyner-Halenda (BJH) method over ranges typically reemployed in measuring pore width and pore area distribution. In some embodiments, the aerogel comprises pores of less than or equal to 100 μm, less than or equal to 10 μm, less than or equal to 1 μm, less than or equal to 500 nm, less than or equal to 250 nm, less than or equal to 100 nm, less than or equal to 50 nm, less than or equal to 25 nm, less than or equal to 20 nm, less than or equal to 15 nm, and/or less than or equal to 10 nm. In some embodiments the aerogel comprises pores of greater than or equal to 5 nm, greater than or equal to 10 nm, greater than or equal to 15 nm, greater than or equal to 20 nm, greater than or equal to 25 nm, greater than or equal to 50 nm, greater than or equal to 100 nm, greater than or equal to 250 nm, greater than or equal to 500 nm, greater than or equal to 1 micron, greater than or equal to 10 microns, and/or greater than or equal to 100 microns.

Average pore width, e.g., mean pore size, (assuming cylindrical pores) may be calculated using pore width=4*(total specific volume)/(specific surface area) where total specific volume and specific surface area may also be calculated using BJH analysis of the desorption isotherm. In some embodiments, the average pore width of the aerogel is less than or equal 1 mm, less than or equal to 100 μm, less than or equal to 10 μm, less than or equal to 1 μm, less than or equal to 500 nm, less than or equal to 250 nm, less than or equal to 100 nm, less than or equal to 50 nm, less than or equal to 25 nm, less than or equal to 20 nm, less than or equal to 15 nm, and/or less than or equal to 10 nm (and/or, in some embodiments, greater than or equal to 5 nm, greater than or equal to 10 nm, greater than or equal to 15 nm, greater than or equal to 20 nm, greater than or equal to 25 nm, greater than or equal to 50 nm, greater than or equal to 100 nm, greater than or equal to 250 nm, greater than or equal to 500 nm, greater than or equal to 1 micron, greater than or equal to 10 microns, and/or greater than or equal to 100 microns). In some embodiments, the aerogel exhibits a BJH mean pore diameter greater than or equal to 2 nm and less than or equal to 50 nm when measured using nitrogen sorptimetry. In some embodiments, the aerogel exhibits a BJH mean pore diameter of greater than or equal to 10 nm and less than or equal to 25 nm when measured using nitrogen sorptimetry. In certain embodiments, it can be particularly advantageous if the average pore width of the aerogel is less than or equal to 50 nm. In some embodiments, it can be particularly advantageous if the average pore width of the aerogel is less than or equal to 20 nm. In some embodiments, the aerogel exhibits any of these properties after being subjected to a standard heating cycle in which the elevated temperature is 200° C. (or 250° C., 300° C., or 350° C.).

In some embodiments, the pore width distribution of the aerogel may be unimodal (i.e., exhibiting a single maximum). In some embodiments, the pore width distribution maximum is found at less than or equal 1 mm, less than or equal to 100 μm, less than or equal to 10 μm, less than or equal to 1 μm, less than or equal to 500 nm, less than or equal to 250 nm, less than or equal to 100 nm, less than or equal to 50 nm, less than or equal to 25 nm, less than or equal to 20 nm, less than or equal to 15 nm, and/or less than or equal to 10 nm (and/or, in some embodiments, greater than or equal to 5 nm, greater than or equal to 10 nm, greater than or equal to 15 nm, greater than or equal to 20 nm, greater than or equal to 25 nm, greater than or equal to 50 nm, greater than or equal to 100 nm, greater than or equal to 250 nm, greater than or equal to 500 nm, greater than or equal to 1 micron, greater than or equal to 10 microns, and/or greater than or equal to 100 microns). In some embodiments, the aerogel comprises a unimodal pore size distribution. In some embodiments, the aerogel exhibits any of these properties after being subjected to a standard heating cycle in which the elevated temperature is 200° C. (or 250° C., 300° C., or 350° C.).

In some embodiments, the pore width distribution of the aerogel may be bimodal, or at least bimodal. In some embodiments, the aerogel can have two distinct populations of pores, one with an average pore size less than or equal to a certain critical pore width, and one with an average pore size greater than some critical pore width. In some embodiments, the critical pore width is less than or equal 1 mm, less than or equal to 100 μm, less than or equal to 10 μm, less than or equal to 1 μm, less than or equal to 500 nm, less than or equal to 250 nm, less than or equal to 100 nm, less than or equal to 50 nm, less than or equal to 25 nm, less than or equal to 20 nm, less than or equal to 15 nm, and/or less than or equal to 10 nm (and/or, in some embodiments, greater than or equal to 5 nm, greater than or equal to 10 nm, greater than or equal to 15 nm, greater than or equal to 20 nm, greater than or equal to 25 nm, greater than or equal to 50 nm, greater than or equal to 100 nm, greater than or equal to 250 nm, greater than or equal to 500 nm, greater than or equal to 1 micron, greater than or equal to 10 microns, and/or greater than or equal to 100 microns). In some embodiments, the aerogel comprises a bimodal pore size distribution. In some embodiments, the aerogel exhibits any of these properties after being subjected to a standard heating cycle in which the elevated temperature is 200° C. (or 250° C., 300° C., or 350° C.).

In some embodiments, the aerogel exhibits a BJH pore volume of greater than or equal to 0.05 cm³/g and less than or equal to 5 cm³/g. In some embodiments, the aerogel exhibits a BJH pore volume of greater than or equal to 0.05 g/cm³, greater than or equal to 1 g/cm³, greater than or equal to 2 g/cm³, greater than or equal to 3 g/cm³, greater than or equal to 4 g/cm³, and/or less than or equal to 5 g/cm³. In some embodiments, the aerogel exhibits any of these properties after being subjected to a standard heating cycle in which the elevated temperature is 200° C. (or 250° C., 300° C., or 350° C.).

In some embodiments, the aerogel may exhibit an internal specific surface area. As used herein, the internal surface area and specific surface area have the same meaning and describe the same phenomenon. These values may also be referred to as the BET surface area. The internal specific surface area of an aerogel may be determined using nitrogen adsorption porosimetry and deriving the surface area value using the Brunauer-Emmett-Teller (BET) model. For example, nitrogen sorption porosimetry may be performed using a Micromeritics Tristar II 3020 surface area and porosity analyzer. Before porosimetry analysis, specimens may be subjected to vacuum of ˜100 torr for 24 hours to remove adsorbed water or other solvents from the pores of the specimens. The porosimeter may provide an adsorption isotherm and desorption isotherm, which comprise the amount of analyte gas adsorbed or desorbed as a function of partial pressure. Specific surface area may be calculated from the adsorption isotherm using the BET method over ranges typically employed in measuring surface area. In some embodiments, the BET surface area of the aerogel is greater than or equal to 5 m²/g, greater than or equal to 50 m²/g, greater than or equal to 100 m²/g, greater than or equal to 200 m²/g, greater than or equal to 300 m²/g, greater than or equal to 400 m²/g, greater than or equal to 500 m²/g, greater than or equal to 600 m²/g, greater than or equal to 700 m²/g, greater than or equal to 800 m²/g, greater than or equal to 1000 m²/g, greater than or equal to 2000 m²/g, greater than or equal to 3000 m²/g, and/or less than or equal to 1500 m²/g, or less than or equal to 4000 m²/g. In some embodiments, the BET surface area of the aerogel is greater than or equal to 5 m²/g and less than or equal to 4000 m²/g. In some embodiments, it can be particularly advantageous if the aerogel exhibits a BET surface area of greater than or equal to 100 m²/g and less than or equal to 800 m²/g. Values of the BET surface area of the aerogel outside of these ranges may be possible. In certain embodiments, it can be particularly advantageous if the aerogel exhibits a BET surface area of greater than or equal to 200 m²/g and less than or equal to 400 m²/g. In some embodiments, the aerogel exhibits any of these properties after being subjected to a standard heating cycle in which the elevated temperature is 200° C. (or 250° C., 300° C., or 350° C.).

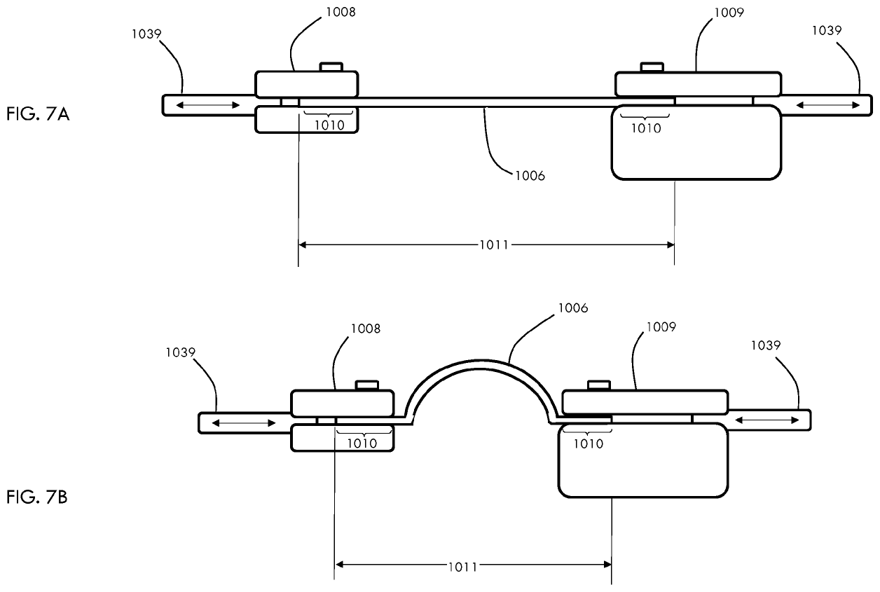

Dusting of an aerogel may be unfavorable in a number of applications. Without wishing to be bound by any particular theory, it is believed that dusting of aerogels is caused by low fracture toughness of the aerogel and that the dust is made of small pieces of the aerogel that break off due to shear, tensile, and/or flexural stress. In some embodiments, dusting of aerogel from an aerogel maybe caused by low fracture toughness of the aerogel. The degree of dusting of an aerogel can be determined using an apparatus like the one illustrated in FIGS. 7A-7B, as follows. The apparatus comprises a rail on which two parallel clamps (1008 and 1009 in FIGS. 7A-7B) are installed. The clamps are attached to linear actuators (1039 in FIGS. 7A-7B) that are able to slide the clamps along the rail. The clamps each include an indentation of 1 cm into which the aerogel sample can be placed. To test a particular aerogel, a representative sample that is 2.5 inches×3.5 inches×2 mm thick is cut. The sample mass is measured and recorded. The sample is clamped between the two clamps of the rail such that 1 cm of the length of the sample (see dimensions 1010 in FIGS. 7A-7B) is positioned between each clamp. The clamps are positioned such that the sample initially is not under tension or compression along the length of the rail (see FIG. 7A). This position is referred to as the unflexed position. The clamps are then moved by the linear actuators toward each other by a distance of 0.5 inches each, such that the ends of the aerogel sample are now 2.5 inches apart (see dimension 1011 in FIG. 7B, compared to dimension 1011 in FIG. 7A). This is considered the flexed position. The linear actuators then move the clamps back to the unflexed position. This is considered one flex cycle. During testing, each flex cycle is performed in 1 second, and for a dusting test, the sample is flexed 1000 times. The sample mass is measured again after the dusting test. The difference in sample mass from before the dusting test and after the dusting test is the amount of mass lost due to dusting. In some embodiments, after the dusting test, the change in the mass of the aerogel sample is less than or equal to 50%, less than or equal to 25%, less than or equal to 10%, less than or equal to 5%, less than or equal to 2% (and/or, in some embodiments, as little as 0.1%, or as little as 0%). In some embodiments, the aerogel exhibits any of these properties after being subjected to a standard heating cycle in which the elevated temperature is 200° C. (or 250° C., 300° C., or 350° C.).

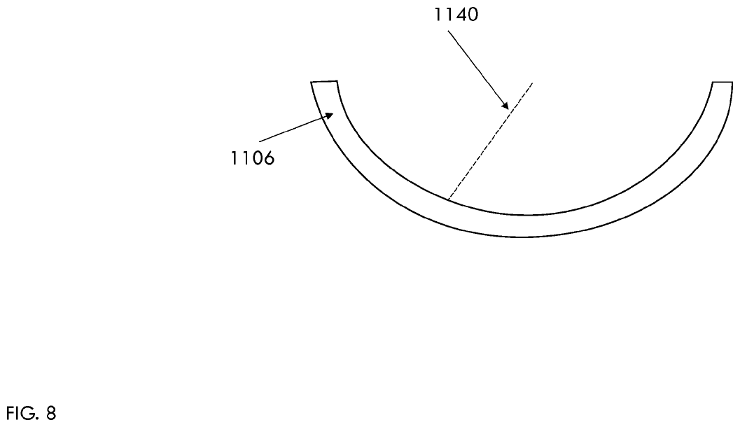

In some embodiments, a sample of the aerogel having dimensions of 4 inches×6 inches×2 mm and a longitudinal axis is capable of being deformed, without creasing, such that the longitudinal axis forms a radius of curvature of less than or equal to 1 inch, less than or equal to ½ inch, less than or equal to ¼ inch, less than or equal to ⅛ inch, less than or equal to 1/16 inch, less than or equal to 1/32 inch, less than or equal to 1/64 inch, or less than or equal to 1/256 inch (and/or, as little as 1/512 inch, or less). On example of this is shown in FIG. 8, where aerogel 1106 has been deformed, without creasing, to have a radius of curvature 1140. In some embodiments, it can be particularly advantageous if a sample of the aerogel having dimensions of 4 inches×6 inches×2 mm and a facial area defined by the 4 inch and 6 inch dimensions is capable of forming a radius of curvature of less than or equal to % A inch when flexed perpendicular to the 4 inch dimension. In some embodiments, the aerogel exhibits any of these properties after being subjected to a standard heating cycle in which the elevated temperature is 200° C. (or 250° C., 300° C., or 350° C.).

In some embodiments, the aerogel has a compressive modulus (also known as Young's modulus, in some embodiments approximately equal to bulk modulus) and yield strength which may be determined using standard uniaxial compression testing. Compressive modulus and yield strength may be measured using the method outlined in standard ASTM D1621-10 “Standard Test Method for Compressive Properties of Rigid Cellular Plastics” followed as written with the exception that specimens are compressed with a crosshead displacement rate of 1.3 mm/s (as prescribed in standard ASTM D695) rather than 2.5 mm/s. In certain embodiments, the compressive modulus of the aerogel is greater than or equal to 100 kPa, greater than or equal to 500 kPa, greater than or equal to 1 MPa, greater than or equal to 10 MPa, greater than or equal to 50 MPa, greater than or equal to 100 MPa, and/or less than or equal to 100 MPa, less than or equal to 50 MPa, less than or equal to 10 MPa, less than or equal to 1 MPa, less than or equal to 500 kPa, less than or equal to 100 kPa, or less than or equal to 50 kPa. Combinations of the above noted ranges, or values outside of these ranges, are possible for the compressive modulus of the aerogel. In some embodiments, it can be particularly advantageous if the aerogel exhibits a compressive modulus greater than or equal to 1 MPa. In some embodiments, the aerogel exhibits any of these properties after being subjected to a standard heating cycle in which the elevated temperature is 200° C. (or 250° C., 300° C., or 350° C.).

The aerogel may exhibit any of a variety of suitable compressive yield strengths. In certain embodiments, the compressive yield strength of the aerogel is greater than or equal to 40 kPa, greater than or equal to 100 kPa, greater than or equal to 500 kPa, greater than or equal to 1 MPa, greater than or equal to 5 MPa, greater than or equal to 10 MPa, greater than or equal to 50 MPa, greater than or equal to 100 MPa, greater than or equal to 500 MPa, and/or or less than or equal to 500 MPa, less than or equal to 100 MPa, less than or equal to 50 MPa, less than or equal to 10 MPa, less than or equal to 5 MPa, less than or equal to 1 MPa, less than or equal to 500 kPa, less than or equal to 100 kPa, or less than or equal to 50 kPa. Combinations of the above noted ranges, or values outside of these ranges, are possible for the compressive yield strength of the aerogel. In some embodiments, it can be particularly advantageous if the aerogel exhibits a compressive yield strength greater than or equal to 300 kPa. In some embodiments, the aerogel exhibits any of these properties after being subjected to a standard heating cycle in which the elevated temperature is 200° C. (or 250° C., 300° C., or 350° C.).

In some embodiments, the aerogel has a flexural modulus and flexural yield strength which may be determined using a standard mechanical testing method. Flexural modulus and yield strength may be measured using the method outlined in standard ASTM D790-10 “Flexural Properties of Unreinforced and Reinforced Plastics and Electrical Insulating Materials” followed as written, with the exception that specimen span is equal to a fixed value of 45 mm rather than varied as a ratio of the thickness of the specimen. Specimen length is at least 10 mm greater than the span. Specimen depth is in the range of 5 mm to 7 mm. Specimen width is in the range of 15 mm to 20 mm. In certain embodiments, the flexural modulus of the aerogel, as measured by the described method, may be at least 0.00689 MPa, at least 0.01 MPa, at least 0.02 MPa, at least 0.03 MPa, at least 0.04 MPa, at least 0.05 MPa, at least 0.06 MPa, at least 0.07 MPa, at least 0.08 MPa, at least 0.09 MPa, at least 0.1 MPa, at least 0.2 MPa, at least 0.3 MPa, at least 0.4 MPa, at least 0.5 MPa, at least 0.6 MPa, at least 0.7 MPa, at least 0.8 MPa, at least 0.9 MPa, at least 1 MPa, at least 2 MPa, at least 5 MPa, at least 10 MPa, at least 20 MPa, at least 50 MPa, at least 100 MPa, at least 200 MPa, at least 300 MPa, and/or less than or equal to 1 GPa, less than or equal to 500 MPa, less than or equal to 300 MPa, less than or equal to 200 MPa, less than or equal to 100 MPa, less than or equal to 50 MPa, and/or less than or equal to 20 MPa. In some embodiments, it can be particularly advantageous if the aerogel exhibits a flexural modulus greater than or equal to 1 MPa. The flexural modulus of the aerogel can be measured according to ASTM D790-10, with the exception that specimen span is equal to a fixed value of 45 mm. In some embodiments, the aerogel exhibits any of these properties after being subjected to a standard heating cycle in which the elevated temperature is 200° C. (or 250° C., 300° C., or 350° C.).

In some embodiments, the flexural strength of the aerogel is greater than or equal to 0.00689 MPa, at least 0.01 MPa, at least 0.02 MPa, at least 0.03 MPa, at least 0.04 MPa, at least 0.05 MPa, at least 0.06 MPa, at least 0.07 MPa, at least 0.08 MPa, at least 0.09 MPa, at least 0.1 MPa, at least 0.2 MPa, greater than or equal to 0.5 MPa, greater than or equal to 1 MPa, greater than or equal to 1.5 MPa, greater than or equal to 2 MPa, greater than or equal to 2.5 MPa, greater than or equal to 3 MPa, greater than or equal to 3.5 MPa, or greater than or equal to 4 MPa, at least 5 MPa, at least 10 MPa, at least 20 MPa, at least 50 MPa, at least 100 MPa, at least 200 MPa, at least 300 MPa, and/or less than or equal to 1 GPa. In some embodiments, it can be particularly advantageous if the aerogel exhibits a flexural strength greater than or equal to 0.5 MPa. The flexural strength of the aerogel can be measured according to ASTM D790-10, with the exception that specimen span is equal to a fixed value of 45 mm. In some embodiments, the aerogel exhibits any of these properties after being subjected to a standard heating cycle in which the elevated temperature is 200° C. (or 250° C., 300° C., or 350° C.).

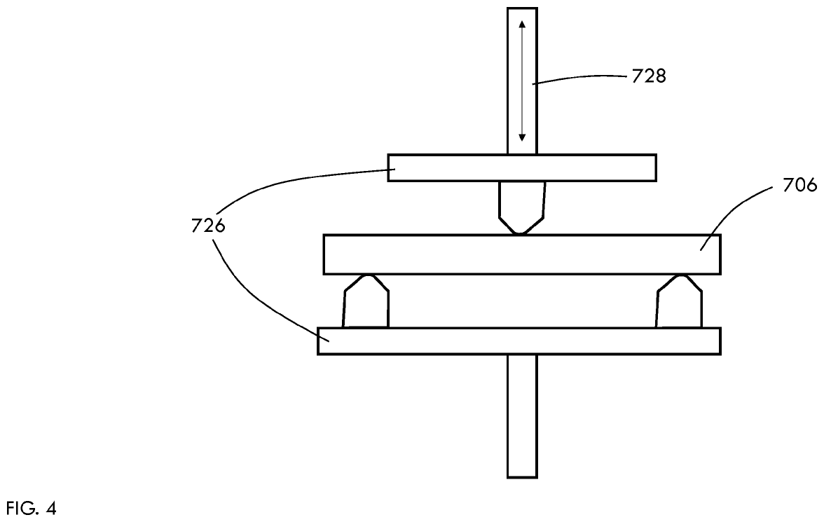

FIG. 4 depicts an apparatus used to measure flexural strength and modulus of an aerogel. An aerogel 706 is placed between plates 726, and stage 728 can be moved down to apply a force onto aerogel 706, which can be used to quantify flexural strength and/or modulus of the material.

In some embodiments, the aerogel can undergo flexural strain of greater than or equal to 1%, greater than or equal to 5%, greater than or equal to 10%, greater than or equal to 20%, greater than or equal to 30%, greater than or equal to 40%, greater than or equal to 50%, greater than or equal to 60%, greater than or equal to 70%, or greater than or equal to 80% (and/or, in some embodiments, up to 99.5%, or higher) without fracture. In some embodiments, the aerogel exhibits any of these properties after being subjected to a standard heating cycle in which the elevated temperature is 200° C. (or 250° C., 300° C., or 350° C.).

In some embodiments, the aerogel has a dielectric constant and loss tangent which may be determined using a standard testing method. Dielectric constant and loss tangent may be measured using the method outlined in standard ASTM D2520-13 “Complex Permittivity (Dielectric Constant) of Solid Electrical Insulating Materials at Microwave Frequencies and Temperatures up to 1650° C.” In certain embodiments, the aerogel exhibits an average dielectric constant over the range of 0-50 GHz of less than or equal to 100, less than or equal to 10, less than or equal to 5, less than or equal to 2, less than or equal to 1.75, less than or equal to 1.5, less than or equal to 1.4, or less than or equal to 1.25 (and/or, in some embodiments, as little as 1.0). In certain embodiments, it can be particularly advantageous if the aerogel exhibits an average dielectric constant over the range of 0-50 GHz of less than or equal to 1.4. In certain embodiments, the aerogel exhibits an average loss tangent over the range of 0-50 GHz of less than or equal to 1, less than or equal to 0.1, less than or equal to 0.01, less than or equal to 0.001, or less than or equal to 0.0001. In certain embodiments, it can be particularly advantageous if the aerogel exhibits an average loss tangent over the range of 0-50 GHz of less than or equal to 0.01. In some embodiments, the aerogel exhibits any of these properties after being subjected to a standard heating cycle in which the elevated temperature is 200° C. (or 250° C., 300° C., or 350° C.).

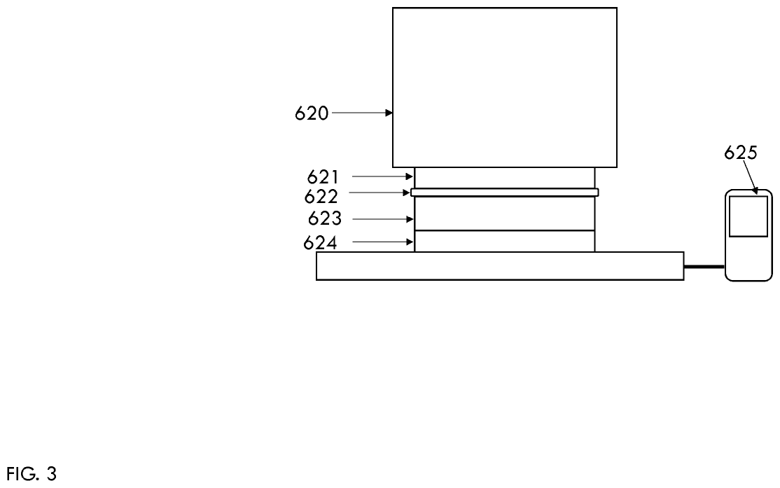

In some embodiments, the aerogel has a relatively low thermal conductivity. Thermal conductivity of an aerogel may be measured using a calibrated hot plate (CHP) device. FIG. 3 schematically illustrates a CHP device. In the figure, an aerogel 622 is placed between a hot surface 621 and cold surface 624. A reference material 623 is adjacent to the aerogel 622, and a heating element 620 can provide heat to the device. A processor 625 can collect heat and/or temperature data from the device in order to determine the thermal conductivity of the aerogel. More details regarding this measurement technique are described below.

The CHP method is based on the principle underlying standard ASTM E1225 “Standard Test Method for Thermal Conductivity of Solids by Means of the Guarded-Comparative-Longitudinal Heat Flow Technique.” An apparatus in which an aerogel and/or other sample material (the mass, thickness, length, and width of which have been measured as explained in the procedure for measuring bulk density) is placed in series with a standard reference material (e.g., NIST SRM 1453 EPS board) of precisely known thermal conductivity, density, and thickness, between a hot surface and a cold surface. The hot side of the system comprises an aluminum block (4″×4″×1″) with three cartridge heaters embedded in it. The cartridge heaters are controlled by a temperature controller operating in on/off mode. The set-point feedback temperature for the controller is measured at the center of the top surface of the aluminum block (at the interface between the block and the sample material) by a type-K thermocouple (referred to as TC_H). A second identical thermocouple is placed directly beside this thermocouple (referred to as TC_1). The sample material is placed on top of the aluminum block, such that the thermocouples are near its center. A third identical thermocouple (TC_2) is placed directly above the others at the interface between the sample material and the reference material. The reference material is then placed on top of the sample material covering the thermocouple. A fourth identical thermocouple (TC_3) is placed on top of the reference material, in line with the other three thermocouples. Atop this stack of materials, a 6″ diameter stainless steel cup filled with ice water is placed, providing an isothermal cold surface. Power is supplied to the heaters and regulated by the temperature controller such that the hot side of the system is kept at a constant temperature of approximately 37.5° C. After ensuring all components are properly in place, the system is turned on and allowed to reach a state of equilibrium. At that time, temperatures at TC_1, TC_2, and TC_3 are recorded. This recording is repeated every 15 minutes for at least one hour. From each set of temperature measurements (one set being the three temperatures measured at the same time), the unknown thermal conductivity can be calculated as follows. By assuming one-dimensional conduction (i.e., neglecting edge losses and conduction perpendicular to the line on which TC_1, TC_2, and TC_3 sit) one can state that the heat flux through each material is defined by the difference in temperature across that material divided by the thermal resistance per unit area of the material (where thermal resistance per unit area is defined by R″=t/k, where t is thickness in meters and k is thermal conductivity in W/m·K). The thickness, t, is measured while subjecting the sample material to a pressure equal to that which is experienced by the sample material during the CHP thermal conductivity test. For example, thickness of a sample material may be measured by sandwiching the sample material between a fixed rigid surface and a moveable rigid plate, parallel to the rigid surface, and applying a known pressure to the material sample by applying a known force to the rigid plate. Using any suitable means, for example a dial indicator or depth gauge, the thickness of this stack of materials, t_1, may be measured. The material sample is then removed from this stack of materials and the thickness, t_2, of the rigid plate is measured under the same force as previously prescribed. The thickness of the material sample under the prescribed pressure can thus be calculated by subtracting t_2 from t_1. The preferred range of material sample thickness for use in this thermal conductivity measurement is between 2 and 10 mm. Using material sample thicknesses outside of this range may introduce a level of uncertainty and/or error into the thermal conductivity calculation such that the measured values are no longer accurate and/or reliable. By setting the heat flux through the sample material equal to the heat flux through the reference material, the thermal conductivity of the sample material can be solved for (the only unknown in the equation). This calculation is performed for each temperature set, and the mean value is reported as the sample thermal conductivity. The thermocouples used can be individually calibrated against a platinum RTD, and assigned unique corrections for zero-offset and slope, such that the measurement uncertainty is ±0.25° C. rather than ±2.2° C.

In certain embodiments, the thermal conductivity at 25° C. of the aerogel, as measured by the CHP method (described above), may be less than or equal to 100 mW/m·K, less than or equal to 75 mW/m·K, less than or equal to 50 mW/m·K, less than or equal to 35 mW/m·K, less than or equal to 25 mW/m·K, less than or equal to 23 mW/m·K, less than or equal to 20 mW/m·K, less than or equal to 15 mW/m·K or less than or equal to 12 mW/m·K, and/or greater than or equal to 0.1 mW/m·K, greater than or equal to 1 mW/m·K, greater than or equal to 2 mW/m·K, greater than or equal to 5 mW/m·K, or greater than or equal to 15 mW/m·K. In some embodiments, it can be particularly advantageous if the aerogel exhibits a thermal conductivity of less than or equal to 30 mW/m·K, or less than or equal to 25 mW/m·K at 25° C. In some embodiments, the aerogel exhibits any of these properties after being subjected to a standard heating cycle in which the elevated temperature is 200° C. (or 250° C., 300° C., or 350° C.).

In some embodiments, the aerogel can exhibit a relatively high acoustic attenuation. Acoustic attenuation of the aerogel can be expressed in terms sound transmission loss. The term sound transmission loss is defined in standard ASTM C634. In certain embodiments, the aerogel exhibits a sound transmission loss of greater than or equal to 1 dB/cm, greater than or equal to 5 dB/cm, greater than or equal to 10 dB/cm, greater than or equal to 11 dB/cm, greater than or equal to 12 dB/cm, greater than or equal to 13 dB/cm, greater than or equal to 14 dB/cm, greater than or equal to 15 dB/cm, greater than or equal to 16 dB/cm, greater than or equal to 17 dB/cm, greater than or equal to dB/cm, greater than or equal to 18 dB/cm, greater than or equal to 19 dB/cm, greater than or equal to 20 dB/cm, greater than or equal to 30 dB/cm, greater than or equal to 40 dB/cm, and/or greater than or equal to 50 dB/cm (and/or, as much as 80 dB/cm, as much as 100 dB/cm, or more) when measured according to standard ASTM E2611. In certain embodiments, the aerogel exhibits sound transmission loss of greater than or equal to 1 dB/cm, greater than or equal to 5 dB/cm, greater than or equal to 10 dB/cm, greater than or equal to 11 dB/cm, greater than or equal to 12 dB/cm, greater than or equal to 13 dB/cm, greater than or equal to 14 dB/cm, greater than or equal to 15 dB/cm, greater than or equal to 16 dB/cm, greater than or equal to 17 dB/cm, greater than or equal to dB/cm, greater than or equal to 18 dB/cm, greater than or equal to 19 dB/cm, greater than or equal to 20 dB/cm, greater than or equal to 30 dB/cm, greater than or equal to 40 dB/cm, and/or greater than or equal to 50 dB/cm (and/or, as much as 80 dB/cm, as much as 100 dB/cm, or more) when measured according to standard ASTM E90. In some embodiments, it can be particularly advantageous if the aerogel exhibits an average sound transmission loss over the frequency range of 300 Hz-2000 Hz greater than or equal to 5 dB/cm. In some embodiments, the aerogel exhibits any of these properties after being subjected to a standard heating cycle in which the elevated temperature is 200° C. (or 250° C., 300° C., or 350° C.).

In some embodiments, the aerogel has at least one dimension that is greater than or equal to 1 mm, greater than or equal to 2 mm, greater than or equal to 3 mm, greater than or equal to 4 mm, greater than or equal to 5 mm, greater than or equal to 6 mm, greater than or equal to 7 mm, greater than or equal to 8 mm, greater than or equal to 9 mm, greater than or equal to 10 mm, greater than or equal to 15 mm, greater than or equal to 20 mm, greater than or equal to 25 mm, greater than or equal to 30 mm, greater than or equal to 35 mm, greater than or equal to 40 mm, greater than or equal to 45 mm, greater than or equal to 50 mm, greater than or equal to 10 cm, greater than or equal to 30 cm, greater than or equal to 50 cm, and/or greater than or equal to 100 cm (and/or, in some embodiments, as much as 1 meter, as much as 25 meters, as much as 100 meters, as much as 1000 meters, or more). In some embodiments, it can be particularly advantageous if the aerogel has at least one dimension greater than or equal to 30 cm. In some embodiments, this dimension is a first dimension.

In some embodiments, the aerogel has a second dimension (different from and perpendicular to the first dimension) that is greater than or equal to 1 mm, greater than or equal to 2 mm, greater than or equal to 3 mm, greater than or equal to 4 mm, greater than or equal to 5 mm, greater than or equal to 6 mm, greater than or equal to 7 mm, greater than or equal to 8 mm, greater than or equal to 9 mm, greater than or equal to 10 mm, greater than or equal to 15 mm, greater than or equal to 20 mm, greater than or equal to 25 mm, greater than or equal to 30 mm, greater than or equal to 35 mm, greater than or equal to 40 mm, greater than or equal to 45 mm, greater than or equal to 50 mm, greater than or equal to 10 cm, greater than or equal to 30 cm, greater than or equal to 50 cm, and/or greater than or equal to 100 cm (and/or, in some embodiments, as much as 1 meter, as much as 25 meters, as much as 50 meters, or more). In some embodiments, it can be particularly advantageous if the second dimension of the aerogel is greater than or equal to 1 foot.

In some embodiments, the aerogel has a third dimension (different from and perpendicular to the first dimension and to the second dimension) that is greater than or equal to 1 mm, greater than or equal to 2 mm, greater than or equal to 3 mm, greater than or equal to 4 mm, greater than or equal to 5 mm, greater than or equal to 6 mm, greater than or equal to 7 mm, greater than or equal to 8 mm, greater than or equal to 9 mm, greater than or equal to 10 mm, greater than or equal to 15 mm, greater than or equal to 20 mm, greater than or equal to 25 mm, greater than or equal to 30 mm, greater than or equal to 35 mm, greater than or equal to 40 mm, greater than or equal to 45 mm, greater than or equal to 50 mm, greater than or equal to 10 cm, greater than or equal to 30 cm, greater than or equal to 50 cm, and/or greater than or equal to 100 cm (and/or, in some embodiments, as much as 1 meter, as much as 25 meters, as much as 50 meters, or more). In some embodiments, it can be particularly advantageous if the third dimension of the aerogel is greater than or equal to 1 foot.

As would be understood by those of ordinary skill in the art, the length of a particular dimension of an article (e.g., an aerogel) corresponds to the distance between the exterior boundaries of that article along that dimension. As also would be understood by those of ordinary skill in the art, when measuring three dimensions of an article, each dimension would be perpendicular to the other two (such that the second dimension would be perpendicular to the first dimension, and the third dimension would be perpendicular to the first and second dimensions).

In some embodiments, the aerogel comprises an infrared (IR) opacifier. The JR opacifier can be added, for example, before, during, or after the gelation of the gel and/or before, during, or after the formation of the aerogel.

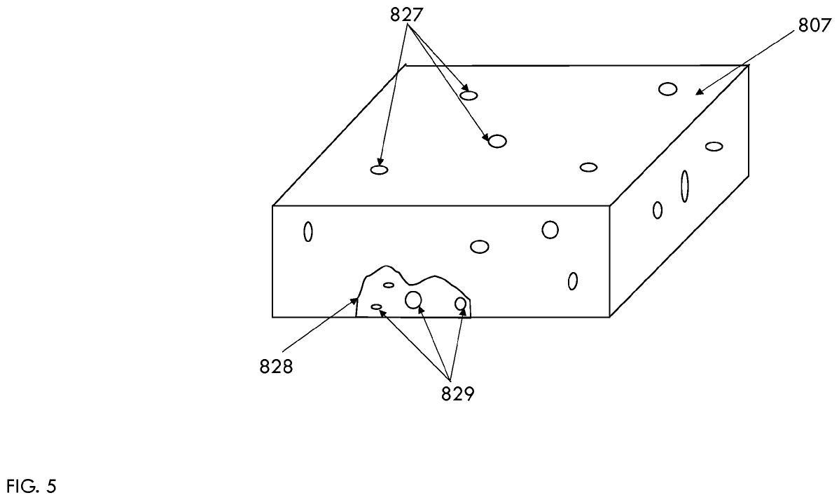

Any of a variety of materials can be used in the IR opacifier. In some embodiments, the IR opacifier comprises a metal (e.g., magnesium, zinc, antimony, and/or combinations of these or other metals such as a magnesium-zinc blends and/or a magnesium-zinc-antimony blends), a metal carbide (e.g., titanium carbide), a metalloid carbide (e.g., silicon carbide), a metal oxide (e.g., an iron oxide, a titanium oxide, a zinc oxide, an aluminum oxide, and/or an antimony oxide), a metalloid oxide (e.g., a silicon oxide), graphitic carbon (e.g., graphite, graphene, carbon nanotubes, and/or fullerenes), elemental carbon (e.g., carbon black), amorphous carbon (e.g., carbon made from a polymer aerogel), a phosphate, a borate, a metal silicate, a metalloid silicate, a metallocene, a molybdate, a stannate, a hydroxide, and/or a carbonate. In some embodiments, the IR opacifier is a particulate material with a measurable maximum cross-sectional dimension. For example, FIG. 5 schematically illustrates an aerogel comprising a particulate material. In the figure, aerogel 807 includes a particulate material 827. The particulate material can be at the surface of the aerogel and/or within the bulk of the aerogel. For example, in FIG. 5, 828 shows the border of a volume of aerogel that has been cut out, and particulate material 829 is present within the bulk of the aerogel.

The average maximum cross-sectional dimension is taken as a number average and can be measured using microscopy. In some embodiments, the average maximum cross-sectional dimension of the IR opacifier can be determined by placing a representative sample of the IR opacifier on a slide or other suitable analysis substrate, imaging the particles (e.g., using image capture hardware and software to capture an image of the IR opacifier sample under proper magnification), and then determining the largest cross-sectional dimension of each particle (e.g., using an image processing software to find the maximum cross-sectional dimensions of each discrete particle present in the sample). Suitable magnification devices include an optical microscope or a scanning electron microscope (SEM). The maximum cross-sectional dimensions of all discrete particles are then averaged to determine the average maximum cross-sectional dimension of the sample. In some embodiments, the average maximum cross-sectional dimension of the IR opacifier is greater than or equal to 50 nanometers and less than or equal to 1 centimeter. In some embodiments, the average maximum cross-sectional dimension of IR opacifier is greater than or equal to 50 nm, greater than or equal to 100 nm, greater than or equal to 250 nm, greater than or equal to 500 nm, greater than or equal to 1 micrometer, greater than or equal to 10 micrometers, greater than or equal to 25 micrometers, greater than or equal to 50 micrometers, greater than or equal to 100 micrometers, greater than or equal to 250 micrometers, greater than or equal to 500 micrometers, greater than or equal to 1 millimeter, and/or less than or equal to 1 centimeter, less than or equal to 5 millimeters, less than or equal to 1 millimeter, less than or equal to 100 micrometers, less than or equal to 50 micrometers, or less than or equal to 5 micrometers. In certain embodiments, it can be particularly advantageous if the maximum cross-sectional dimension of the IR opacifier is greater than or equal to 1 micrometer less than or equal to 5 micrometers.

In some embodiments, the aerogel may be carbonizable. In some embodiments, a carbonized derivative of the aerogel may be produced. In some embodiments, the carbonized derivative of the aerogel may by produced via pyrolysis. In some embodiments, the carbonized derivative is fibrillar.

In some embodiments, the aerogel further comprises silica aerogel. In some embodiments, the aerogel further comprises trimethylsilyl-functionalized silica aerogel. In some embodiments, the aerogel further comprises trimethylsilyl-functionalized silica aerogel comprising sodium ions. In some embodiments, the aerogel comprises discrete particles of silica aerogel. In some embodiments, the aerogel comprises discrete particles of trimethylsilyl functionalized silica aerogel. In some embodiments, the aerogel comprises silica in an amount of at least 0.001 wt %, at least 0.01 wt %, at least 0.1 wt %, and/or less than or equal to 25 wt %, less than or equal to 20 wt %, less than or equal to 15 wt %, less than or equal to 10 wt %, or less than or equal to 5 wt % relative to the mass of the aerogel. In some embodiments, the addition of silica aerogel particles increases the hydrophobicity of the aerogel. Without wishing to be bound to any particular theory, it is believed that the addition of trimethylsilyl functionalized silica aerogel comprising sodium ions to the polymer aerogel may increase the resistance of the polymer aerogel to absorbing liquid comprising a surfactant. In some embodiments, increased resistance of the polymer aerogel to absorbing liquid comprising a surfactant may result in a polymer aerogel that can undergo laundering without significant increase in density, reduction in pore size, and/or change in internal surface area following laundering.

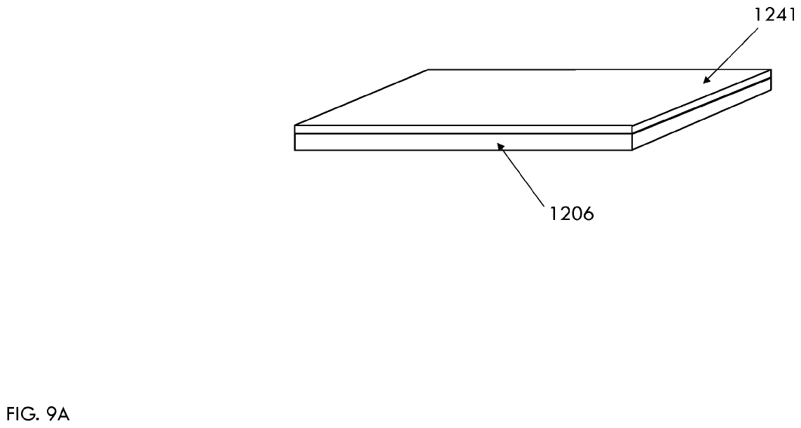

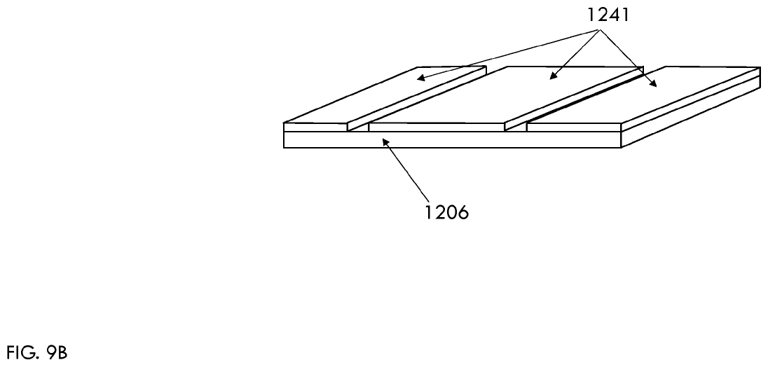

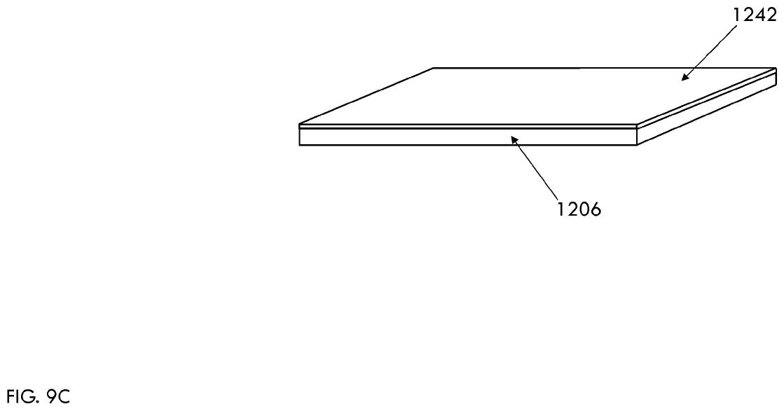

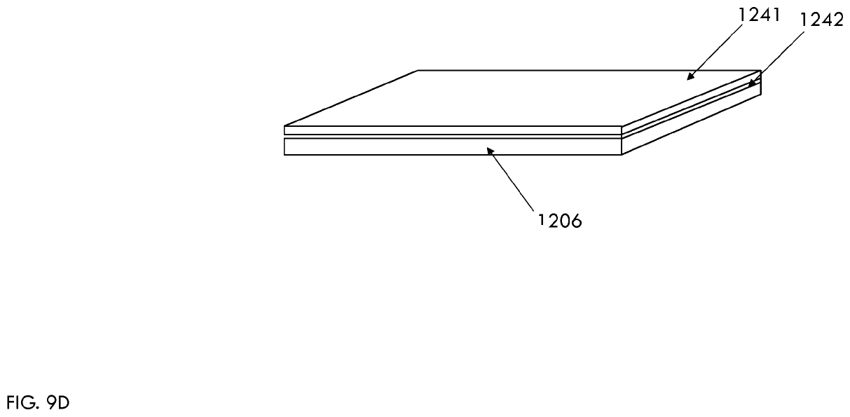

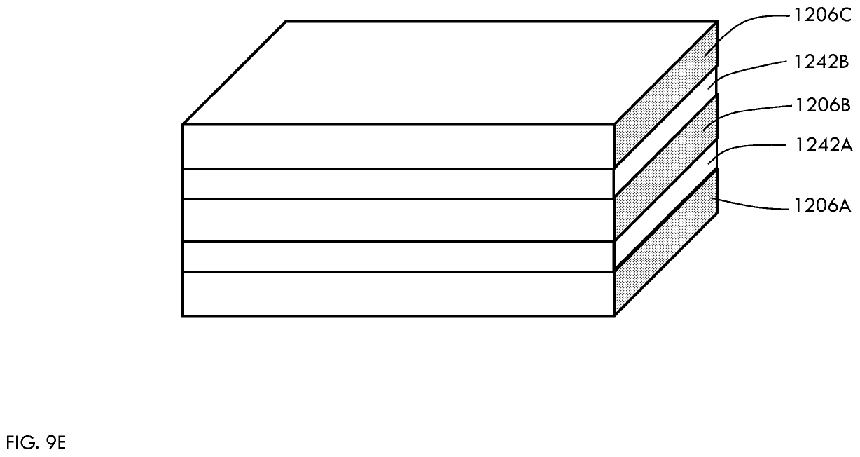

In some embodiments, an article comprising an aerogel comprises an adhesive applied to at least a portion of an external surface of the aerogel. For example, FIGS. 9C-9D schematically illustrate an adhesive 1242 over an exterior surface of the aerogel 1206. In some embodiments, the adhesive is applied in the form of a transfer tape. In some embodiments, the adhesive is sprayed on to the aerogel. In some embodiments, the adhesive is poured on to the aerogel. In further embodiments, the adhesive is spread on the aerogel. In some embodiments, the adhesive is applied in a uniform layer over an exterior face of the aerogel. In further embodiments, the adhesive is applied in a non-uniform layer over an exterior face of the aerogel. In some embodiments, the adhesive comprises an epoxy, an acrylic, an acrylonitrile, a polyamide, a polyester, a polysulfide, a polyvinyl acetate, a polyethylene, a polypropylene, a polyvinylpyrrolidone, a polyvinyl alcohol, a cyanoacrylate, a biopolymer, a polyurethane, a polyurea, an isocyanate, a silicone, and/or a gelatin. In some embodiments the adhesive covalently bonds with the aerogel. In some embodiments, the adhesive wicks in to one or more of the pores of the aerogel. In some embodiments, the adhesive is non-flammable. In some embodiments, the adhesive is heat activated.

In some embodiments, an article comprises an aerogel and a layer of facing material. For example, FIG. 9A schematically depicts an aerogel 1206 with a facing material 1241 on an exterior surface of aerogel 1206. The facing material may be arranged in any of a variety of ways on the aerogel. For example, FIG. 9A schematically depicts the facing material over the entirety of the exterior surface of aerogel 1206. In other embodiments, the facing material covers portions, but not necessarily the entirety of, an exterior surface of the aerogel. In FIG. 9B, for example, facing material 1241 covers only portions of the exterior surface of the aerogel 1206, relative to the embodiment illustrated in FIG. 9A.

In some embodiments, the facing material comprises a polymer, a metal, a ceramic, a fibrous sheet, and/or a carbon. In some embodiments, the facing material is chemically adhered to the aerogel. In some embodiments, the facing material is mechanically adhered to the aerogel. In some embodiments, the facing material is adhered to the aerogel using an adhesive. In FIG. 9D, for example, facing material 1241 is adhered to aerogel 1206 via adhesive 1242.

In some embodiments, the article comprising the aerogel also comprises more than one layer of facing material. In some embodiments, the article comprising the aerogel comprises a continuous layer of facing material. In other embodiments, the article comprising the aerogel comprises a discontinuous layer of facing material. In some embodiments, the article comprising the aerogel comprises a layer of uniform thickness of facing material. In other embodiments, the article comprising the aerogel comprises a layer of facing material that is not a uniform thickness.

In some embodiments, the facing material is in solid contact with the aerogel. Solid contact includes both direct solid contact and indirect solid contact. Two solid objects are said to be in “indirect solid contact” when there are one or more solid materials between them and at least one pathway can be traced from the first solid object to the second solid object that passes only through solid materials. As one example, if solid interlayer is between an aerogel/aerogel and a facing material, the aerogel and the facing material are said to be in indirect solid contact because a pathway can be traced from the aerogel/aerogel, through the solid interlayer (a solid object), and to the facing layer. By contrast, two solid objects are said to be in “direct contact” when they are in direct physical contact with each other.

In certain aspects, the aerogels described herein can be part of layered (e.g., a multi-layer) articles. Generally, a layer is an arrangement of material having a thickness dimension, a width dimension (which is perpendicular to the thickness dimension) that is at least 5 times the thickness dimension, and a depth dimension (which is perpendicular to both the thickness dimension and the width dimension) that is at least 5 times the thickness dimension. In some embodiments, the layer is arranged such that the width dimension is at least 10 times, at least 50 times, at least 100 times, at least 500 times, or at least 1000 times the thickness dimension. In certain embodiments, the layer is arranged such that the depth dimension is at least 10 times, at least 50 times, at least 100 times, at least 500 times, or at least 1000 times the thickness dimension.

In some embodiments, an article comprises a first layer comprising an aerogel adhered to a second layer (e.g., comprising an aerogel). In some embodiments, a plurality of layers of aerogel are adhered to one another in order to achieve a desired thickness of an overall multi-layered article. In some embodiments, the plurality of layers comprises 2 layers, 3 or more layers, 4 or more layers, 5 or more layers, 6 or more layers, 7 or more layers, 8 or more layers, 9 or more layers, 10 or more layers, 15 or more layers, 20 or more layers, 25 or more layers, 30 or more layers, 35 or more layers, 40 or more layers, 45 or more layers, or 50 or more layers. In some embodiments, it can be advantageous to include at least 2 and less than or equal to 10 aerogel layers within the article.

In some embodiments, the aerogel layer(s) are secured with an adhesive. As an illustrative example, in some embodiments, one face of a first aerogel layer is adhered to a first face of a second aerogel layer, and a second face of the second aerogel layer is adhered to one face of a third aerogel layer. One example of such an arrangement is shown in FIG. 9E, in which the top face of first aerogel layer 1206A is adhered (using adhesive 1242A) to the bottom face of second aerogel layer 1206B, and the top face of second aerogel layer 1206B is adhered (using adhesive 1242B) to the bottom face of third aerogel layer 1242C.

In accordance with some embodiments, polymer aerogels may be prepared in a variety of form factors. In some embodiments, monolithic aerogels (e.g., in the form of monolithic parts) may be produced. One of ordinary skill in the art would appreciate the meaning of monolithic as referring to a whole, contiguous, macroscopic part or object as opposed to, for example, a powdered or granular form of a material, a sub-volume of a part or object, or an embedded/integrated component of a material, e.g., one of the networks in an aerogel comprising interpenetrating networks. In some embodiments, the part may have complex features. In some embodiments, flexible tapes may be produced. In some embodiments, thin films with thicknesses ranging from 1 micron to 1 mm may be produced. In some embodiments, the shape of a polymer aerogel may be changed by CNC milling, sawing, drilling, stamping, sanding, grinding, bending, compressing, rolling, and/or thermoforming.

The aerogels described herein can be used in any of a variety of applications.

In some embodiments, a reinforcing material is at least included within the geometric boundaries of the polymer aerogel; said reinforcing material comprising a fibrous batting, an open-cell foam, and/or a honeycomb.

In some embodiments, the polymer aerogel has at least one dimension between 10 microns and 1 mm.

In some embodiments, the polymer aerogel has at least one dimension equal to or greater than 10 cm, greater than 30 cm, greater than 50 cm, and/or greater than 100 cm. In some embodiments, it can be particularly advantageous if the polymer aerogel has at least one dimension greater than or equal to 30 cm.

In some embodiments, a thin film comprises the polymer aerogel. In some embodiments, a monolith comprises the polymer aerogel. In some embodiments, a particle comprises the polymer aerogel. In some embodiments, a flexible tape comprises the polymer aerogel. In some embodiments, ballistics armor, shield, panel, composite, and/or protective vest comprises the polymer aerogel.

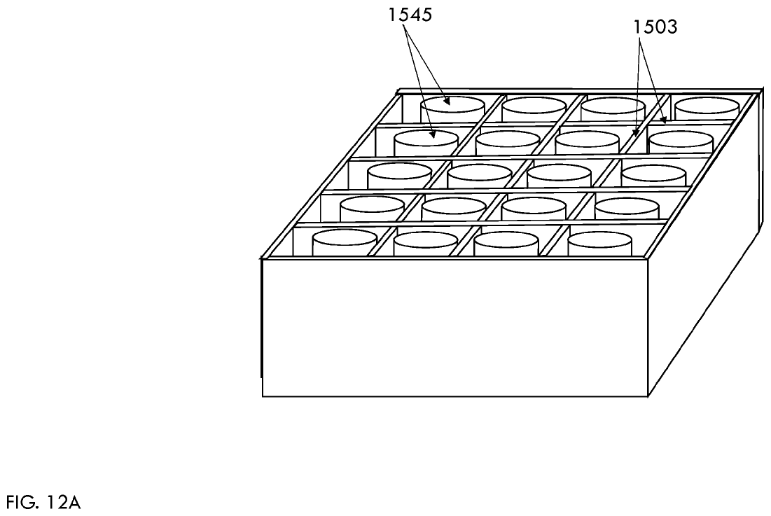

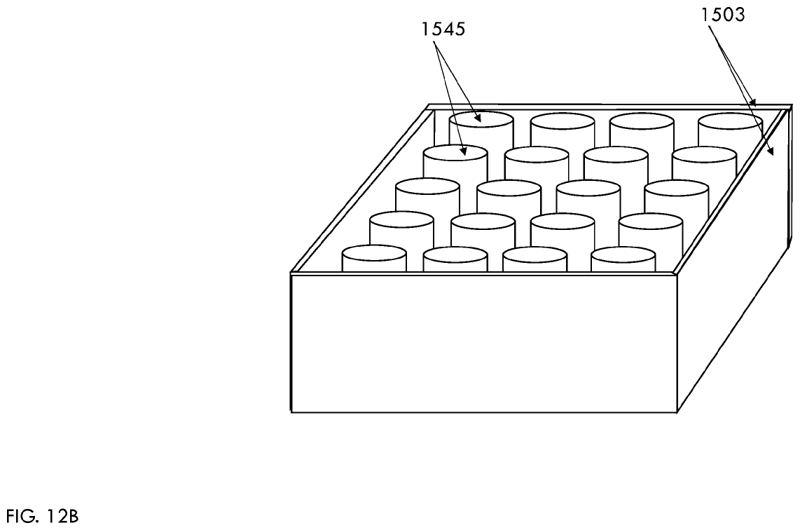

In some embodiments, the aerogel is used in a vehicle. In some embodiments, the vehicle is an automobile, an airplane, a rocket, and/or a boat. In some embodiments, the aerogel is used as an aircraft wall panel. In some embodiments, the aerogel is used in an engine cover. In some embodiments, the aerogel is used in a battery pack. For example, FIGS. 12A-12B schematically illustrate an aerogel 1503 adjacent to batteries 1545. In FIG. 12A, aerogel 1503 has been positioned between battery cells. In particular, aerogel 1503 has been arranged to form a matrix of compartments into which the cells have been positioned. In FIG. 12B, aerogel has been used to form the outer walls of a compartment containing cells 1545.

In some embodiments, aerogels are suitable for use as soundproofing, a component in a ballistics shield, panel, armor, protective vest, and/or bullet-proof armor, and/or vibration mitigating insulation. In some embodiments, it can be particularly advantageous to use the aerogel in ballistics armor, a shield, a panel, and/or a protective vest.

In some embodiments, the aerogel is used as a flexible tape. In some embodiments, the flexible tape may be used in construction applications. In some other embodiments, the flexible tape may be used in aerospace applications. In still further embodiments, the flexible tape may be used in automotive applications.

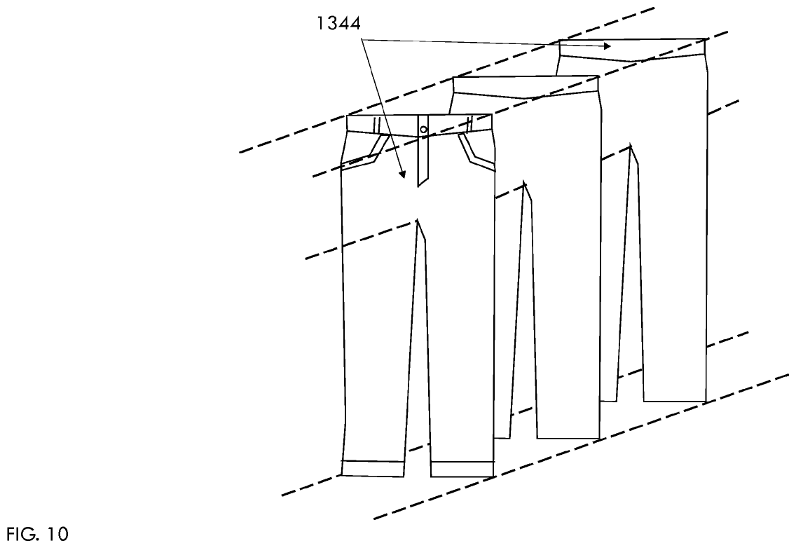

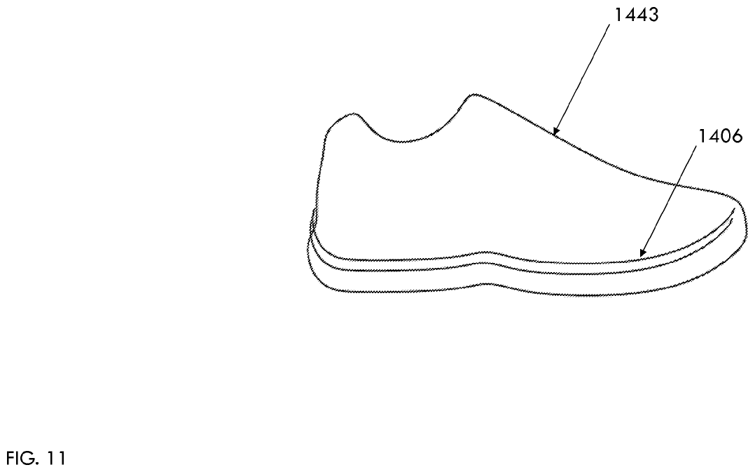

In some embodiments, the aerogel is used in an apparel garment. In some embodiments, the apparel garment is a jacket, a hat, gloves, a shirt, socks, pants, or any other apparel garment. For example, FIG. 10 schematically depicts pants 1344 that include an aerogel. In some embodiments, the aerogel is used in a wetsuit. In some embodiments, the aerogel is used in a shoe, a boot, or an insole. By way of illustration and not limitation, FIG. 11 schematically depicts a shoe 1443 including an insole 1406 comprising an aerogel. In some embodiments, the aerogel is sewn into an apparel garment. In some embodiments, the aerogel is laminated (e.g., chemically laminated) to a textile in an apparel garment. In some embodiments, the aerogel is adhered to a textile in an apparel garment. In some embodiments, the aerogel is sandwiched between two panels in an apparel garment.

### EXAMPLES

The following examples are intended to illustrate certain embodiments of the present invention, but do not exemplify the full scope of the invention.

### Example 1. Synthesis of Polyurea Aerogel Produced from the Reaction of Isocyanate with In-Situ-Formed Amines

Polyurea gels were synthesized from the reaction of isocyanates with amines and/or in-situ formed amines. Unless otherwise provided, each alkyl amine shown in Table 1 is unbranched alkyl amine, and each dialkyl amine shown in Table 1 is unbranched dialkyl amine. Various methods of improving the hydrophobicity of a polyurea aerogel, by hydrophobizing said gel, were explored, including the addition of a hydrophobe during solvent exchange as well as the addition of a hydrophobe in the solution before the gel is set. Bulk density and water uptake were determined at ambient temperature, and thermal conductivity was measured according to the calibrated hot plate method described herein. A table outlining the various methods of hydrophobization is provided below in Table 1.

TABLE 1
Hydrophobic Polyurea Aerogel Formulations

| | | | | Molarity | |
|---|---|---|---|---|---|
| | | | Hydrophobe | N3300A in | [Hydrophobe]: |
| | Base | | Integration | Base Solvent | [N3300A] |
| Sample | Solvent | Hydrophobe | Method | (M) | (if one-pot) |
| 1 | Acetone | | | 1 | |
| 2 | Acetone | Hexylamine | Solvent | 1 | |
| | | | Exchange | | |
| 4 | Acetone | Hexylamine | Solvent | 0.2 | |
| | | | Exchange | | |
| 5 | Acetone | Hexylamine | One-pot | 0.2 | 0.13 |
| 6 | Acetone | | | 0.2 | |
| 9 | Acetone | Hexylamine | One-pot | 0.2 | 0.63 |
| 10 | Acetone | Hexylamine | One-pot | 0.2 | 0.13 |
| 11 | THF | Hexylamine | One-pot | 0.125 | |
| 12 | Acetone | Hexylamine | One-pot | 0.125 | |
| 13 | Acetone | Hexylamine | One-pot | 0.2 | 0.21 |
| 14 | Acetone | Hexylamine | One-pot | 0.125 | 0.21 |
| 15 | THF | | | 0.125 | |
| 16 | THF | | | 0.125 | |
| 17 | THF | | | 0.125 | |
| 18 | Acetone | Hexylamine | Solvent | 0.2 | |
| | | | Exchange | | |
| 19 | Acetone | Hexylamine | Solvent | 0.2 | |
| | | | Exchange | | |
| 20 | Acetone | Hexylamine | One-pot | 0.2 | 0.13 |
| 21 | Acetone | Hexylamine | One-pot | 0.2 | 0.13 |
| 22 | Acetone | Hexylamine | One-pot | 0.2 | 0.25 |
| 23 | Acetone | Hexylamine | One-pot; | 0.2 | 0.25 |
| | | | Solvent | | |
| | | | Exchange | | |
| 24 | Acetone | Hexylamine | One-pot | 0.2 | 0.29 |
| 25 | Acetone | Hexylamine | One-pot; | 0.2 | 0.29 |
| | | | Solvent | | |
| | | | Exchange | | |
| 26 | Acetone | Pentafluoroaniline | One-pot | 0.2 | 0.13 |
| 27 | Acetone | 4- | | | |
| | | Trifluoromethoxyaniline | | | |
| 28 | Acetone | 1/2 | One-pot | 0.2 | 0.13 |
| | | perfluorooctylamine; | | | |
| | | 1/2 | | | |
| | | hexylamine | | | |
| 29 | Acetone | 10% | One-pot | 0.2 | 0.13 |
| | | perfluorooctylamine; | | | |
| | | 90% | | | |
| | | hexylamine | | | |
| 30 | Acetone | 1/2 | One-pot | 0.2 | 0.13 |
| | | pentafluoroaniline; | | | |
| | | 1/2 | | | |
| | | hexylamine | | | |
| 31 | Acetone | 10% | One-pot | 0.2 | 0.13 |
| | | pentafluoroaniline; | | | |
| | | 90% | | | |
| | | hexylamine | | | |
| 32 | Acetone | 1/2 4- | One-pot | 0.2 | 0.13 |
| | | trifluoromethoxyaniline; | | | |
| | | 1/2 | | | |
| | | hexylamine | | | |
| 33 | Acetone | 1/2 | One-pot | 0.2 | 0.13 |
| | | pentafluoroaniline; | | | |
| | | 1/2 | | | |
| | | hexylamine | | | |
| 34 | Acetone | Hexylamine | One-pot | 0.2 | 0.13 |
| 35 | Acetone | | One-pot | 0.08 | |
| 36 | Acetone | Hexylamine | One-pot | 0.08 | 0.13 |
| 37 | Acetone | | One-pot | 0.05 | |
| 38 | Acetone | Hexylamine | One-pot | 0.05 | 0.13 |
| 39 | Acetone | | One-pot | 0.15 | |
| 40 | Acetone | | One-pot | 0.16 | |
| 41 | Acetone | Hexylamine | One-pot | 0.15 | 0.13 |
| 42 | Acetone | Hexylamine | One-pot | 0.16 | 0.13 |
| 43 | Acetone | Hexylamine | One-pot | 0.22 | 0.13 |
| 44 | Acetone | Hexylamine | One-pot | 0.24 | 0.13 |
| 45 | Acetone | Hexylamine | One-pot | 0.26 | 0.13 |
| 46 | Acetone | Hexylamine | One-pot | 0.28 | 0.13 |
| 47 | Acetone | Hexylamine | One-pot | 0.3 | 0.13 |
| 48 | Acetone | Octylamine | One-pot | 0.2 | 0.13 |
| 49 | Acetone | 1/2 octylamine; | One-pot | 0.2 | 0.13 |
| | | 1/2 hexylamine | | | |
| 50 | Acetone | Dodecylamine | One-pot | 0.2 | 0.13 |
| 51 | Acetone | 1/2 | One-pot | 0.2 | 0.13 |
| | | dodecylamine; | | | |
| | | 1/2 hexylamine | | | |
| 52 | Acetone | Dihexylamine | One-pot | 0.2 | 0.13 |
| 53 | Acetone | Dioctylamine | One-pot | 0.2 | 0.13 |
| 54 | Acetone | Didodecylamine | One-pot | 0.2 | 0.13 |
| 55 | Acetone | 1/2 | One-pot | 0.2 | 0.13 |
| | | dihexylamine; | | | |
| | | 1/2 hexylamine | | | |
| 56 | Acetone | Perfluorooctylamine | One-pot | 0.2 | 0.13 |
| 57 | Acetone | Hexylamine | One-pot | 0.2 | 0.13 |

| | Vol % | | | | | Water |
|---|---|---|---|---|---|---|
| | Hydrophobe | | Bulk | Thermal | | Uptake w/ |
| | in Solvent | | Density | Conductivity | Water | Surfactant |
| Sample | Exchange | Additive | [g/cc] | [mW/m-K] | Uptake [%] | (%) |
| 1 | | | 0.403 | 47 | 95 | |
| 2 | 3 | | 0.347 | 37.8 | 5 | |
| 3 | 3 | | 0.311 | | 239 | |
| 4 | 0.3 | | 0.122 | | 22 | |
| 5 | | | 0.123 | | 21 | |
| 6 | | | 0.209 | 23 | 106 | |
| 7 | 0.3 | | 0.126 | | 72 | |
| 8 | | | 0.192 | | 423 | |
| 9 | | | | | 24 | |
| 10 | | | | 23.1 | 14 | |
| 11 | | | 0.101 | | 31 | |
| 12 | | | 0.07 | | 60 | |
| 13 | | | 0.098 | 24.5 | 30 | |
| 14 | | | 0.055 | 27.6 | 78 | |
| 15 | | | 0.07 | | 46 | |
| 16 | | | 0.062 | | 29 | |
| 17 | | | 0.064 | 28 | 34 | |
| 18 | 0.3 | | 0.094 | 23.9 | 27 | |
| 19 | 3 | | 0.092 | | 37 | |
| 20 | | | 0.101 | 23.2 | 21 | 245 |
| 21 | | | 0.103 | 23.6 | 18 | |
| 22 | | | 0.095 | 24.6 | 17 | |
| 23 | 0.3 | | 0.095 | | 14 | |
| 24 | | | 0.101 | 24.1 | 18 | |
| 25 | 0.3 | | 0.098 | 24.5 | 9 | |
| 26 | | | 0.1 | 24.1 | 25 | 299 |
| 27 | | | 0.099 | 24.6 | 14 | 389 |
| 28 | | | 0.105 | 22.8 | 14 | 98 |
| 29 | | | 0.1 | 23.2 | 9 | 153 |
| 30 | | | 0.096 | 24.5 | 15 | 186 |
| 31 | | | 0.097 | 24 | 18 | 206 |
| 32 | | | 0.099 | 24.9 | 15 | 272 |
| 33 | | | 0.1 | 24.1 | 12 | 221 |
| 34 | | Lumira | 0.122 | | 12 | |
| | | LA1000 | | | | |
| 35 | | | 0.054 | 25.4 | 53 | |
| 36 | | | 0.057 | 28.7 | 85 | |
| 37 | | | 0.055 | 25.4 | 106 | |
| 38 | | | 0.053 | 30 | 171 | |
| 39 | | | 0.097 | 22.7 | 107 | 296 |
| 40 | | | 0.104 | 22.8 | 159 | 310 |
| 41 | | | 0.1 | 23.5 | 104 | 182 |
| 42 | | | 0.109 | 22.4 | 106 | 217 |
| 43 | | | 0.106 | 23.5 | 19 | 212 |
| 44 | | | 0.117 | 23.2 | 15 | 215 |
| 45 | | | 0.118 | 23.6 | 19 | 297 |
| 46 | | | 0.134 | 23.3 | 20 | 199 |
| 47 | | | 0.14 | 24.1 | 15 | 186 |
| 48 | | | 0.097 | 23.7 | 20 | 191 |
| 49 | | | 0.099 | 22.9 | 15 | 196 |
| 50 | | | 0.123 | 23.6 | 12 | 103 |
| 51 | | | 0.097 | 23.7 | 13 | 198 |
| 52 | | | 0.105 | 23.5 | 10 | 138 |
| 53 | | | 0.112 | 23.4 | 10 | 82 |
| 54 | | | 0.11 | 23.7 | 10 | 76 |
| 55 | | | 0.102 | 23.2 | 14 | 172 |
| 56 | | | 0.1 | 22.1 | 11 | 128 |
| 57 | | MT1200 | 0.121 | 21.8 | 18 | 144 |

The following procedure outlines a method to produce a polyurea aerogel from a polyurea gel formed via reaction between an isocyanate and in-situ formed amines. 8.79 g Desmodur N₃₃₀₀ (the isocyanurate trimer of hexamethylene diisocyanate) was dissolved in 53.07 g acetone and stirred until homogenous (approximately 10 minutes). To this mixture 0.83 g deionized water was added, and stirred for approximately 20 seconds. Next, 1.64 g triethylamine was added to the mixture, and stirred an additional 20 seconds. The solution was then poured into a polypropylene mold, which was then sealed in a gas tight container, and transferred to a controlled-temperature environment set to 15° C. The container was allowed to sit for 24 hours, during which time gelation occurs. After 24 hours the gel was removed from the mold and transferred to a solvent exchange bath i.e., a sealed container partially filled with approximately 500 mL acetone. It remained submerged in acetone in the container for 72 hours, during which time the acetone was decanted and replaced with an equivalent volume of new acetone twice. After solvent exchange was complete the gel was transferred to a pressure vessel and submerged in excess acetone. The pressure vessel was then sealed and liquid CO₂ was introduced into the pressure vessel. The CO₂-acetone mixture was drained periodically while simultaneously supplying fresh liquid CO₂ until all the acetone has been removed. Then, the pressure vessel was isolated from the CO₂ supply, though it was still filled with liquid CO₂. The pressure vessel was then heated until the internal temperature reached 54° C., during which time pressure increased. Pressure was regulated by actuation of a solenoid valve, and was not allowed to exceed 1400 psi. The CO₂ inside the vessel was at that time in the supercritical state, and was held at these conditions for three hours, at which point the autoclave was slowly vented isothermally, such that the supercritical fluid entered the gaseous state without forming a two-phase liquid-vapor system, until the pressure vessel returned to atmospheric pressure. The pressure vessel was then cooled to room temperature before the intact aerogel was removed from the pressure vessel.

Samples 2, 3, 4, 7, 18, and 19 were contacted with a hydrophobe as a solvent exchange step. A polyurea gel was produced as described above, but the first solvent exchange bath was a mixture of acetone and hydrophobe. After 24 hours in this mixture, the gel was transferred to a fresh bath of acetone and the procedure outlined above continued as if this was the first solvent exchange bath.

Sample 5 was produced from polyurea gels formed by the procedure above except hexylamine was added to the solution after the triethylamine, and mixed for about 30 seconds before the solution was poured into the mold. The gel was then processed through drying as outlined above.

Sample 9 was produced from a polyurea gel formed by the procedure above except hexylamine was added to the mixing solution instead of triethylamine. The process was then completed through drying as described.

Samples, 10-14, 20, 22, 24, 26-33, and 41-56 were produced from polyurea gels formed by the procedure outlined above except about 20 mL of base solvent was reserved from the first mixture and the hydrophobe was diluted in said reserved solvent. This solvent/hydrophobe solution was then added to the mixing solution after the triethylamine and was mixed for about 30 seconds. The solution was then poured into a mold and the remainder of the procedure outlined above was carried out.

Sample 21 was produced from polyurea gel formed by the procedure outlined above except about 20 mL of base solvent was reserved from the first mixture and the hydrophobe was diluted in said reserved solvent. This solvent/hydrophobe solution was then added to the mixing solution about 20 minutes after the addition of triethylamine. The solution was mixed for about 1 minute and was then poured into a mold. The remainder of the procedure outlined above was carried out as described.

Samples 23 and 25 were produced from polyurea gels formed by the procedure outlined above except about 20 mL of base solvent was reserved from the first mixture and the hydrophobe was diluted in said reserved solvent. This solvent/hydrophobe solution was then added to the mixing solution after the triethylamine and was mixed for about 30 seconds. The solution was then poured into a mold and allowed to gel as outlined above. Additionally, the gel was transferred into a bath of acetone and hydrophobe and allowed to sit for 24 hours. The solvent exchange and drying processes were then carried out as outlined above.

Samples 34 and 57 were produced from polyurea gels formed by the procedure outlined above except about 20 mL of base solvent was reserved from the first mixture and the hydrophobe was diluted in said reserved solvent. This solvent/hydrophobe solution was then added to the mixing solution after the triethylamine and was mixed for about 30 seconds. Particulate silica aerogel material was then added to the solution and mixed for about an additional 30 seconds. The solution was then poured into a mold and the remainder of the procedure outlined above was carried out.

Samples 35, 37, 39, and 40 were produced from polyurea gels formed by the procedure outlined above except both N₃₃₀₀A and Hexamethylene diisocyanate (HMDI) were added to the first lot of acetone in molar ratios of 2:3 N₃₃₀₀A:HMDI for samples 35, 39, and 40; and 1:3 N₃₃₀₀A:HMDI for sample 37 and were mixed for about 10 minutes. The rest of the procedure was carried out as outlined above.

Samples 36 and 38 were produced from polyurea gels formed by the procedure outlined above except about 20 mL of base solvent was reserved from the first mixture and the hydrophobe was diluted in said reserved solvent. Additionally, both N₃₃₀₀A and HMDI were added to the non-reserved lot of base solvent in molar ratios of 2:3 N₃₃₀₀A:HMDI for sample 36; and 1:3 N₃₃₀₀A:HMDI for sample 38 and were mixed for about 10 minutes. The water and triethylamine were added as described above, Then, the solution of base solvent and hydrophobe was added to the solution and mixed for about 30 seconds. The rest of the procedure was carried out as outlined above.

Aerogels fabricated according to certain of the methods described herein exhibited low thermal conductivity coupled with low water uptake, indicating improved hydrophobicity.

### Example 2. Synthesis of Polyurea Aerogel Produced from the Reaction of Isocyanate with In-Situ-Formed Amines and Hexylamine, Composited with Nomex Felt

A polyurea gel was synthesized from an isocyanate. 4.4 g Desmodur N₃₃₀₀ (isocyanurate trimer of hexamethylene diisocyanate) was dissolved in 17.73 g acetone and stirred until homogenous (approximately 10 minutes). To this mixture 0.40 g deionized water was added, and stirred for approximately 20 seconds. Next, 0.82 g triethylamine was added to the mixture, and stirred an additional 20 seconds. Finally, a second mixture of 0.01 g hexylamine and 17.89 g acetone was added to the first mixture and stirred for approximately 2 minutes. The solution was then poured into a polypropylene mold over a 3-inch by 4-inch rectangle of 0.25-inch thick, 16 oz/square yard, meta-aramid felt such that the felt absorbed all of the solution. The mold was then sealed in a gas tight container, and transferred to a controlled-temperature environment set to 15° C. The gel was allowed to sit for 24 hours, during which time gelation occurs. After 24 hours the gel composite was removed from the mold and transferred to a solvent exchange bath.

The gel composite was then solvent exchanged and dried as described in example 1.

Aerogels fabricated according to certain of the methods described herein exhibited low thermal conductivity coupled with low water uptake, indicating improved hydrophobicity.

### Example 3. Synthesis of Polyurea Aerogel Produced from the Reaction of Isocyanate with In-Situ-Formed Amines and Hexylamine, Composited with Silica Felt

A polyurea gel was synthesized from an isocyanate. 4.4 g Desmodur N₃₃₀₀ (isocyanurate trimer of hexamethylene diisocyanate) was dissolved in 17.73 g acetone and stirred until homogenous (approximately 10 minutes). To this mixture 0.40 g deionized water was added, and stirred for approximately 20 seconds. Next, 0.82 g triethylamine was added to the mixture, and stirred an additional 20 seconds. Finally, a second mixture of 0.01 g hexylamine and 17.89 g acetone was added to the first mixture and stirred for approximately 2 minutes. The solution was then poured into a polypropylene mold over a 3-inch by 4-inch rectangle of 0.25-inch thick, 10 lbs/cubic foot, silica felt such that the felt absorbed all of the solution. The mold was then sealed in a gas tight container, and transferred to a controlled-temperature environment set to 15° C. The gel was allowed to sit for 24 hours, during which time gelation occurs. After 24 hours the gel composite was removed from the mold and transferred to a solvent exchange bath.

The gel composite was then solvent exchanged and dried as described in example 1.

Aerogels fabricated according to certain of the methods described herein exhibited low thermal conductivity coupled with low water uptake, indicating improved hydrophobicity.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. An aerogel comprising one or more moieties of Formula (M): 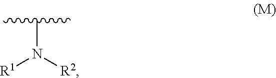
wherein:
each of R¹ is independently a first organic moiety;
each of R² is independently H or a second organic moiety; and
the log P of H—R¹ and/or H—R² determined at about 25° C. and about 1 atm is not lower than 1;
provided that each of the first and second organic moieties is not H.

2. A method for synthesizing an aerogel comprising:
forming a combination comprising a gel precursor and a solvent, and optionally a catalyst;
forming a gel from the combination; and
drying the gel to form the aerogel;
wherein:
a hydrophobe is present at at least one point in time after the beginning of forming the combination and before the completion of drying the gel;
the hydrophobe is a compound of the formula: H—N(R¹)(R²); and
the aerogel comprises one or more moieties of Formula (M): 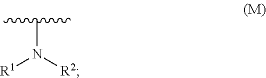
wherein:
each of R¹ is independently a first organic moiety;
each of R² is independently H or a second organic moiety; and
the log P of H—R¹ and/or H—R² determined at about 25° C. and about 1 atm is not lower than 1;
provided that each of the first and second organic moieties is not H.

3. An aerogel comprising one or more moieties of Formula (M101): 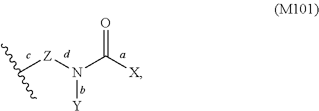
wherein:
each X is independently 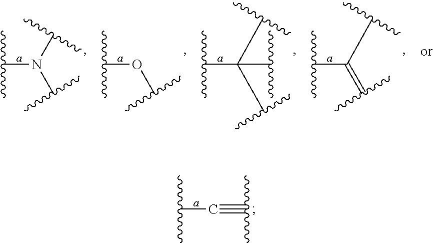
each Y is independently H, 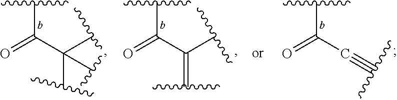
and
each Z is independently a third organic moiety or an inorganic moiety.

4. A method for synthesizing an aerogel comprising:
forming a combination comprising a gel precursor and a solvent, and optionally a catalyst;
forming a gel from the combination; and
drying the gel to form the aerogel;
wherein:
a hydrophobe is present at at least one point in time after the beginning of forming the combination and before the completion of drying the gel;
the hydrophobe is a compound of the formula: H—X; and
the aerogel comprises one or more moieties of Formula (M101): 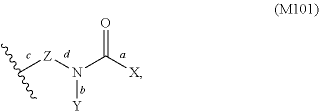
wherein:
each X is independently 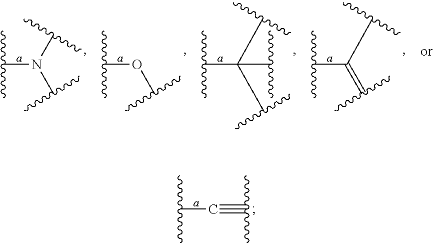
each Y is independently H, 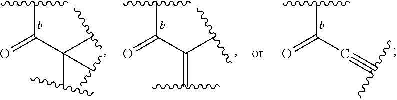
and
each Z is independently a third organic moiety or an inorganic moiety.

5. The aerogel of claim 1 or the method of claim 2 comprising one or more moieties of Formula (M101): 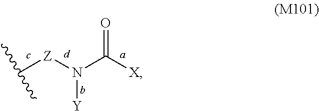
wherein:
each X is independently 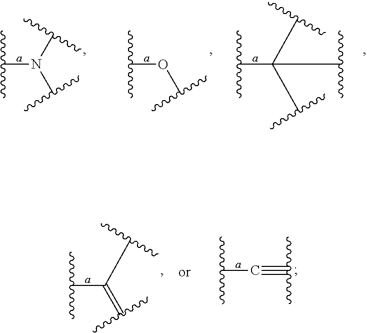
each Y is independently H, 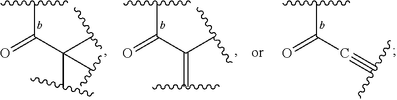
and
each Z is independently a third organic moiety or an inorganic moiety.

6. The aerogel or method of any one of the preceding claims, wherein at least one of the moieties of Formula (M101) are independently of Formula (M1):

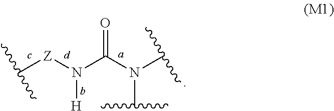

7. The aerogel or method of any one of the preceding claims, wherein at least one of the moieties of Formula (M101) are independently of the formula: 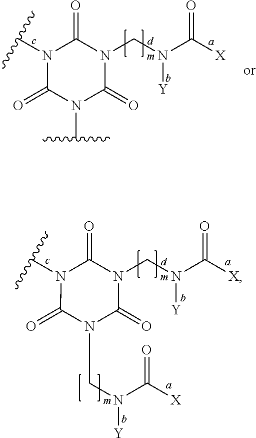
wherein each m is independently an integer between 1 and 12, inclusive.

8. The aerogel or method of any one of the preceding claims, wherein at least one of the moieties of Formula (M101) are independently of the formula:

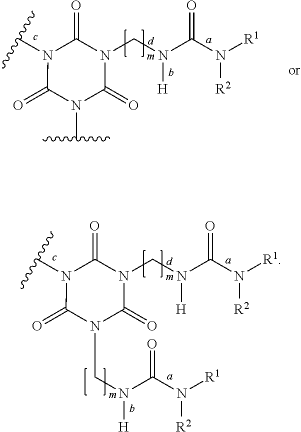

9. The aerogel or method of any one of the preceding claims, wherein at least one of the moieties of Formula (M101) are independently of the formula:

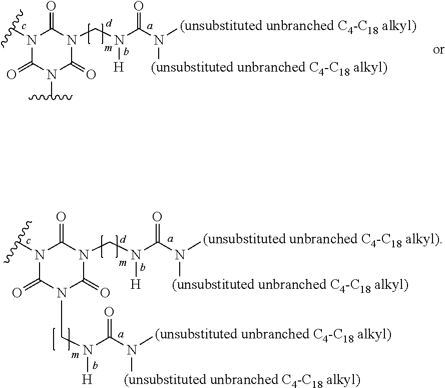

10. The aerogel or method of any one of the preceding claims, wherein at least one of the moieties of Formula (M101) are independently of the formula:

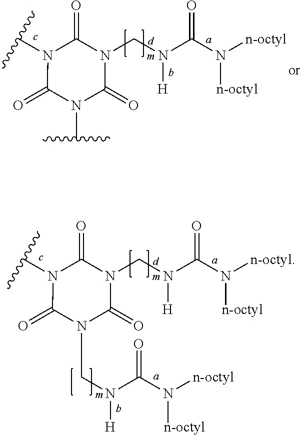

11. The aerogel or method of any one of the preceding claims, wherein at least one of the moieties of Formula (M101) are independently of the formula:

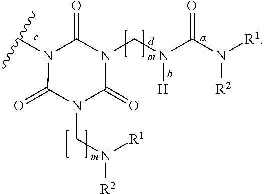

12. The aerogel or method of any one of the preceding claims, wherein at least one of the moieties of Formula (M101) are independently of the formula: 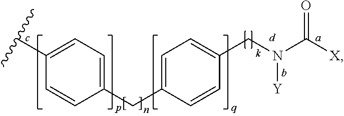
wherein:
each p is independently 0 or 1;
each n is independently an integer between 1 and 6, inclusive;
each q is independently 0 or 1; and
each k is independently an integer between 0 and 6, inclusive.

13. The aerogel or method of any one of the preceding claims, wherein at least one of the moieties of Formula (M101) are independently of the formula:

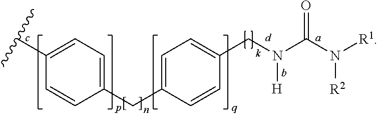

14. The aerogel or method of any one of the preceding claims, wherein at least one of the moieties of Formula (M101) are independently of Formula (M2):

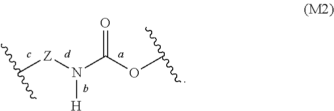

15. The aerogel or method of any one of the preceding claims comprising one or more moieties of Formula (M3):

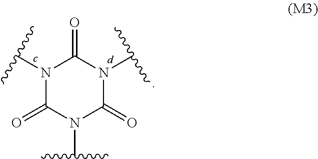 [SMILES: *n1c(=O)n(*)c(=O)n(*)c1=O]

16. The aerogel or method of any one of the preceding claims, wherein at least one of the moieties of Formula (M101) are independently of Formula (M4): 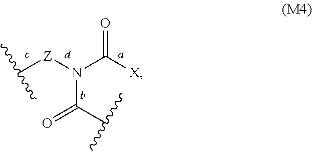
wherein each X is independently

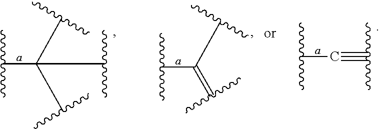

17. The aerogel or method of any one of the preceding claims, wherein at least one of the moieties of Formula (M101) are independently of Formula (M5): 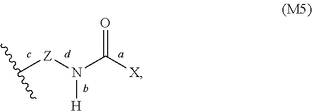
wherein each X is independently

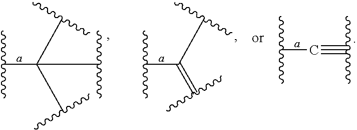

18. The aerogel or method of any one of the preceding claims, wherein at least one of the moieties of Formula (M101) are independently of Formula (M6):

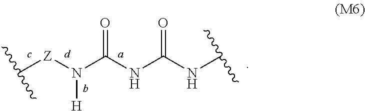

19. The aerogel or method of any one of the preceding claims comprising one or more moieties of Formula (M7): 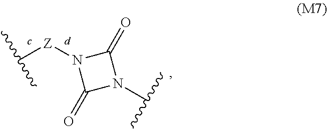
wherein each Z is independently a third organic moiety or an inorganic moiety.

20. The aerogel or method of any one of the preceding claims, wherein at least one of the moieties of Formula (M101) are independently of Formula (M8):

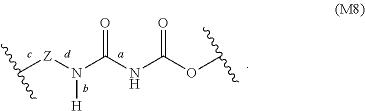

21. The aerogel or method of any one of the preceding claims comprising one or more moieties of Formula (M9): 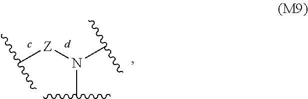
wherein each Z is independently a third organic moiety or an inorganic moiety.

22. The aerogel or method of any one of the preceding claims, wherein at least one of the moieties of Formula (M9) are independently of the formula: 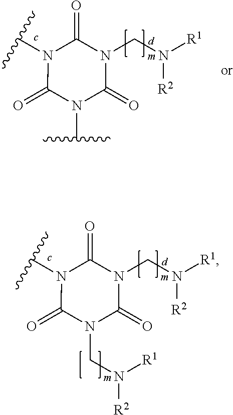
wherein each m is independently an integer between 1 and 12, inclusive.

23. The aerogel or method of any one of the preceding claims further comprising one or more organic polymers.

24. The aerogel or method of the preceding claim, wherein at least one of the organic polymers comprise one or more: polyureas, polyurethanes, polyamides, polyimides, polyisocyanurates, polyallophanates, polybiurets, and/or polyuretdiones.

25. The aerogel or method of the preceding claim, wherein at least one of the organic polymers comprise one or more polyureas.

26. The aerogel or method of any one of the preceding claims, wherein at least one of the organic polymers comprise at least one of the moieties of Formula (M) and/or at least one of the moieties of Formula (M101).

27. The aerogel or method of any one of the preceding claims, wherein at least one of the organic polymers comprise as repeating units at least one of the moieties of Formula (M101) that are polyvalent radicals.

28. The aerogel or method of any one of the preceding claims, wherein at least one of the polyureas comprise at least one of the moieties of Formula (M) and/or at least one of the moieties of Formula (M101).

29. The aerogel or method of any one of the preceding claims, wherein each R¹ is independently optionally substituted alkyl or optionally substituted phenyl.

30. The aerogel or method of any one of the preceding claims, wherein each R¹ is independently C₁₋₁₈ alkyl optionally substituted with 1 or more halogen; or phenyl optionally substituted with 1, 2, 3, 4, or 5 substituents independently selected from the group consisting of halogen, C₁₋₁₈ alkyl optionally substituted with 1 or more halogen, —O(C₁₋₁₈ alkyl optionally substituted with 1 or more halogen), and —N(C₁₋₁₈ alkyl optionally substituted with 1 or more halogen)₂.

31. The aerogel or method of any one of the preceding claims, wherein each R² is independently H, optionally substituted alkyl, or optionally substituted phenyl.

32. The aerogel or method of any one of the preceding claims, wherein each R² is independently H; C₁₋₁₈ alkyl optionally substituted with 1 or more halogen; or phenyl optionally substituted with 1, 2, 3, 4, or 5 substituents independently selected from the group consisting of halogen, C₁₋₁₈ alkyl optionally substituted with 1 or more halogen, —O(C₁₋₁₈ alkyl optionally substituted with 1 or more halogen), and —N(C₁₋₁₈ alkyl optionally substituted with 1 or more halogen)₂.

33. The aerogel or method of any one of the preceding claims, wherein at least one R¹ and/or at least one R² are independently optionally substituted alkyl.

34. The aerogel or method of any one of the preceding claims, wherein at least one R¹ and/or at least one R² independently comprise optionally substituted C₁₋₁₈ alkyl.

35. The aerogel or method of any one of the preceding claims, wherein at least one R¹ and/or at least one R² independently is unsubstituted C₄₋₁₈ alkyl.

36. The aerogel or method of any one of the preceding claims, wherein at least one R¹ and/or at least one R² independently comprise partially fluorinated alkyl or perfluoroalkyl.

37. The aerogel or method of any one of the preceding claims, wherein at least one R¹ is unsubstituted n-hexyl, and at least one R² are H.

38. The aerogel or method of any one of the preceding claims, wherein at least one R¹ is unsubstituted n-octyl, and at least one R² are H.

39. The aerogel or method of any one of the preceding claims, wherein at least one R¹ is unsubstituted n-dodecyl, and at least one R² are H.

40. The aerogel or method of any one of the preceding claims, wherein at least one R¹ is n-perfluorooctyl, and at least one R² are H.

41. The aerogel or method of any one of the preceding claims, wherein at least one R¹ is optionally substituted phenyl, and at least one R² are H.

42. The aerogel or method of any one of the preceding claims, wherein at least one R¹ is pentafluorophenyl, and at least one R² are H.

43. The aerogel or method of any one of the preceding claims, wherein at least one R¹ is 4-trifluoromethoxyphenyl, and at least one R² are H.

44. The aerogel or method of any one of the preceding claims, wherein at least one R¹ and at least one R² are each n-hexyl.

45. The aerogel or method of any one of the preceding claims, wherein at least one R¹ and at least one R² are each n-octyl.

46. The aerogel or method of any one of the preceding claims, wherein at least one R¹ and at least one R² are each n-dodecyl.

47. The aerogel or method of any one of the preceding claims, wherein at least one R¹ and/or at least one R² independently comprise vinyl.

48. The aerogel or method of any one of the preceding claims, wherein at least one of the moieties of Formula (M) independently comprise one or more fluoro.

49. The aerogel or method of any one of the preceding claims, wherein at least two 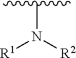
are different from each other.

50. The aerogel or method of any one of the preceding claims, wherein each 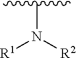
is the same as each other.

51. The aerogel or method of any one of the preceding claims, wherein at least one Z is a third organic moiety.

52. The aerogel or method of any one of the preceding claims, wherein at least one Z is optionally substituted alkylene, optionally substituted alkenylene, optionally substituted alkynylene, optionally substituted heteroalkylene, optionally substituted heteroalkenylene, optionally substituted heteroalkynylene, optionally substituted carbocyclylene, optionally substituted heterocyclylene, optionally substituted arylene, optionally substituted heteroarylene, or a combination thereof.

53. The aerogel or method of any one of the preceding claims, wherein at least one

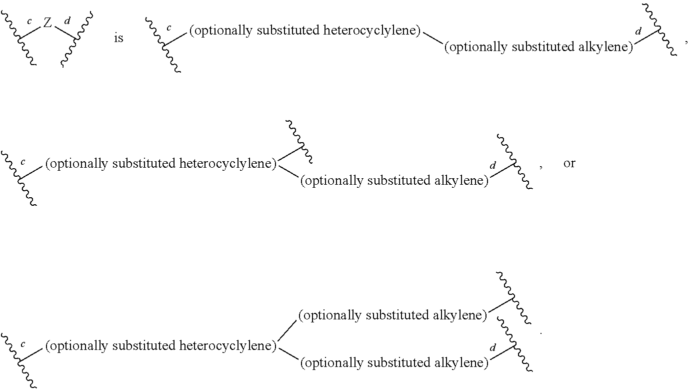

54. The aerogel or method of any one of the preceding claims, wherein at least one 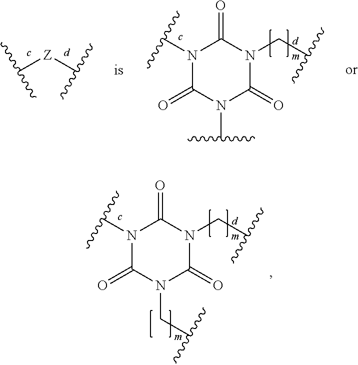
wherein each m is independently an integer between 1 and 12, inclusive.

55. The aerogel or method of any one of the preceding claims, wherein at least one Y is H.

56. The aerogel or method of any one of the preceding claims, wherein at least one X is

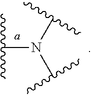 [SMILES: *N(*)*]

57. The aerogel or method of any one of the preceding claims, wherein at least one m are independently 4, 5, 6, 7, or 8.

58. The aerogel or method of any one of the preceding claims, wherein the log P of H—R¹ and/or H—R² determined at about 25° C. and about 1 atm is not lower than 1.5, not lower than 2, not lower than 2.5, or not lower than 3.

59. The aerogel or method of any one of the preceding claims, wherein the aerogel exhibits a bulk density of between 0.01 to 0.9 g/cm³.

60. The aerogel or method of any one of the preceding claims, wherein, when the aerogel is submerged under water at 25° C. for 24 h, the aerogel uptakes a mass of water within its outer boundaries of less than 200% of the dry mass of the aerogel prior to submerging in the water.

61. The aerogel or method of any one of the preceding claims, wherein the aerogel exhibits a contact angle with water, in an ambient air environment at 1 atm and 25° C., of greater than 90° and less than 180°.

62. The aerogel or method of any one of the preceding claims, wherein the aerogel exhibits a BET surface area of greater than or equal to 10 m²/g and less than or equal to 2000 m²/g, greater than or equal to 10 m²/g and less than or equal to 1000 m²/g, or greater than or equal to 100 m²/g and less than or equal to 400 m²/g.

63. The aerogel or method of any one of the preceding claims, wherein the aerogel exhibits a compressive modulus of greater than or equal to 100 kPa or greater than or equal to 1 MPa.

64. The aerogel or method of any one of the preceding claims, wherein the aerogel exhibits a compressive yield strength of greater than or equal to 40 kPa, or greater than or equal to 300 kPa.

65. The aerogel or method of any one of the preceding claims, wherein the aerogel exhibits a flexural modulus of greater than or equal to 0.00689 MPa, or greater than or equal to 1 MPa.

66. The aerogel or method of any one of the preceding claims, wherein the aerogel exhibits a flexural strength of greater than or equal to 0.00689 MPa, or greater than or equal to 500 kPa.

67. The aerogel or method of any one of the preceding claims, wherein the average pore size of the aerogel is less than or equal to 20 nm.

68. The aerogel or method of any one of the preceding claims, wherein the aerogel comprises pores of 1 micron or greater.

69. The aerogel or method of any one of the preceding claims, wherein the aerogel comprises a bimodal pore size distribution.

70. The aerogel or method of any one of the preceding claims, wherein the aerogel exhibits a thermal conductivity of from 10 mW/m·K at 25° C. to 100 mW/m·K at 25° C., from 15 mW/m·K at 25° C. to 50 mW/m·K at 25° C., or from 18 mW/m·K at 25° C. to 40 mW/m·K at 25° C.

71. The aerogel or method of any one of the preceding claims, wherein a reinforcing material is at least included within the geometric boundaries of the aerogel; said reinforcing material comprising a fibrous batting, an open-cell foam, and/or a honeycomb.

72. The aerogel or method of any one of the preceding claims, wherein the solvent is a combination of a first organic solvent, optionally a second organic solvent, and water.

73. The method of any one of the preceding claims, wherein forming the combination comprises:
combining mixture A comprising the gel precursor and the first organic solvent with water and optionally the catalyst to form mixture C; and
combining mixture C with mixture B comprising the compound of the formula: H—N(R¹)(R²) and the second organic solvent.

74. The method of any one of the preceding claim, wherein mixture C is combined with mixture B before mixture C forms a gel.

75. The method of any one of the preceding claims, wherein mixture C is combined with mixture B at 20° C.

76. The method of any one of the preceding claims, further comprising, after forming the gel and before drying the gel, combining the gel with mixture B comprising the compound of the formula: H—N(R¹)(R²) and the second organic solvent.

77. The method of any one of the preceding claims, wherein the gel precursor comprises isocyanate.

78. The method of any one of the preceding claims, wherein the isocyanate comprises Desmodur N₃₃₀₀.

79. The method of any one of the preceding claims, wherein the gel precursor comprises amino or mono-substituted amino.

80. The method of any one of the preceding claims, wherein the gel precursor comprises hydroxy.

81. The method of any one of the preceding claims, wherein the gel precursor comprises anhydride, carboxy, or acyl halide.

82. The method of any one of the preceding claims, wherein the first organic solvent and/or the second organic solvent independently comprise tert-butanol and/or acetone.

83. The method of any one of the preceding claims, wherein R¹ is optionally substituted alkyl, and R² is H.

84. The method of any one of the preceding claims, wherein each of R¹ and R² is independently optionally substituted alkyl.

85. The method of any one of the preceding claims, wherein R¹ and/or R² are independently perflouroalkyl.

86. The method of any one of the preceding claims, wherein the molar ratio of the hydrophobe (e.g., a compound of the formula: H—N(R¹)(R²)) to the gel precursor is greater than or equal to 0.01.

87. The method of any of the preceding claims, wherein the liquid is removed from the gel by supercritical extraction.

88. The method of any one of the preceding claims, wherein the liquid in the gel is first at least partially replaced by carbon dioxide after which the carbon dioxide is then removed from the gel.

89. The method of any one of the preceding claims, wherein the liquid in the gel is removed by subcritical extraction.

90. The method of any one of the preceding claims, wherein the liquid in the gel is removed by evaporation and/or boiling.

91. The method of any one of the preceding claims, wherein the liquid in the gel is removed by freeze drying under vacuum.

92. The method of any one of the preceding claims, wherein the liquid in the gel is removed by freeze drying at atmospheric pressure.

93. An aerogel prepared by the method of any one of the preceding claims.

94. A thin film comprising the aerogel of any one of the preceding claims.

95. A monolith comprising the aerogel of any one of the preceding claims.

96. A particle comprising the aerogel of any one of the preceding claims.

97. A flexible tape comprising the aerogel of any one of the preceding claims.

98. A ballistics armor, shield, panel, composite, and/or protective vest comprising the aerogel of any one of the preceding claims.

99. The aerogel or method of any one of the preceding claims, wherein neither R¹ nor R² is hydrogen, and the log P of H—R¹ and H—R² determined at about 25° C. and about 1 atm is not lower than 1.

100. An aerogel comprising one or more moieties of the following structure: 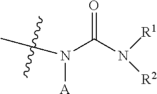
wherein:
each of A is a point of attachment to a precursor of a gel of the aerogel, a gel of the aerogel, and/or the aerogel;
each of R¹ is independently a first organic moiety;
each of R² is independently H or a second organic moiety; and
the log P of each of H—R¹ and/or H—R² determined at about 25° C. and about 1 atm is not lower than 1;
provided that each of the first and second organic moieties is not H.

101. An aerogel comprising one or more moieties of the following structure: 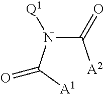
wherein:
each of A¹ is a point of attachment to a precursor of a gel of the aerogel, a gel of the aerogel, and/or the aerogel;
each of A² is either the same point of attachment to the precursor of a gel of the aerogel, the gel of the aerogel, and/or the aerogel as A¹ or a different point of attachment to the precursor of a gel of the aerogel, the gel of the aerogel, and/or the aerogel;
each of Q¹ is independently an organic moiety that is not H; and
the log P of each of H-Q¹ determined at about 25° C. and about 1 atm is not lower than 1.

102. An aerogel comprising one or more moieties of the following structure: 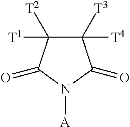
wherein:
each of A is a point of attachment to a precursor of a gel of the aerogel, a gel of the aerogel, and/or the aerogel;
at least one of T¹, T², T³, and T⁴ is an organic moiety that is not H; and
the log P of at least one of H-T¹, H-T², H-T³, and H-T⁴ determined at about 25° C. and about 1 atm is not lower than 1.

103. An aerogel comprising one or more moieties of the following structure: 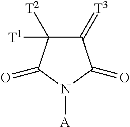
wherein:
each of A is a point of attachment to a precursor of a gel of the aerogel, a gel of the aerogel, and/or the aerogel;
at least one of T¹, T², and T³ is an organic moiety that is not H; and
the log P of at least one of H-T¹, H-T², and H-T³ determined at about 25° C. and about 1 atm is not lower than 1.

104. An aerogel comprising one or more moieties of the following structure: 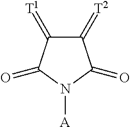
wherein:
each of A is a point of attachment to a precursor of a gel of the aerogel, a gel of the aerogel, and/or the aerogel;
at least one of T¹ and T² is an organic moiety that is not H; and
the log P of at least one of H-T¹ and H-T² determined at about 25° C. and about 1 atm is not lower than 1.

105. An aerogel comprising one or more moieties of the following structure: 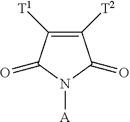
wherein:
each of A is a point of attachment to a precursor of a gel of the aerogel, a gel of the aerogel, and/or the aerogel;
at least one of T¹ and T² is an organic moiety that is not H; and
the log P of at least one of H-T¹ and H-T² determined at about 25° C. and about 1 atm is not lower than 1.

106. An aerogel comprising one or more moieties of the following structure: 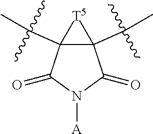
wherein:
each of A is a point of attachment to a precursor of a gel of the aerogel, a gel of the aerogel, and/or the aerogel;
T⁵ comprises one or more atoms establishing a cyclic organic moiety; and
the log P of 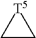
determined at about 25° C. and about 1 atm is not lower than 1.

107. An aerogel comprising one or more moieties of the following structure: 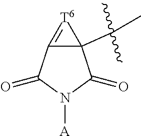
wherein:
each of A is a point of attachment to a precursor of a gel of the aerogel, a gel of the aerogel, and/or the aerogel;
T⁶ comprises one or more atoms establishing a cyclic organic moiety; and
the log P of 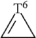
determined at about 25° C. and about 1 atm is not lower than 1.

108. An aerogel comprising one or more moieties of the following structure: 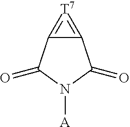
wherein:
each of A is a point of attachment to a precursor of a gel of the aerogel, a gel of the aerogel, and/or the aerogel;
T⁷ comprises two or more atoms establishing a cyclic organic moiety; and
the log P of 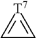
determined at about 25° C. and about 1 atm is not lower than 1.

109. An aerogel comprising one or more moieties of the following structure: 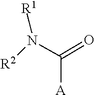
wherein:
each of A is a point of attachment to a precursor of a gel of the aerogel, a gel of the aerogel, and/or the aerogel;
each of R¹ is independently a first organic moiety;
each of R² is independently H or a second organic moiety; and
the log P of each of H—R¹ and/or H—R² determined at about 25° C. and about 1 atm is not lower than 1;
provided that each of the first and second organic moieties is not H.

110. An aerogel comprising one or more moieties of the following structure: 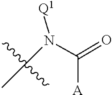
wherein:
each of A is a point of attachment to a precursor of a gel of the aerogel, a gel of the aerogel, and/or the aerogel;
each of Q¹ is independently an organic moiety that is not H; and
the log P of each of H-Q¹ determined at about 25° C. and about 1 atm is not lower than 1.

111. An aerogel comprising one or more moieties of the following structure: 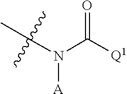
wherein:
each of A is a point of attachment to a precursor of a gel of the aerogel, a gel of the aerogel, and/or the aerogel;
each of Q¹ is independently an organic moiety that is not H; and
the log P of each of H-Q¹ determined at about 25° C. and about 1 atm is not lower than 1.

112. An aerogel comprising one or more moieties of the following structure: 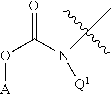
wherein:
each of A is a point of attachment to a precursor of a gel of the aerogel, a gel of the aerogel, and/or the aerogel;
each of Q¹ is independently an organic moiety that is not H; and
the log P of each of H-Q¹ determined at about 25° C. and about 1 atm is not lower than 1.

113. An aerogel comprising one or more moieties of the following structure: 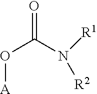
wherein:
each of A is a point of attachment to a precursor of a gel of the aerogel, a gel of the aerogel, and/or the aerogel;
each of R¹ is independently a first organic moiety;
each of R² is independently H or a second organic moiety; and
the log P of each of H—R¹ and/or H—R² determined at about 25° C. and about 1 atm is not lower than 1;
provided that each of the first and second organic moieties is not H.

114. An aerogel comprising one or more moieties of the following structure: 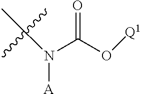
wherein:
each of A is a point of attachment to a precursor of a gel of the aerogel, a gel of the aerogel, and/or the aerogel;
each of Q¹ is independently an organic moiety that is not H; and
the log P of each of H-Q¹ determined at about 25° C. and about 1 atm is not lower than 1.

115. An aerogel comprising one or more moieties of the following structure: 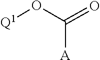
wherein:
each of A is a point of attachment to a precursor of a gel of the aerogel, a gel of the aerogel, and/or the aerogel;
each of Q¹ is independently an organic moiety that is not H; and
the log P of each of H-Q¹ determined at about 25° C. and about 1 atm is not lower than 1.

116. An aerogel comprising one or more moieties of the following structure: 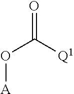
wherein:
each of A is a point of attachment to a precursor of a gel of the aerogel, a gel of the aerogel, and/or the aerogel;
each of Q¹ is independently an organic moiety that is not H; and
the log P of each of H-Q¹ determined at about 25° C. and about 1 atm is not lower than 1.

117. The aerogel of any one of claims 100-116, wherein the aerogel comprises one or more organic polymers.

118. The aerogel of any one of claims 100-117, wherein at least one of the organic polymers comprise one or more: polyureas, polyurethanes, polyamides, polyimides, polyisocyanurates, polyallophanates, polybiurets, and/or polyuretdiones.

119. The aerogel of any one of claims 100-118, wherein at least one of the organic polymers comprise one or more polyureas.

120. The aerogel of any one of claims 100-119, wherein at least one of the organic polymers comprise one or more polyurethanes.

121. The aerogel of any one of claims 100-120, wherein at least one of the organic polymers comprise one or more polyamides.

122. The aerogel of any one of claims 100-121, wherein at least one of the organic polymers comprise one or more polyimides.

123. The aerogel of any one of claims 100-122, wherein at least one of the organic polymers comprise one or more polyesters.

124. The aerogel of any one of claims 100-123, wherein the log P of each of H—R¹ and H—R² determined at about 25° C. and about 1 atm is not lower than 1.

125. The aerogel of any one of claims 100-124, wherein neither R¹ nor R² is H, and the log P of each of H—R¹ and H—R² determined at about 25° C. and about 1 atm is not lower than 1.

126. The aerogel of any one of claims 100-125, wherein each R¹ is independently C₁₋₁₈ alkyl optionally substituted with 1 or more halogen; or phenyl optionally substituted with 1, 2, 3, 4, or 5 substituents independently selected from the group consisting of halogen, C₁₋₁₈ alkyl optionally substituted with 1 or more halogen, —O(C₁₋₁₈ alkyl optionally substituted with 1 or more halogen), and —N(C₁₋₁₈ alkyl optionally substituted with 1 or more halogen)₂.

127. The aerogel of any one of claims 100-126, wherein each R² is independently H, optionally substituted alkyl, or optionally substituted phenyl.

128. The aerogel of any one of claims 100-127, wherein each R² is independently H; C₁₋₁₈ alkyl optionally substituted with 1 or more halogen; or phenyl optionally substituted with 1, 2, 3, 4, or 5 substituents independently selected from the group consisting of halogen, C₁₋₁₈ alkyl optionally substituted with 1 or more halogen, —O(C₁₋₁₈ alkyl optionally substituted with 1 or more halogen), and —N(C₁₋₁₈ alkyl optionally substituted with 1 or more halogen)₂.

129. The aerogel of any one of claims 100-128, wherein at least one R¹ and/or at least one R² are independently optionally substituted alkyl.

130. The aerogel of any one of claims 100-129, wherein at least one R¹ and/or at least one R² independently comprise optionally substituted C₁₋₁₈ alkyl.

131. The aerogel of any one of claims 100-130, wherein at least one R¹ and/or at least one R² independently is unsubstituted C₄₋₁₈ alkyl.

132. The aerogel of any one of claims 100-131, wherein at least one R¹ and/or at least one R² independently comprise partially fluorinated alkyl or perfluoroalkyl.

133. The aerogel of any one of claims 100-132, wherein at least one R¹ is unsubstituted n-hexyl, and at least one R² are H.

134. The aerogel of any one of claims 100-133, wherein at least one R¹ is unsubstituted n-octyl, and at least one R² are H.

135. The aerogel of any one of claims 100-134, wherein at least one R¹ is unsubstituted n-dodecyl, and at least one R² are H.

136. The aerogel of any one of claims 100-135, wherein at least one R¹ is n-perfluorooctyl, and at least one R² are H.

137. The aerogel of any one of claims 100-136, wherein at least one R¹ is optionally substituted phenyl, and at least one R² are H.

138. The aerogel of any one of claims 100-137, wherein at least one R¹ is pentafluorophenyl, and at least one R² are H.

139. The aerogel of any one of claims 100-138, wherein at least one R¹ is 4-trifluoromethoxyphenyl, and at least one R² are H.

140. The aerogel of any one of claims 100-139, wherein at least one R¹ and at least one R² are each n-hexyl.

141. The aerogel of any one of claims 100-140, wherein at least one R¹ and at least one R² are each n-octyl.

142. The aerogel of any one of claims 100-141, wherein at least one R¹ and at least one R² are each n-dodecyl.

143. The aerogel of any one of claims 100-142, wherein at least one R¹ and/or at least one R² independently comprise vinyl.

144. The aerogel of any one of claims 100-143, wherein each Q¹ is independently C₁₋₁₈ alkyl optionally substituted with 1 or more halogen; or phenyl optionally substituted with 1, 2, 3, 4, or 5 substituents independently selected from the group consisting of halogen, C₁₋₁₈ alkyl optionally substituted with 1 or more halogen, —O(C₁₋₁₈ alkyl optionally substituted with 1 or more halogen), and —N(C₁₋₁₈ alkyl optionally substituted with 1 or more halogen)₂.

145. The aerogel of any one of claims 100-144, wherein at least one Q¹ is optionally substituted alkyl.

146. The aerogel of any one of claims 100-145, wherein at least one Q¹ comprises optionally substituted C₁₋₁₈ alkyl.

147. The aerogel of any one of claims 100-146, wherein at least one Q¹ is unsubstituted C₄₋₁₈ alkyl.

148. The aerogel of any one of claims 100-147, wherein at least one Q¹ comprises partially fluorinated alkyl or perfluoroalkyl.

149. The aerogel of any one of claims 100-148, wherein at least one Q¹ is unsubstituted n-hexyl.

150. The aerogel of any one of claims 100-149, wherein at least one Q¹ is unsubstituted n-octyl.

151. The aerogel of any one of claims 100-150, wherein at least one Q¹ is unsubstituted n-dodecyl.

152. The aerogel of any one of claims 100-151, wherein at least one Q¹ is n-perfluorooctyl.

153. The aerogel of any one of claims 100-152, wherein at least one Q¹ is optionally substituted phenyl.

154. The aerogel of any one of claims 100-153, wherein at least one Q¹ is pentafluorophenyl.

155. The aerogel of any one of claims 100-154, wherein at least one Q¹ is 4-trifluoromethoxyphenyl.

156. The aerogel of any one of claims 100-155, wherein at least one Q¹ comprises vinyl.

157. The aerogel of any one of claims 100-156, wherein at least one of T¹, T², T³, and T⁴ is independently C₁₋₁₈ alkyl optionally substituted with 1 or more halogen; or phenyl optionally substituted with 1, 2, 3, 4, or 5 substituents independently selected from the group consisting of halogen, C₁₋₁₈ alkyl optionally substituted with 1 or more halogen, —O(C₁₋₁₈ alkyl optionally substituted with 1 or more halogen), and —N(C₁₋₁₈ alkyl optionally substituted with 1 or more halogen)₂.

158. The aerogel of any one of claims 100-157, wherein at least one of T¹, T², T³, and T⁴ is independently optionally substituted alkyl.

159. The aerogel of any one of claims 100-158, wherein at least one of T¹, T², T³, and T⁴ is independently optionally substituted C₁₋₁₈ alkyl.

160. The aerogel of any one of claims 100-159, wherein at least one of T¹, T², T³, and T⁴ is independently unsubstituted C₄₋₁₈ alkyl.

161. The aerogel of any one of claims 100-160, wherein at least one of T¹, T², T³, and T⁴ is independently comprises partially fluorinated alkyl or perfluoroalkyl.

162. The aerogel of any one of claims 100-161, wherein at least one of T¹, T², T³, and T⁴ is independently unsubstituted n-hexyl.

163. The aerogel of any one of claims 100-162, wherein at least one of T¹, T², T³, and T⁴ is independently unsubstituted n-octyl.

164. The aerogel of any one of claims 100-163, wherein at least one of T¹, T², T³, and T⁴ is independently unsubstituted n-dodecyl.

165. The aerogel of any one of claims 100-164, wherein at least one of T¹, T², T³, and T⁴ is independently is n-perfluorooctyl.

166. The aerogel of any one of claims 100-165, wherein at least one of T¹, T², T³, and T⁴ is independently optionally substituted phenyl.

167. The aerogel of any one of claims 100-166, wherein at least one of T¹, T², T³, and T⁴ is independently pentafluorophenyl.

168. The aerogel of any one of claims 100-167, wherein at least one of T¹, T², T³, and T⁴ is independently.

169. The aerogel of any one of claims 100-168, wherein at least one of T¹, T², T³, and T⁴ independently comprises vinyl.

170. The aerogel of any one of claims 100-169, wherein the one or more atoms of T⁵ include one or more atoms chosen from carbon, oxygen, nitrogen, sulfur, phosphorus, or silicon.

171. The aerogel of any one of claims 100-170, wherein the cyclic organic moiety established by the one or more atoms of at least one T⁵ comprises an optionally substituted carbocyclic moiety.

172. The aerogel of any one of claims 100-171, wherein the cyclic organic moiety established by the one or more atoms of at least one T⁵ comprises an optionally substituted cycloalkyl moiety.

173. The aerogel of any one of claims 100-172, wherein the cyclic organic moiety established by the one or more atoms of at least one T⁵ comprises an optionally substituted heterocyclic moiety.

174. The aerogel of any one of claims 100-173, wherein the cyclic organic moiety established by the one or more atoms of at least one T⁵ comprises an optionally substituted aromatic moiety.

175. The aerogel of any one of claims 100-174, wherein the cyclic organic moiety established by the one or more atoms of at least one T⁵ comprises an optionally substituted heteroaromatic moiety.

176. The aerogel of any one of claims 100-175, wherein the one or more atoms of T⁶ include one or more atoms chosen from carbon, oxygen, nitrogen, sulfur, phosphorus, or silicon.

177. The aerogel of any one of claims 100-176, wherein the cyclic organic moiety established by the one or more atoms of at least one T⁶ comprises an optionally substituted carbocyclic moiety.

178. The aerogel of any one of claims 100-177, wherein the cyclic organic moiety established by the one or more atoms of at least one T⁶ comprises an optionally substituted heterocyclic moiety.

179. The aerogel of any one of claims 100-178, wherein the cyclic organic moiety established by the one or more atoms of at least one T⁶ comprises an optionally substituted aromatic moiety.

180. The aerogel of any one of claims 100-179, wherein the cyclic organic moiety established by the one or more atoms of at least one T⁶ comprises an optionally substituted heteroaromatic moiety.

181. The aerogel of any one of claims 100-180, wherein the two or more atoms of T⁷ include one or more atoms chosen from carbon, oxygen, nitrogen, sulfur, phosphorus, or silicon.

182. The aerogel of any one of claims 100-181, wherein the cyclic organic moiety established by the two or more atoms of at least one T⁷ comprises an optionally substituted carbocyclic moiety.

183. The aerogel of any one of claims 100-182, wherein the cyclic organic moiety established by the two or more atoms of at least one T⁷ comprises an optionally substituted heterocyclic moiety.

184. The aerogel of any one of claims 100-183, wherein the cyclic organic moiety established by the two or more atoms of at least one T⁷ comprises an optionally substituted aromatic moiety.

185. The aerogel of any one of claims 100-184, wherein the cyclic organic moiety established by the two or more atoms of at least one T⁷ comprises an optionally substituted heteroaromatic moiety.
